(19) United States
(12) Patent Application Publication
(10) Pub. No.: US 2010/0243344 A1
(43) Pub. Date: Sep. 30, 2010

(54) ELECTROMECHANICALLY COUNTERBALANCED HUMANOID ROBOTIC SYSTEM

(75) Inventors: Keenan A. Wyrobek, Menlo Park, CA (US); Eric Berger, Mountain View, CA (US); J. Kenneth Salisbury, JR., Mountain View, CA (US)

Correspondence Address: VISTA IP LAW GROUP LLP, 12930 Saratoga Avenue, Suite D-2, Saratoga, CA, 95070, US

(73) Assignee: Board of Trustees of Leland Stanford Junior University, Palo Alto, CA (US)

(21) Appl. No.: 12/626,187

(22) Filed: Nov. 25, 2009

Related U.S. Application Data
(63) Continuation-in-part of application No. 12/154,112, filed on May 19, 2008, now abandoned.
Application No. 12/154,112 is a continuation of application No. 11/904,181, filed on Sep. 25, 2007, now abandoned.
(60) Provisional application No. 60/847,313, filed on Sep. 25, 2006.

(51) Int. Cl. B25J 5/00; B60K 1/00; B25J 18/00

(52) U.S. Cl. 180/21; 180/65.1; 74/490.01; 901/1; 901/19

(57) ABSTRACT

Systems and methods related to construction, configuration, and utilization of humanoid robotic systems and aspects thereof are described. A system may include a mobile base, a spine structure, a body structure, and at least one robotic arm, each of which is movably configured to have significant human-scale capabilities in prescribed environments. The one or more robotic arms may be rotatably coupled to the body structure, which may be mechanically associated with the mobile base and spine such that it may be deflectably elevated and rolled relative to the base simultaneously and independently. Aspects of the one or more arms may be counterbalanced with one or more spring-based counterbalancing mechanisms which facilitate backdriveability and payload features.

### RELATED APPLICATION DATA

This application is a continuation-in-part of copending U.S. application Ser. No. 12/154,112, filed May 19, 2008, which is a continuation of U.S. application Ser. No. 11/904,181 filed Sep. 25, 2007, which claims the benefit under 35 U.S.C. §119 of U.S. provisional application Ser. No. 60/847,313 filed Sep. 25, 2006. The foregoing applications are each hereby incorporated by reference into the present application in their entirety.

### FIELD OF THE INVENTION

The invention relates to electromechanical and robotic systems for accomplishing human-scale tasks, and specifically to humanoid and autonomous robotic systems for use in the human environment.

### BACKGROUND

Scientists and researchers in countries such as Japan, Germany, and the United States have a long history of utilizing electromechanical devices to assist with tasks such as manufacturing. Most of these systems comprise a variation of an armlike work interface, and some of them may have a base structure which is mobile relative to the coordinate system of the floor or earth. More recently, a classification of robots often referred to as “humanoid robots” has evolved, with many designers trying to bring robotics and autonomy deeper into the human living environment. Humanoid robots derive their classification name from human-like qualities that they may imitate or possess. For example, a series of humanoid robots developed under the tradename “Asimo”® by Honda Corporation of Japan has demonstrated that small human-like robots can safely walk, or ambulate, around on two feet with two legs, interact with humans in the work or home environment, and handle some very light duty tasks, such as holding a lightweight tray.

Another ambulatory robot from Japan was built and distributed in limited numbers by Kawada Heavy Industries, Inc., under the name “HRP2”. Indeed, much attention has been focused on solving the humanlike ambulatory problem, presumably because human environments are designed for ambulatory beings. Other humanoid robotics design efforts have focused less on ambulation and have developed robots with wheeled bases to facilitate movement of other important robotic features, such as electromechanically operated arms or variations of arms. For example, the “STAIR 1” and “STAIR 2” robots developed at Stanford University are representative of a relatively large class of robots wherein a research team builds or purchases, for example, from Segway Corporation, a relatively straightforward mobile base, and then mounts a robotic arm on the top of the base to build a robotics research platform.

A project from Deutches Zentrum fur Luft and Raumfahrt (“DLR”, or the “German Aerospace Center”) called the “Robutler” comprises a movable table style base with a robotic arm mounted to its top. This system was configured to have laser scanner localization, stereo video cameras, and other sensors to attempt to accomplish what was referred to by DLR as “scene analysis”. A subsequent DLR robotics configuration, termed “Justin”, was significantly more humanoid in its construction and appearance. The Justin humanoid robot has lightweight humanoid arms, a humanoid sensor head, and a pivotable torso structure. This robot is force controlled using a series elastic configuration and has expensive and powerful arms with distally mounted hands comprising fingerlike elements. Like many of the publicly displayed humanoid robots, it is not fully self contained, in that it has off-board computing and power systems assisting with its function. Indeed, many humanoid robots are displayed or operated with power and/or communications lines trailing behind due to the complexities of full integration. The University of Karlsruhe, Germany, has developed a series of humanoid robots called “ARMAR”, which has been displayed with several variations of a nonambulatory mobile base, an integrated sensor head, a torso structure which may be pivoted to interact with aspects of the environment around it, and up to two robotic arms.

It would be desirable for robotics researchers, corporations, and people in general to have an integrated humanoid robotics platform for development and human environment operation that is robust, safe, predictable, fully-integrated, able to mechanically navigate typical human environments, highly programmable, and capable of certain human-scale tasks, such as lifting and manipulating objects that are commonly lifted and manipulated by humans. Such a system is described herein.

### SUMMARY

One embodiment is directed to a humanoid robotic system comprising a mobile base having a base frame and a plurality of wheels rotatably coupled to the base frame and configured to controllably navigate floors through contact with a generally planar floor surface. The system also has an elongate spine structure fixedly coupled to the mobile base and projecting from said mobile base along a longitudinal axis of the elongate spine structure that is substantially perpendicular from the plane of the generally planar floor surface. Further, a body structure is provided which is slidably and rotatably coupled to the elongate spine structure, the body structure having spine interface configured to facilitate rolling of the body structure about a roll axis substantially coincident with the longitudinal axis of the elongate spine structure, as well as simultaneous and independent axial deflection of the body relative to the mobile base in a direction substantially parallel to the longitudinal axis of the elongate spine structure. At least one robotic arm is rotatably coupled to the body structure. In another embodiment, the mobile base may comprise a battery-based power supply system configured to operate all aspects of the robotic system in an extended self-contained mode, without additional external power connectivity, when charged. Further, the mobile base may comprise at least three wheel-based floor interfaces, two of which are independently actuated by a wheel drive motor, the remainder of which are passively rotatable. In one embodiment, the elongate spine structure may comprise a body structure elevator cart which is controllably repositionable relative to a length of the elongate spine, and which is rotatably coupled to the body structure. In another embodiment, the body structure may be electromechanically rolled about the body structure elevator cart to which it is coupled via a body roll actuator coupled to the body structure, the roll actuator being coupled to a body roll actuator drive pulley which is coupled to a pulley comprising the body structure elevator cart by a flexible recirculatory drive member. The body structure elevator cart may be electromechanically repositioned relative to the length of the elongate spine via a body elevator actuator coupled to the mobile base, the body elevator actuator being coupled to a body elevator drive pulley which is coupled to the body structure elevator cart by a tension member. In one embodiment the system may comprise two robotic arms rotatably coupled to the body structure. In another embodiment, the at least one robotic arm may comprise a force-controlled, backdriveable arm. In one embodiment, this arm may have a payload of about two kilograms. In another embodiment, the at least one robotic arm may comprise a spring-based counterbalancing mechanism configured to utilize one or more springs to compensate for gravitational forces associated with one or more portions of the at least one robotic arm. The at least one robotic arm may comprise a forearm portion, an upper arm portion, a first spring, and a second spring, and wherein the first spring is configured to compensate for gravitational forces associated with the mass of the forearm portion, and the second spring is configured to compensate for gravitational forces associated with the mass of the upper arm portion. At least one of the one or more springs may be configured to be controllably and electromechanically adjusted utilizing an actuator, and at least one of the one or more springs may be a compression spring. The at least one robotic arm may comprise a proximal support structure rotatably coupled to the body structure, the proximal support structure rotatably coupled to a robotic arm upper arm portion, which is rotatably coupled to a robotic forearm portion, and wherein the proximal support structure substantially contains and is coupled to the spring-based counterbalancing mechanism.

Another embodiment is directed to a robotic arm system, comprising a proximal support structure; an arm comprising an upper arm portion and a forearm portion; the upper arm portion having a proximal and a distal end, the proximal end being rotatably coupled to the proximal support structure; the forearm portion having a proximal and a distal end, the proximal end being rotatably coupled to the distal end of the upper arm portion; and an electromechanically adjustable spring-based counterbalancing mechanism comprising a spring intercoupled between the proximal support structure and the arm and configured to counterbalance loads imparted to the arm. In one embodiment, the proximal end of the upper arm portion may comprise a shoulder interface portion configured to be rotatably coupled to the proximal structure to allow shoulder flexion rotation about an axis substantially perpendicular to a longitudinal axis of the proximal support structure. In another embodiment the proximal support structure may be rotatably coupled to a parent structure such that the proximal support structure may be rotated about its longitudinal axis to provide a panning rotation of the shoulder interface relative to the parent structure, independently of the shoulder flexion rotation. In another embodiment, the spring may be intercoupled between the proximal support structure and the shoulder interface portion by a tension member, the spring being configured to apply a counterbalancing torque about the shoulder interface to prevent shoulder flexion based at least in part upon gravitational loads imparted upon the upper arm portion.

In another embodiment, the robotic arm system may further comprise a forearm counterbalancing linkage comprising a proximal member extending from and being rotatably coupled to the proximal end of the upper arm portion, the proximal member also being coupled to the forearm portion and being configured such that a longitudinal axis of the proximal member remains parallel to a longitudinal axis of the forearm portion. The forearm counterbalancing linkage may comprise a proximal member pulley rotatably coupled to the proximal end of the upper arm portion and fixedly coupled to the proximal member, the proximal end of the forearm portion comprising a timing pulley configured to rotate about an elbow flexion axis defined by the rotatable coupling between the proximal end of the forearm portion and the distal end of the upper arm portion when the upper arm portion and forearm portion are rotated relative to each other, with a timing belt being routed around each of the proximal member pulley and timing pulley and across the upper arm portion to retain the parallel orientation of the proximal member and the longitudinal axis of the forearm portion. In another embodiment the spring may be intercoupled between the proximal support structure and the proximal member, the spring being configured to apply a counterbalancing torque about the elbow flexion axis to prevent rotation of the forearm portion at the elbow flexion axis based at least in part upon gravitational loads imparted upon the forearm portion.

In another embodiment the robotic arm system may further comprise a gripper rotatably coupled to the distal end of the forearm portion. Such gripper may be configured to roll and flex about a wrist axis relative to the distal end of the forearm portion. In another embodiment, the shoulder interface portion of the upper arm portion may be rotatably coupled to the remainder of the upper arm portion, and configured to allow for a shoulder roll rotation about a longitudinal axis of the upper arm portion. In one embodiment, the spring may be constrained in controlled compression. In another embodiment, the spring may be constrained in controlled tension. Inother embodiment, the spring-based counterbalancing mechanism may comprise a first spring intercoupled between the proximal support structure and the forearm portion, and a second spring intercoupled between the proximal support structure and the upper arm portion, wherein both springs may be electromechanically adjustable. In one embodiment, the spring may be electromechanically adjusted with a cable operably coupled to a motor configured to controllably add or decrease loads applied to the spring.

Another embodiment is directed to a method of operating a robotic arm, comprising providing a robotic arm system comprising a proximal support structure and an arm having an upper arm portion and a forearm portion; the upper arm portion having a proximal and a distal end, the proximal end being rotatably coupled to the proximal support structure; the forearm portion having a proximal and a distal end, the proximal end being rotatably coupled to the distal end of the upper arm portion; and electromechanically adjusting a spring-based counterbalancing mechanism comprising a spring intercoupled between the proximal support structure and the arm to counterbalance loads imparted to the arm. In one embodiment, the spring-based counterbalancing mechanism may be intercoupled between the proximal support structure and the proximal end of the upper arm portion, wherein electromechanically adjusting may comprise actuating a motor coupled to the spring by a tensioning element. In another embodiment the spring-based counterbalancing mechanism may be intercoupled between the proximal support structure and a proximal member extending from and being rotatably coupled to the proximal end of the upper arm portion, the proximal member being coupled to the forearm portion by a linkage configured such that a longitudinal axis of the proximal member remains parallel to a longitudinal axis of the forearm portion, and wherein electromechanically adjusting comprises actuating a motor coupled to the spring by a tensioning element. In another embodiment electromechanically adjusting may comprise changing the tension on a compression spring by actuating a motor coupled to the spring by a tensioning element. In another embodiment electromechanically adjusting may comprise changing the tension on a tension spring by actuating a motor coupled to the spring by a tensioning element.

### BRIEF DESCRIPTION OF THE DRAWINGS

FIGS. 1A-4C illustrate bottom views of various mobility configurations.

FIGS. 5A-8D illustrate side views of various balancing and mobility configurations and considerations.

FIGS. 9A-9C illustrate top views of component kinematic relationship configurations.

FIGS. 10A-11E illustrate side views of various elevation and mobility configurations and considerations.

FIGS. 12-33 illustrate schematic views of kinematic configurations pertinent to the subject robotic appendages.

FIGS. 34-36G depict embodiments and components of counterbalancing mechanisms.

FIG. 37 illustrates a schematic representation of an embodiment of a counterbalancing mechanism.

FIGS. 38A-39 illustrate embodiments and components of counterbalancing mechanism assemblies.

FIG. 40 depicts a side view of a mobility configuration.

FIGS. 41A-56 illustrate various embodiments of robotic appendage kinematic assemblies and configurations.

FIG. 57 illustrates an embodiment comprising a single arm assembly movably coupled to a mobile base.

FIG. 58 depicts aspects of a drive assembly for a mobile base embodiment.

FIGS. 59A-60 illustrate various aspects of an elevation/rotation assembly pertinent to a main body component.

FIGS. 61A-M illustrate various three dimensional orthogonal views of various components of a humanoid robot assembly.

FIG. 62 illustrates a schematic of a power system.

### DETAILED DESCRIPTION

As discussed above, an integrated humanoid robotics platform is desired. What follows is a detailed description of various embodiments of an inventive humanoid robotics system, addressed component by component, preceded by a discussion of various design configurations that are infused into the components and greater system.

1. Functional Considerations:

Fundamentally, for the robot to be useful in human environments and perform tasks for people, it desirably will have certain capabilities similar to those possessed by humans. For example, it would be desirable for such a robot to support loads of up 50 Newtons (10 Lbf) with one arm; grasp, carry and place a standard brick with one hand; use both arms to move a full pot of water from one counter to another; open light-weight doors, cabinets, drawers with one hand; pick up dishes from a standard table and place in a dishwasher; move over relatively flat surfaces, such as those presented with hard floors or low-pile rugs, at up to 2 meters per second; move over obstacles, such door thresholds, floor-rug transitions, extension cords; and/or navigate wheelchair accessible areas, such as doors, elevators, ramps, and hallways.

Preferably the robot also is safe in the human environment operating around humans. Preferably both the hardware and software systems should be integrally designed from the ground up to ensure that all safety concerns are addressed. Mechanical safety design preferably comprises minimizing inertia, providing back-drivability, eliminating pinch points, carefully managing kinetic and potential energies as well as force output, and making appropriate materials selection. Software design safety preferably comprises layering of code for sensor and actuator fault tolerance, and establishing mechanical energy limits and checks to ensure that bugs which may be present in high-level software code cannot manifest themselves as unsafe robot performance.

Robustness relative to the implementation environment is also desirable. In other words, the robot preferably should tolerate, relatively gracefully and without significant downtime, software code that may be in suboptimal form, and/or unexpected environmental conditions. For example, preferably the mechanical systems are robust enough to handle collisions of various sorts. Further, it is desirable to have a layer of software code configured to ensure that commands to electromechanical actuators do not break or fail components of the robot.

As described above, payload is also an important consideration. Up to now, robots generally have been strong and massive, or weak and light, but not both strong and light. Payload ratios (payload divided by manipulator weight) for human-sized industrial robots are on the order of 1:10, compared to a human arm ratio of approximately 1:1. The subject system embodiments preferably have a human-like payload ratio facilitated by an innovative gravity compensation mechanism that reduces structural weight, electric motor mass, and torque requirements, while still accommodating heavy loads. The accomplishment of an order of magnitude reduction in structural mass has significant implications on safety, usability, and appropriateness of use in human environments. This gravity compensation system provides compensation for both the arm and payload removably coupled to the arm. This reduces the need for significantly large motors in the arm, and enables the use of backdrivable transmissions, which is valuable for human and robot safety in unstructured environments. As is described below in further detail, the preferred gravity compensation embodiments utilize compression springs, highly-geared motors, and tension members such as steel cables or belts mounted to the arm segments in a kinematic arrangement that provides gravity compensation throughout all arm configurations. Such gravity compensation actuation preferably allows the arm segment structures to be lightweight and reduces the need for torque from the arm-mounted motors themselves, while also preventing their mass from compromising the arm's payload. This enables each arm to have an approximately 5 kg payload in some embodiments without limiting useful object manipulation force provided by the arm joint motors.

General mobility of the robot embodiments are also a design consideration. While fully holonomic, or omni-directional, drivetrains exist, few existing humanoid robotic systems, if any, provide robust mobility performance in real-world situations, i.e., ability to move over doorjambs, curbs, and/or extension cords. Preferred embodiments of the subject system couple a 2-degree-of-freedom (“dof”) differentially driven base with torso rotation to approximate holonomic motion for the two 7-dof arms mounted on the upper torso. With such a 2-active-wheeled base configuration, the subject indoor-environment robot embodiments can drive smoothly at speeds up to human walking speed of 2 m/s, bump over 1-2 cm obstacles like carpeting, thresholds and cords, and allow the arms to be positioned virtually anywhere in a natural human-like configuration. Embodiments of the base preferably comprise two pneumatic tired wheels with 6 Nm continuous torque applicable to each wheel, enabling a climbing capability of approximately 8 degrees. The base embodiments also preferably comprise two suspension casters, as well as batteries, power electronics and chargers. Further, base and torso assemblies preferably are coupled by a controllably telescoping and rotating joint.

Robotic arms or manipulators are a key interface of the preferred robot embodiments with the nearby environment. From a general, functional perspective, to manipulate objects that are common in work and home environments, preferred design embodiments include two arms with ranges of motion and force application configurations similar to those of human arms, each with a simple gripper capable of typical human-like grasps. Preferred embodiments also are designed to minimize physical pinch points and external wiring, as well as modularity to allow researchers to easily add specialized hardware if needed. The two 7-dof arms of some embodiments each preferably combine three shoulder rotations, elbow flexion, forearm rotation, as well as wrist flexion and rotation. Such arm embodiments preferably have a 5 kg payload each (in addition to the gripper weight) and a dynamic overhead of 15 N. A single-motor gripper embodiment, inspired by human prosthesis designs with quick-release mounting and a 100 N grip capability, may allow for hook, pinch, and cylindrical prehension of objects, typical of human grasp ability.

The control architecture of the preferred embodiments emphasizes robustness, simplicity, and flexibility from a functional perspective. Communications protocols preferably are simply defined, easy to fully implement, and designed to support flexible composition of multiple tasks. The integration of safety systems into low-level processes that cannot be accidentally disrupted preferably serves to prevent individual task failure from affecting the whole system embodiment. Such designs emphasize multiple co-existing services, utilities, and processes, a formula that takes certain cues from the flexibility, stability, and usefulness of Unix-based operating systems.

From a functional perspective, software modules preferably allow for future researchers to add their own control and sensing modules with no need to change the basic control software. Similarly, hardware additions preferably are facilitated in certain embodiments by a distributed power bus and an Ethernet backbone, augmented by short-range wireless networking. These provisions preferably make it possible to add hardware virtually anywhere on or off the robot.

Power electronics and battery configurations of various embodiments preferably allow for 1-4 hours of typical autonomy, depending on the operational situation and tasks being performed by the subject system. The system preferably can draw 2 kW of peak power and 1 kW of continuous power, a condition expected in such embodiments when manipulating heavy payloads and driving on carpeting. At this maximum continuous rating, the power electronics preferably are sized for 1 hour of autonomy. Smart-battery technology configurations preferably allow for computer monitoring of charge state and fast charges from a 110 VAC wall plug. In an alternative embodiment, a distributed controller layout may facilitate simplified electronics manufacturing, installation and maintenance.

From a functional objectives perspective, it is preferred that a developer should be able to add any type of sensor to the robot almost anywhere on the robot. Various embodiments comprise Ethernet, Firewire, USB-2, Wi-fi, serial, and analog inputs/outputs throughout the robot for additional sensors and actuators to be interfaced. For example, one embodiment comprises an interfaced stereo optical capture device, such as a camera, for the manipulation field of view, in addition to single lens cameras for peripheral vision, interfaced quite simply without the need for adding additional hardware or control capability.

Runtime and battery life is also an important functional consideration. As a typical personal computer is designed to be always available for a software developer, the preferred robot development platform embodiments are designed to be always available. As described above, a robot that is always on preferably should be robust enough not to break or malfunction, and it must have a power system having at least some portions that do not turn off. The power system developed for the preferred embodiments is hot pluggable, meaning that it can be plugged in to charge and unplugged without interrupting the power to the robot. The preferred battery assembly can run the computers and all supporting electronics for over 12 hrs without recharging, with no motor usage. Since the computers preferably are configured to monitor the remaining battery power in real-time, there preferably is ample warning of an impending battery charge need. The chargers preferably are integrated in the base, so that the robot can be plugged into any standard outlet with any standard computer power cord. In addition, a wireless emergency stop, or “E-stop”, system preferably is configured to cut off all motor actuation power directly without affecting the power to any of the computers or distributed controllers.

2. Range of Motion and Mobility:

Different environments and different applications dictate different needs for the vertical range of motion for the robot. In unstructured environments it is inevitable that the robot will make mistakes during manipulation. In most cases the robot should therefore be able to reach down as low as things can fall. If the robot can work on a table or reach a shelf it should be able to reach the floor to recover a dropped object for example. If the robot is working in a more controlled environment then the vertical range of travel needed may be reduced.

A manipulator may be defined as an articulated linkage that can independently interact with an object or the environment. There exists a tradeoff between the number of manipulators and the ability to manipulate objects. A human arm and hand for example can be thought of as five manipulators, the fingers, which generally share the common workspace of the hand. A human can use the fingers on one hand in coordination to achieve dexterous manipulation. A single arm with a simple gripper inherently has less dexterity and may need to use external forces (gravity or a fixed surface for example) to successfully manipulate an object. One option in robot design is to mimic a human arm and hand to achieve dexterous manipulation. For many classes of tasks like fine manipulation, such an approach may be preferred.

For the class of tasks where fine manipulation is not necessary, such as certain household chores, many tasks can be completed with an embodiment having only one arm with a simple gripper. If the number of arms is increased, then additional dexterity and manipulation efficiency can generally be achieved. In a two arm configuration with simple grippers, gross manipulation can almost always be achieved as long as the object is light enough that one arm can bear most of the objects weight at a given time, and the object is large enough that it can be affected by both grippers or arms in concert. It is generally preferable that the workspaces of each arm must overlap at least a little (and/or the object being manipulated may be large enough to span the distance between the two workspaces) to facilitate both arms reaching the object at the same time.

As noted above, multiple arms can make single tasks more efficient through increased dexterity. The use of multiple arms to enable tasks to be done simultaneously can also enhance task efficiency. For example, the task of simultaneously having a mobile robot carry an object with one manipulator and open a door with another manipulator has not been demonstrated with conventional configurations. For any task in which multiple separate systems would normally be needed, a single platform with multiple arms can be used.

While graspers or grippers are generally featured in the depicted embodiments as distal end effectors, many other end effectors may be utilized. For many applications such as manufacturing, pick-and-pack, or similar work, such as operating a coffee shop, one or more specialized end effectors may be preferred. Specialized grippers or tools may be configured to make certain applications more robust, and to lower costs, in addition to other benefits.

For general manipulation tasks it is preferrable that the horizontal workspace be sufficiently large to accommodate the environments in which humans generally work. This includes around appliances, kitchens, tabletops, doors, and doorways. It is also important that the workspaces of the arms ensure that in certain poses, the whole system is narrow enough to clear spaces such as doorways and other obstacles.

Humans have preconceived ideas about robots from exposure to examples in industry and science fiction. As described above, one primary concern is the safety of robot and human interaction. Many people assume that robots have a level of situational awareness and reactions similar to what humans typically possess. Even if this someday becomes reality, humans can easily hurt each other, often by accident. In the meantime, between the current state of robot technology and human like artificial intelligence, robots are going to be somewhat clumsy tools, and it will be very difficult, if not impossible, to eliminate all possibility for robot-related injury to humans. Making a robot appear toy-like or human-like may invite people to engage the robot more closely than is safe. Making the robot's appearance not evoke human like functionality can be an effective way to redefine the relationship between robots and people. Early functionality in robots may be more tool based than general intelligence based. In other words, early robot embodiments will be designed to do specific well-defined tasks; ensuring that people respect the workspace such robots while they are doing such tasks may be important for safety, and one way to achieve this is by intentionally controlling the way the robot looks.

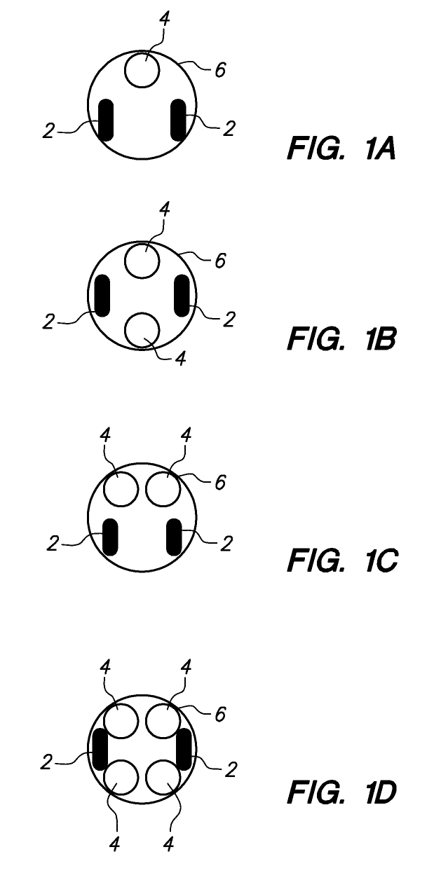

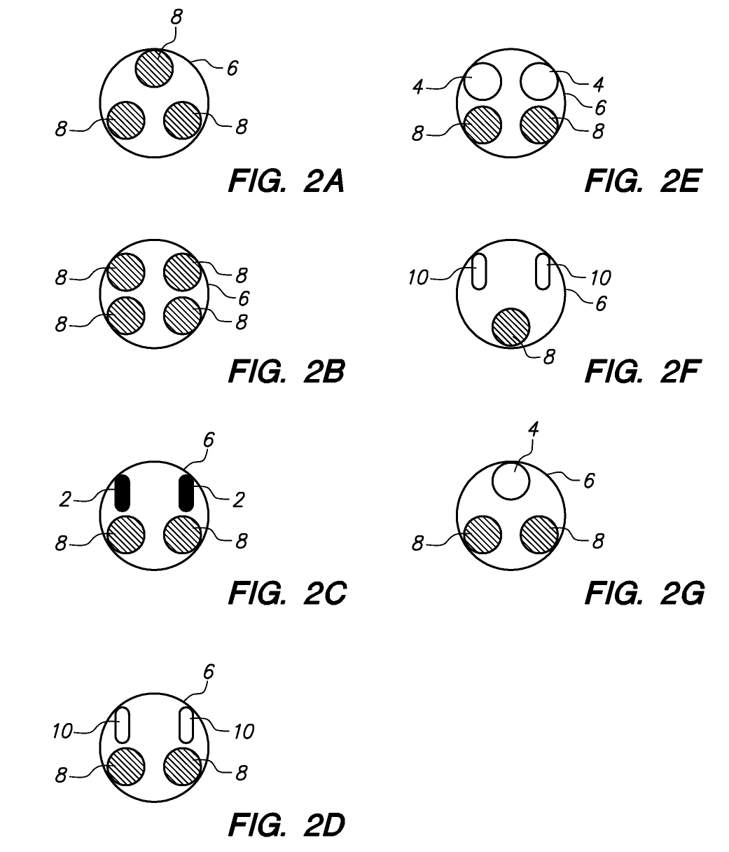

Mobility is fundamental for robots that work in human environments because by nature human environments rely on our mobility to get around those environments. In general there are two classes of accessible spaces in human environments, wheelchair-accessible spaces where an appropriate set of wheels will get a robot around, and non-wheelchair-accessible spaces where additional functionality is required for mobility. In one embodiment for wheelchair-accessible spaces, differential drive with casters configurations may be preferred. Referring to FIGS. 1A-1D, four variations of mobile bases comprising combinations of driven wheels (2) and omnidirectional stabilizers (4), such as casters, are depicted for maintaining balance, stability, and mobility. Each of the omni-directional stabilizers (4) may be a skid plate, an omni-directional wheel, any type of caster wheel, a steered wheel, or the like. Generally the two driven wheels (2) are parallel and have nominally collinear axes as depicted in FIGS. 1A-1D. Note the shape of the base (6) may vary; it is depicted as round in FIGS. 1A-1D for illustrative purposes only. Referring to FIGS. 2A-2G, seven variations of mobile base configurations comprising wheels that can be both actively steered and actively driven (8), as well as more conventional passive wheels (10) and driven wheels (2).

Referring to FIGS. 2A-2F, various embodiments for base (6) mobility combining passive wheels (10), actively driven wheels (2), omnidirectional stabilizers (4), and wheels that are both steered and driven (8) are illustrated.

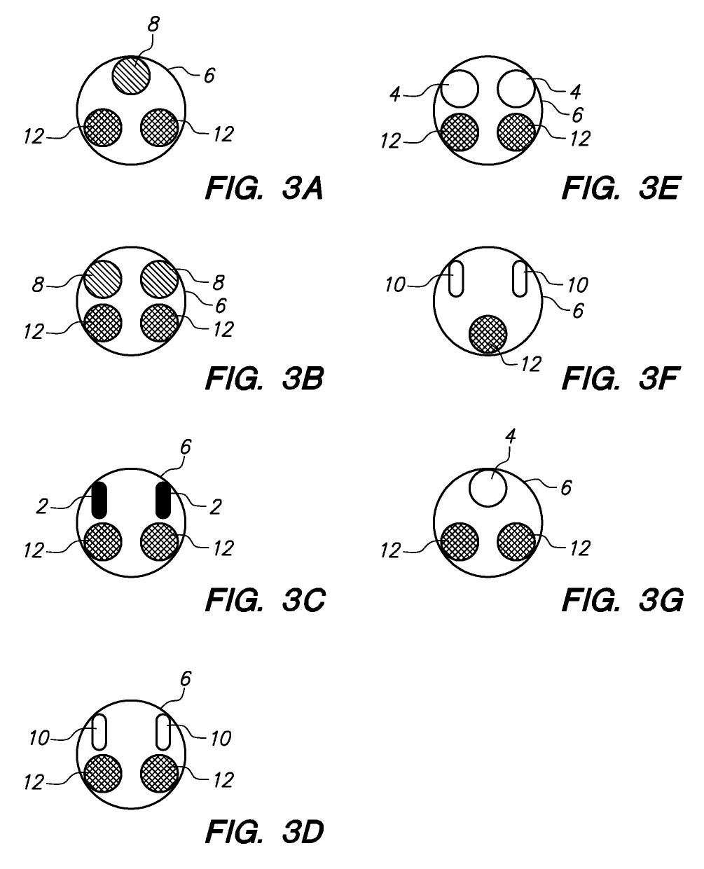

Referring to FIGS. 3A-3F, various embodiments for base (6) mobility combining passive wheels (10), actively driven wheels (2), omnidirectional stabilizers (4), wheels that are both steered and driven (8), and wheels that are actively steered but not driven (12) are illustrated. The fixed driven wheels (2) depicted in FIG. 3C may be driven together (through a differential, for example), or separately.

A holonomic configuration is one that can drive in any direction and turn at any time. Holonomic configurations may be implemented using omni directional wheels that can be actively driven in one or both directions. Any one or more of the wheels in the abovedescribed configurations may be replaced with a holonomic wheel. If all of the wheels in a given embodiment are holonomic, or at least two holonomic wheels are combined with omni-directional stabilizer(s) (4), the base (6) may be considered fully holonomic.

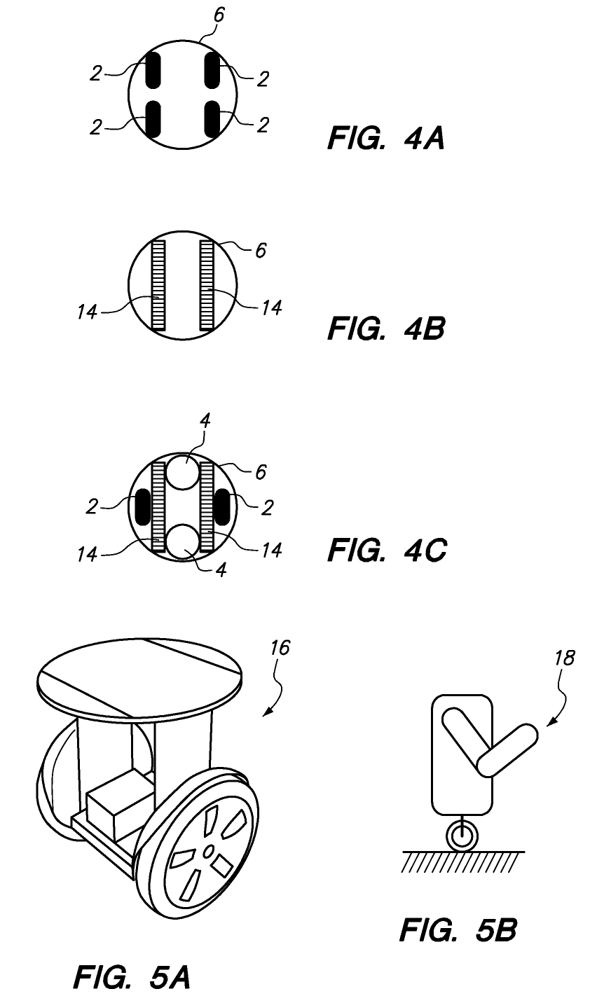

Skid-steer type embodiments may also be desired for base mobility. Referring to FIGS. 4A-4C, embodiments are illustrated wherein no parts of the drivetrain are steered, and wherein wheels or tanklike treads (14) are utilized for mobility. The treads (14) may be conventional tanklike structures, or may be articulated in a manner similar to those sold with the product tradenamed “Packbot”® by iRobot Corporation. Such specialty treads may be combined with aspects of wheeled drivetrains for general mobility, as illustrated in FIG. 4C.

A mobile base may be interfaced with the ground using two or four wheel balanced configurations. Referring to FIG. 5B, a mobility configuration (18) featuring side-by-side wheels driven differentially for steering and actively driven to balance the robot's load above them may be utilized, somewhat akin to the functionality of a commercially available two-wheeled robotic mobilization platform (16) depicted in FIG. 5A, as available by Segway Corporation.

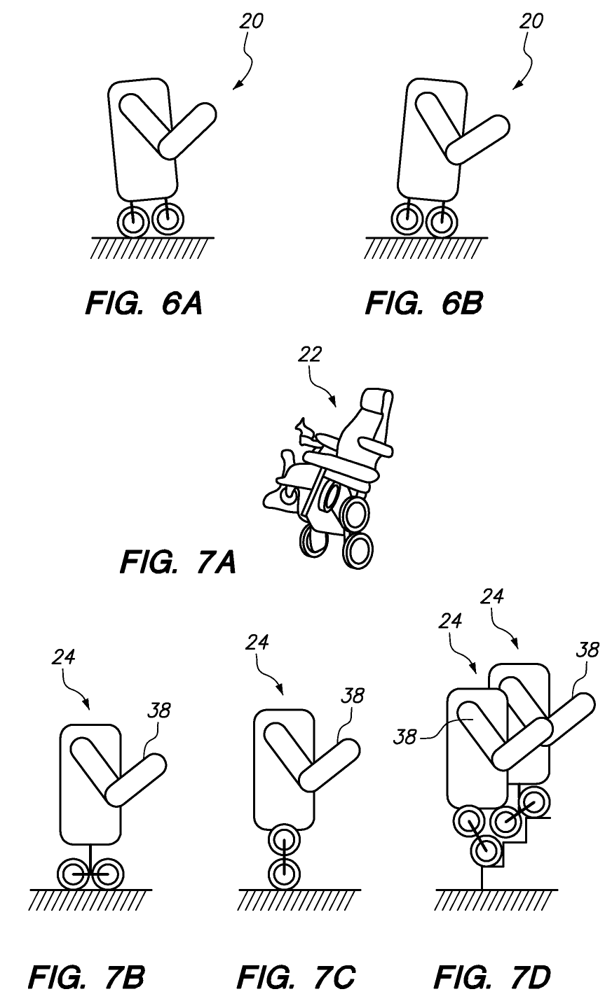

Referring to FIGS. 6A (accelerating forward—to the right) and 6B (accelerating backward—to the left), one of the main drawbacks of a two wheel balancing implementation is that the system may be prone to trip if it tries to back up or advance over a fixed object but is stopped by the object. A configuration (20) featuring two sets of two-wheel-balancing wheels may be desired in such a scenario. When moving forward, it would balance on its rear wheels, and when moving backward, it would move on its front wheels. In these instances, if it were to trip, it would fall onto a stable configuration.

Non-wheelchair-accessible spaces present additional challenges for mobility. Referring to FIGS. 7B-7D, a four-wheel configuration such as that featured in the base if the product sold under the tradename “Ibot”® by Segway Corporation (22 in FIG. 7A) may be utilized to mobilize a robot body (24) and arms (38). In such a configuration, the two sets of balancing wheels can pass over one another, enabling the robot to climb stairs, adjust its workspace vertically, get close to a work surface, and drive across rough terrain in a skid-steer configuration, all depending on the setting of the operating mode of the wheels.

Multi-legged locomotion may be an appropriate solution for many environments, especially in rough terrain. A robot body and two arms mounted on a set of two or more legs is more human or animal-like than a wheeled version and may be suitable for more challenging environments than wheelchair-accessible areas. Combinations of legs, wheels and/or tank treads may be utilized in certain embodiments to provide a balance between the ability to traverse non-wheelchair accessible environments and efficient mobility. Separate leg and wheel systems or wheels on the ends of legs may also be appropriate.

From a stability and safety perspective, each of the above mobility systems may be augmented with fault protection systems such as airbags that inflate to cushion a fall, or stabilizer links that extend like an airbag to break a fall.

Various combinations of wheel types (like pneumatic, plastic, rubber, foam, hybrid and others) and/or suspension schemes may be implemented on all of the above wheeled configurations. Mechanical compliance in these systems may make manipulation challenging. In many cases, modeling the dynamics of the compliance in these systems or the use of sensors may not be enough for adequately controllable manipulation. In these cases direct-to-ground stabilization of the mobility system may be necessary in much the same way that a crane has legs that bypass its wheels to stabilize it for manipulation.

In most configurations, placing as many internal components as low in the robot as possible is advantageous for stability, lowering the center of gravity. Generally, when possible, the batteries, charger systems and other electronics are placed in the bottom of the base embodiments. Most of the configurations outlined above may be considered static mobility platforms. That is to say, in a given pose of the robot, if the robot were to lock up all of its joints, the robot would not fall over. To maximize static stability, the stability footprint preferably is designed as large as possible, given space constraints, and the center of mass is placed as low as possible. Generally, the side-to-side width limit of the stability footprint may be determined by the narrowest spaces that the robot is to pass through, like doorways and hallways. The front-to-back depth limit of the robot may be determined by the desired proximity to work surfaces. In many human environments, countertops have recessed baseboards and tables have clear space between their support legs, making it advantageous to keep the robot base itself as flat and low as possible so that it can move into the clear floor spaces these workspaces offer. This allows the arms to reach farther across the work surfaces than possible otherwise.

The robot body (6) may be defined as the mechanical section or portion that connects the mobility system(s) to the arms. Its main functions are to extend the range of motion of the arms and to configure itself to adjust the overall center of mass of the robot for safety.

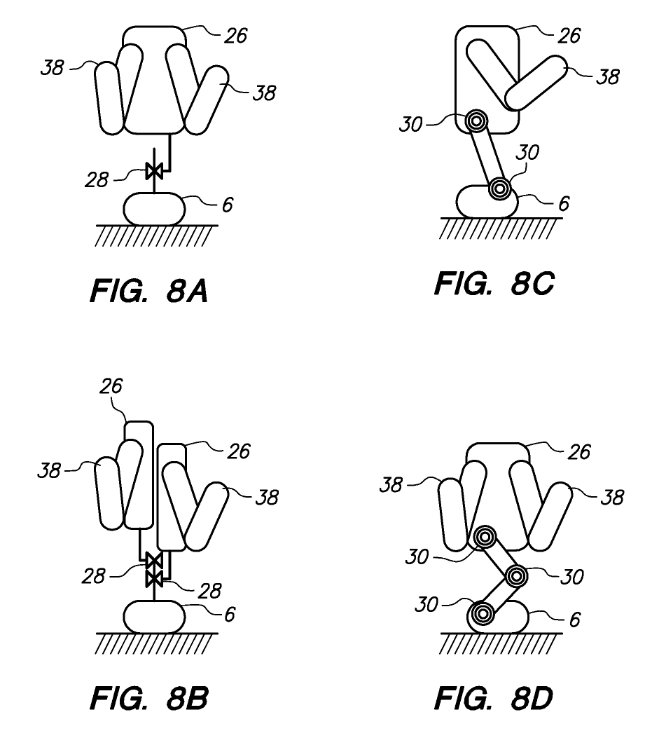

In some of the mobility configurations, the ability to raise and lower the workspace of the arms is part of the mobility scheme. This includes various types of legged implementations, legged-wheel implementations and iBot®—style implementations. In many other mobility implementations, vertical adjustment of the arms' workspaces may be implemented by the body of the robot. Even in mobile base implementations wherein the base itself has vertical adjustment, additional vertical adjustment may be implemented in the body. FIGS. 8A-8D illustrate various joint configurations using prismatic (28) and revolute (30) joints to accomplish vertical adjustment of the arm (38) workspace.

With motion of a robot's arms, the center of mass of the robot may be always changing in both the vertical and horizontal planes. Depending on the number of arms, the mass of the arms, the range of motion of the arms, the length of the arm links and the arm payload, the center of mass of the robot can vary greatly throughout the various configurations of the arm. Some mobility configurations can help maintain stability of the robot dynamically. In some cases the mobility configuration can be stable enough that the robot will simply never fall over for all arm configurations. In most scenarios it is advantageous to have additional control of the center of mass of the robot to compensate for the arm motions, payload and varying terrain.

One method for keeping the robot stable is to add mass to base of the robot. This mass may be statically mounted to the base. A reduced mass may be equally effective in increasing stability if it is actively articulated and used to offset the motion and payload of the arms.

If the entire center of mass of the body can be adjusted so that the center of mass of the robot can be kept inside the stability footprint, this may assist in keeping the robot upright. Several factors that may be taken into consideration are: uneven terrain, static and dynamic forces induced from arm and payload dynamics, and external forces on the robot. Note that all of the configuration examples of prismatic and revolute body adjustments illustrated in FIGS. 8A-8D would contribute to stability when lowered in the case of the prismatic examples and when lowered, adjusted front to back or side to side in the revolute examples. Additional examples are discussed below.

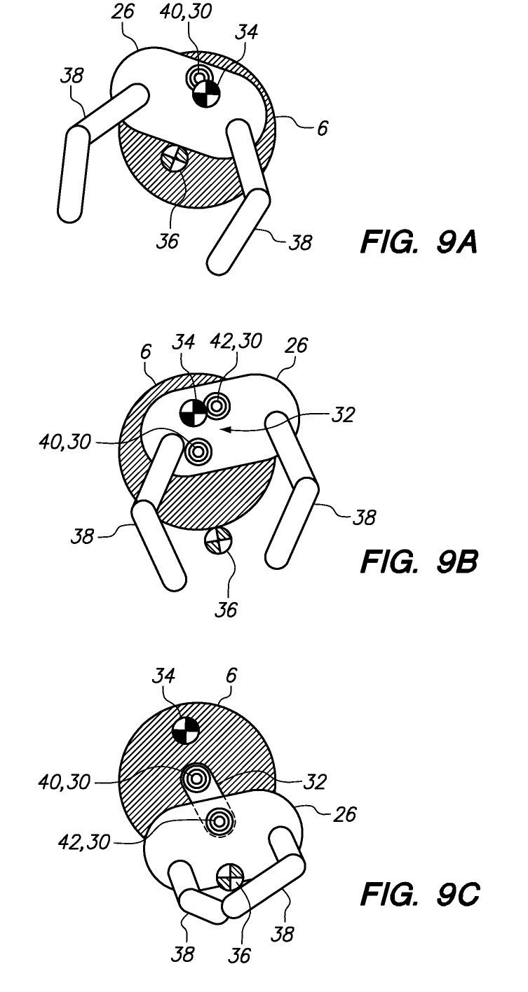

Vertical revolute axes may also be utilized to adjust the center of mass. Referring to FIGS. 9A-9C, a simple pan degree of freedom between the base (6) and body (26) may be utilized. Referring to FIGS. 9B and 9C, this may be implemented by interposing a coupling member (32) between the base (6) and body (26), and having two revolute joints (30) for such coupling providing two different axes of rotation (40, 42). By placing the axis of rotation of the revolute joint (30) so that it does not pass through the center of mass of the upper body (26) enables this adjustment. Additional pan degrees of freedom may be put in series to enable further adjustment of the center of mass, as shown in FIGS. 9B and 9C.

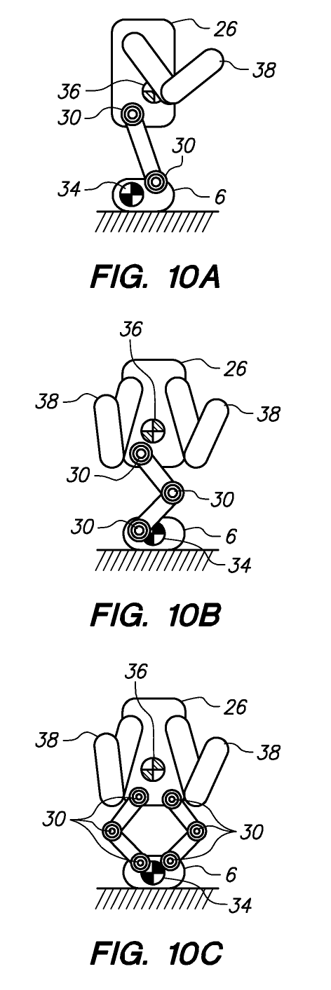

Referring to FIGS. 10A-10C, non-vertical revolute joints may be utilized to adjust the center of mass with up to three degrees of freedom, depending upon the number of joints utilized. FIG. 10A illustrates an implementation with one actuated link attaching the body (26) to the base (6); FIG. 10B illustrates an embodiment wherein the height and front-to-back and/or left-to-right position of the body and arm center of mass (36) may be adjusted (pictured as left-to-right only); and FIG. 10C illustrates an implementation with multiple jointed legs connecting the body (26) to the base (6). The direction of the axes in these diagrams is depicted in the horizontal plane, but they may be at any angle, as appropriate.

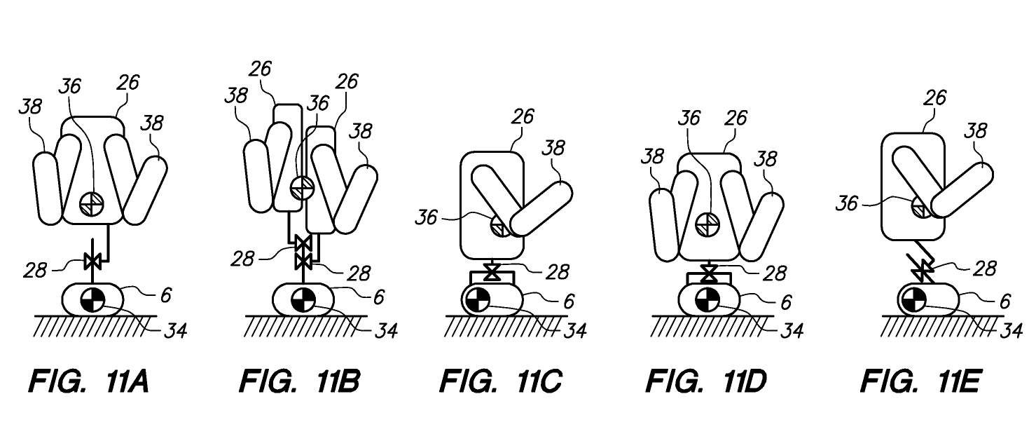

The center of mass may also be adjusted with prismatic joints. FIGS. 11A-11E illustrate some of the many such implementations. These illustrated embodiments generally are one degree of freedom embodiments, but combinations of multiple prismatic and/or revolute joints may also be utilized.

A further aspect of various embodiments of the robot uses the “force vectoring” spring-based actuation system outlined below as a gravity counterbalance. In a gravity counterbalancing implementation, the output force vector of the system is fixed relative to the body. It may be advantageous to be able to reorient the direction of that vector. One possible way to reorient that victor is simply to tilt the body itself. Changing the direction of the counterbalance vector relative to base can be useful when the base is on uneven terrain or additional force is required in a direction perpendicular to gravity, for example, to exert force on an object or obstacle. Any type of pivot joint that reorients the body relative to the base may add one or more degrees of freedom with this effect.

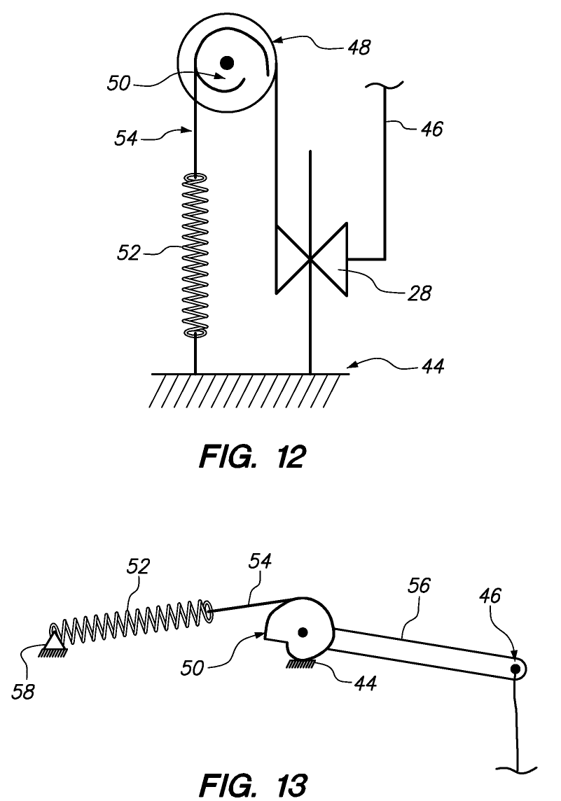

In some cases, the counterbalancing of the body joints reduces the torque requirements on the joint's actuator by offsetting the torque created by the mass of the link. This places less of an emphasis on perfect counterbalancing and more of an emphasis on removing most of the actuator's load. Controlling such a system is more problematic by the changing torques and loads imparted by the arm and payload dynamics on these joints. Referring to FIG. 12, a passive counterbalance configuration in a prismatic joint is depicted wherein a counterbalance force is not adjustable, but actuation can be added to modify the counterbalance force. A spring (52) is coupled to a cam-shaped pulley (50) by a spring extension tensile member (54). The cam-shaped pulley also has an output pulley interface (48) that is coupled to the prismatic joint (28), which is coupled (46) to a load (not shown). The output pulley interface (48) may also be cam shaped.

Referring to FIG. 13, a passive counterbalance implementation embodiment in a revolute joint is depicted, wherein a spring (52) is coupled by a spring extension tensile member (54) to a cam shaped pulley (50), which is coupled to a structural member (56). The structural member (56) is coupled (46) to the load (not shown).

Any of the abovedescribed joint types may be combined to result in a solution that uses appropriate vertical height adjustment, center of gravity control, range of motion enhancement, and/or force vectoring.

3. Robotic Arm Considerations:

The quality of the manipulation of objects and interaction with the environment are to a large extent the result of the design of the arms, or “manipulators”, themselves. This section covers considerations utilized to achieve safe and high-performance manipulator embodiments, and the geometry of arm links using this design approach.

Robots preferably comprise actuated joints. Generally, actuators in mechanisms may act in joint-space, and apply torques directly or through transmissions to the joint rotation axes. Frequently, however, the tasks of a robot system involve forces and motions of the end effectors in what may be termed the “world coordinate system”. Transforming from world-space coordinate system to the joint-space representation requires computation, and precludes using some forms of mechanical components (such as springs and dampers) directly on the joints to perform tasks in the world coordinate system.

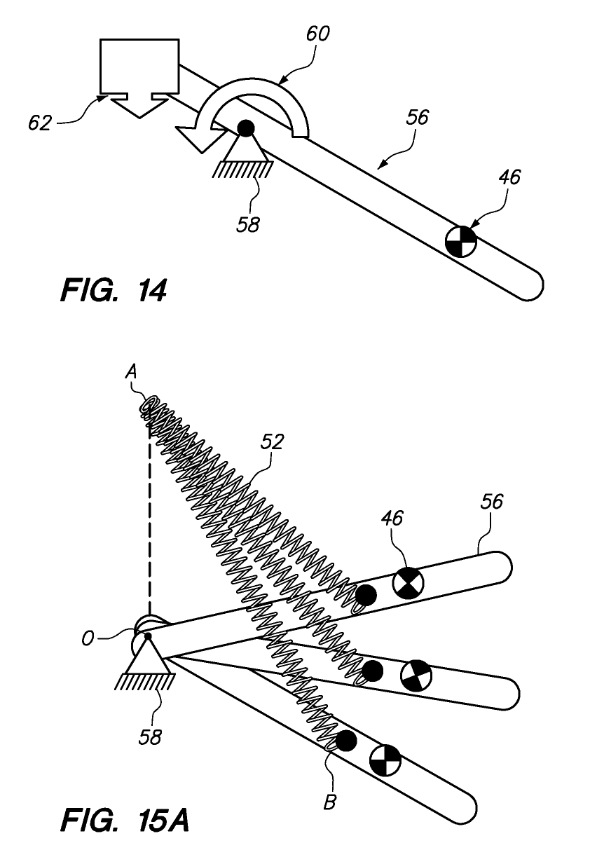

One common example of this is balancing gravity. There is no constant joint torque that can be applied to a link that rotates around a fulcrum to counteract the effect of gravity on it, however the effect of gravity can be substantially or wholly eliminated by the addition of a suitably sized and located counterbalance mass on the side of the link opposite it's center of mass. Solutions like this can be very advantageous, because they function without sensing, computation, or power usage, and can cause effects (such as floating the arm) safely and reliably. A simple counterbalancing configuration is depicted in FIG. 14 wherein a counterbalance mass (62) is located at one end of a structural member or “link” (56), a payload (46) is mechanically associated with the other side of the link (56), and joint torque (60) is applied about a point of rotation of the link (56) which is associated with a fulcrum structure (58).

The use of a counterbalance mass, however, is often impractical because of the added inertia and mass to the system and because without complicated mechanisms to redirect the force that they generate they can only provide a force to the mechanism in the direction of gravity. The illustrative embodiments of counterbalanced arms described herein explore a range of mechanisms which we call “spring-based force vectoring systems” which preferably exhibit many of the advantages of mass counterbalancing while avoiding the added inertia and having applicability to a much broader range of situations other than counterbalancing against gravity.

Force vectoring systems preferably employ a mechanism designed to apply a torque equivalent to the torque that would be induced by some force at some specific point in a mechanical linkage. We refer to that equivalent force as a “virtual force” and the point as the “virtual force point”. The linkage can be part of a robot arm. The force direction can be, but is not necessarily, opposite the force of gravity, i.e., vertical and directed upward relative to the earth. The specific point on the linkage is commonly, but not always, the end of the link where the payload of the link is applied. A key aspect of a force vectoring mechanism is that the virtual force vector does not change with movement of the joint of the link. This constant force may be applied to the linkage by exerting a varying torque about the joint of the linkage with a mechanism using a combination of cables, pulleys, bars, and other components that has a geometry specific to the design. Adding actuation to adjust the parameters of this inherently passive design can change the virtual force vector in direction or magnitude.

One advantage of a non mass-based force vectoring system over mass-based counterbalances is that in applications requiring a large offset force, for example counteracting the weight of a somewhat heavy robot link, the added weight of a force vectoring mechanism is significantly less than a mass-counterbalance or a large actuator capable of a similar torque and dynamic response. Added weight in personal robot arms may render them less safe around humans. The use of a large actuator to generate joint torques results in a stiff, heavy system as well, also somewhat unsuitable for use around humans. Combining a lightweight force vectoring system with a small compliant actuator to move the payload of the robot results in a strong robot with lightweight arms.

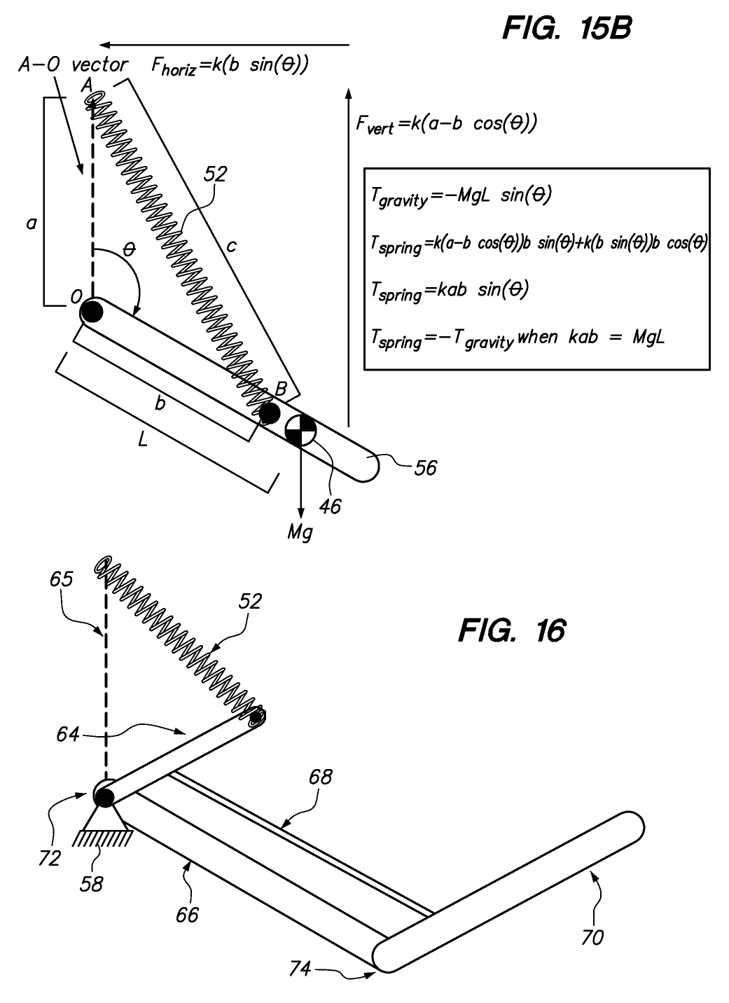

One basic observation behind many of the subject spring-based actuation system embodiments is that a spring “K” with a stiffness constant of “k” and a rest length of zero from a grounded point “A” to a point “B” on a rigid body that pivots around a point “O” will induce a torque on that body about “O” that is equivalent to the torque that would be induced by a force vector (A−O)*k applied at point B. A simple configuration comprising a link (56), a coupled payload (46), a spring (52), and a fulcrum point (58) is depicted in three positions to illustrate movement in FIG. 15A. Illustrative points A, O, and B are depicted. We refer to the applied force as a “virtual force”, and the location where it is applied as the “virtual force point”. Taking advantage of this lets us apply and control that virtual force by controlling the points A and B, as well as the spring K. One key consideration is that for a given configuration of A, B, and k, the direction and magnitude of the virtual force remains unchanged throughout the travel of the link.

An extension to the above-described principle is as follows: applying a virtual force F to any point P is equivalent to applying a virtual force of C*F to a point located at (P−O)/C, for any constant C. This means that as long as the point B lies on the line between O and any point P on the link, the virtual force scales appropriately, and our virtual force point is moved to point P. Through the rest of this detailed description, it is assumed that applying a virtual force vector to the link implies the effect of the virtual force at some point along the link (generally the center of mass or nominal payload position).

Referring to FIG. 15B, a spring-based vectoring system to counteract the constant force of gravity from a mass M at distance L along the link (56), along with the derivation to show how it applies for any angle theta. This also demonstrates the movement of the virtual force point from B to P. The constant C in the discussion above would be C=L/b. The same reasoning behind this example applies for counteracting any other given force.

The exemplary embodiment above illustrating the principle for a 1 degree-of-freedom link can be extended to multi-joint and multi degree-of-freedom linkage embodiments as well. Referring to FIG. 16, a four-bar linkage configuration is depicted having a spring (52), a distal link parallel bar (64), a proximal link joint (72), a proximal link member (66), a distal link joint (74), a distal link (70). And a connector bar (68) configured to keep the distal link (70) parallel to the distal link parallel bar (64). In this four-bar mechanism, using a connector bar (68) of the same length as the proximal link (66), the distal link parallel bar (64) is maintained parallel to the distal link (66). The spring (52) for the distal link force vectoring can be attached to the distal link parallel bar (64) rather than to the distal link (66) itself. Additionally, in three-dimensional space, the whole arrangement can pivot around the vertical dotted line (65) without changing the force-vector properties. The virtual force exerted on the distal link (70) remains constant independent of any of the joint angles in the system. In addition, if the distal link (70) rotates about the axis along the length of the proximal link (66), and assuming that the distal link parallel bar (68) is constrained to remain parallel to the distal link (70), the distal link virtual force vector also remains unaffected in magnitude or direction. The configuration depicted in FIG. 16 illustrates how, schematically, additional serial links can driven using the same vectoring method. For example, the proximal link (66) could have its own spring-based force vectoring mechanism, which would be independent of the distal link force vectoring mechanism. The mathematical derivation for distal links is identical to that for the single link.

This mechanism can be implemented in different ways, including linkages, belts, cables, pneumatics, and hydraulics. The role of this mechanism is to maintain the appropriate kinematic relationship between the distal link parallel bar (68) and the distal link (70). In the case that the mechanism is not a connector bar, the spring would mount to the mechanism that implements the kinematic relationship. Other parallel mechanisms are described below.

There are a number of ways of setting up a spring-based actuation system so that the virtual force generated is adjustable. First, the virtual force applied to the link may be adjusted by moving the point A (point names as defined above and utilized in the Figures). Moving it towards and away from point O will scale the magnitude of the force, and unconstrained movements can change the direction and magnitude of the force vector correspondingly, since the virtual force is proportional to the vector (A−O). Moving B further from O will scale the virtual force up, and moving B closer to O will scale it down. Adjusting k is frequently difficult to do, but also has the effect of scaling the virtual force.

When multiple spring systems of this type are combined, the output virtual force vectors add as any force vector sum does. This effect can be utilized in many ways to allow a much greater dynamic range of output forces to be achieved from relatively small motions of the point A or adjustments of other parameters.

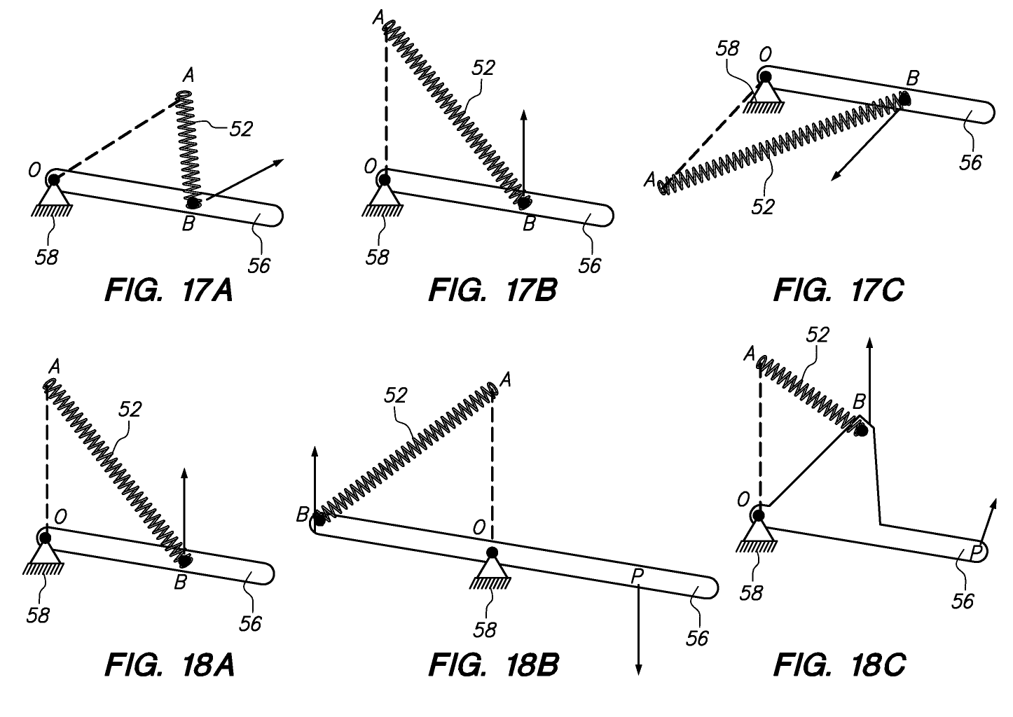

It is often desirable to change the direction and magnitude of the force vector. Referring to FIGS. 17A-17C, spring attachment point A is kept at a constant distance from the fulcrum. The dotted line between the fulcrum and A determines the direction of the force vector. Its magnitude is proportional to the distance between point A and the pivot O. FIGS. 17A, 17B, and 17C show three configuration embodiments. Changing the location of A can be effected by, for example, an actuator, manual adjustment or can be built into the design as a feature. In this arrangement the direction of the virtual force vector is always along the line between point A and the pivot O, and is also proportional to the distance between point A and the pivot O. When the virtual force point P is taken to lie out of line with B and O, then the direction of the virtual force can change direction also. This principle works in the same way for multi link mechanisms and multi degree of freedom linkages as well.

Another technique for changing the direction and magnitude of the force vector is to move point B on the link. FIGS. 18A-18C depict representative embodiments. The same principles illustrated here for changing A and B apply to multi-link and multi degree of freedom linkages as well (not shown).

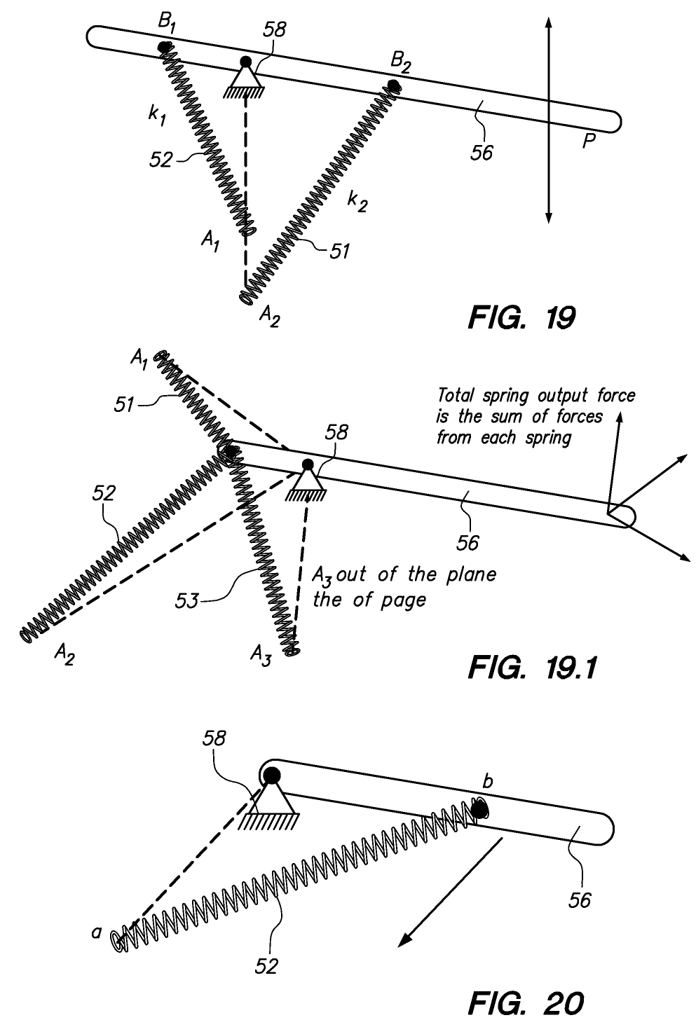

The effects of the virtual force vectors induced by multiple springs add with one another. In the case illustrated in FIG. 19, two springs (51, 52) are implemented opposing one another in exactly opposite directions. By varying A1, B1, k1 and/or A2, B2 or k2, the magnitudes and directions of the two forces can be modified.

In the case where the locations of the A points are the only parameters being varied, this configuration allows the virtual force at P to be changed significantly, including changing the direction in which it acts from up to down smoothly through zero, by relatively small motions of the two points A1 and A2, and without requiring either point to pass through O as would be required to adjust a single spring's induced virtual force through zero.

Referring to FIG. 19.1, a generalized three-dimensional force vector summing embodiment is illustrated. Using multiple springs (51, 52, 53), with attachment points Ai and Bi placed so that they span space, arbitrary forces vectors can be achieved in full three-dimensional space by adjusting just the magnitude of the three systems. Any of the Ai, Bi or Ki can potentially be adjusted to modify the direction and magnitude of the resultant force vector sum.

Since the virtual force is ultimately realized as a torque around an axis, for a joint that has only a single degree of freedom, any component of the virtual force along that axis has no contribution to the torque and can be ignored. Referring to FIG. 20, the fulcrum (58) is a simple one degree-of-freedom axis perpendicular to the plane of the page. If point A or point B is moved out of the plane of the page in a direction normal to the page, the projection onto the page will remain the same, and the 2D force vectoring calculations will remain valid in this plane (and thus around the axis perpendicular to this plane).

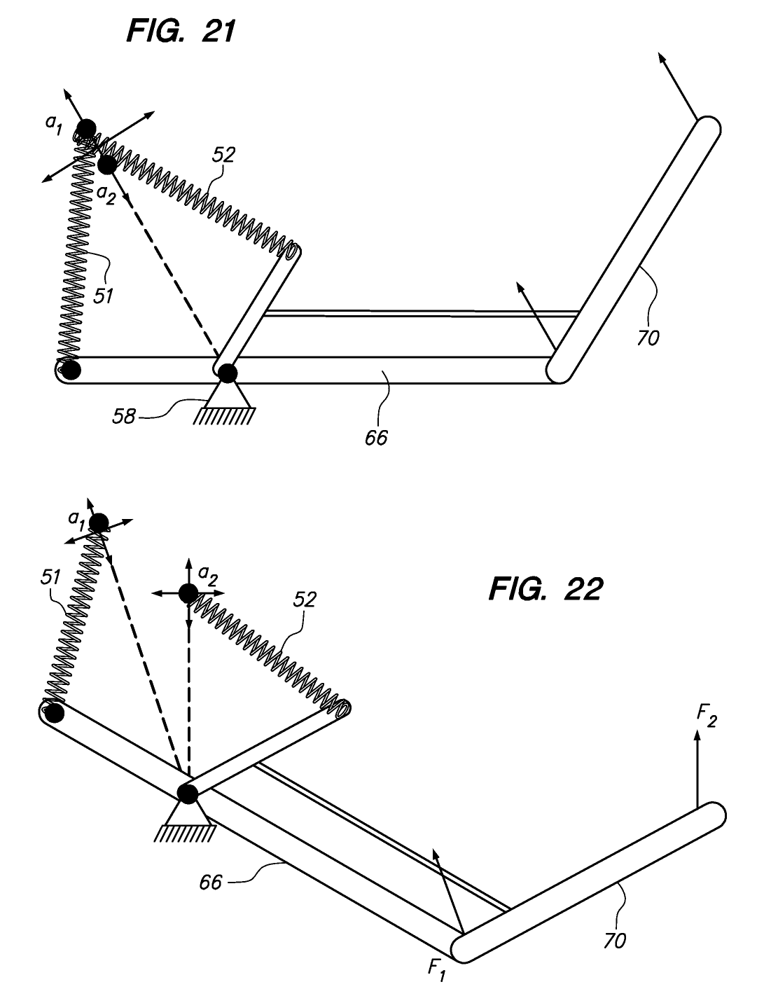

Referring to FIGS. 21-23, various serial linkage configurations are illustrated. For any serial linkage the fixed A, B and k values can be set so that only a single degree of freedom actuation system, coupled to one each, A, B or k from each link, would be required to adjust the virtual force vectors applied to each link in parallel, thus applying a virtual force to the system endpoint that will be supported by the entire serial linkage. To accomplish this, it is sufficient to pick the k values and the B locations for each link so that the distance between O and B multiplied by k is constant for the system attached to each link. In that case, the overall virtual force induced in the whole serial linkage will be proportional to the vector A−O. If additional constant-force offsets are desired, such as to balance the force of gravity on the linkage, then the A points for each linkage would have to be placed in different locations accordingly to provide that static offset, but could still be adjusted rigidly together. This principle extends to systems with an arbitrary number of links and additional degrees of freedom. Referring to FIG. 21, an embodiment is depicted wherein points “a1” and “a2” are mechanically coupled together and adjusted together to vary the magnitude of the output force vector. Internal forces are dealt with automatically by virtue of such configuration.

Referring to FIG. 22, independent 2D actuators are used to adjust the two spring (51, 52) systems, resulting in the application of two force vectors, F1 and F2, on different links of the mechanism. This is useful if it is desired for the mechanism to exert different forces at different points along the structure.

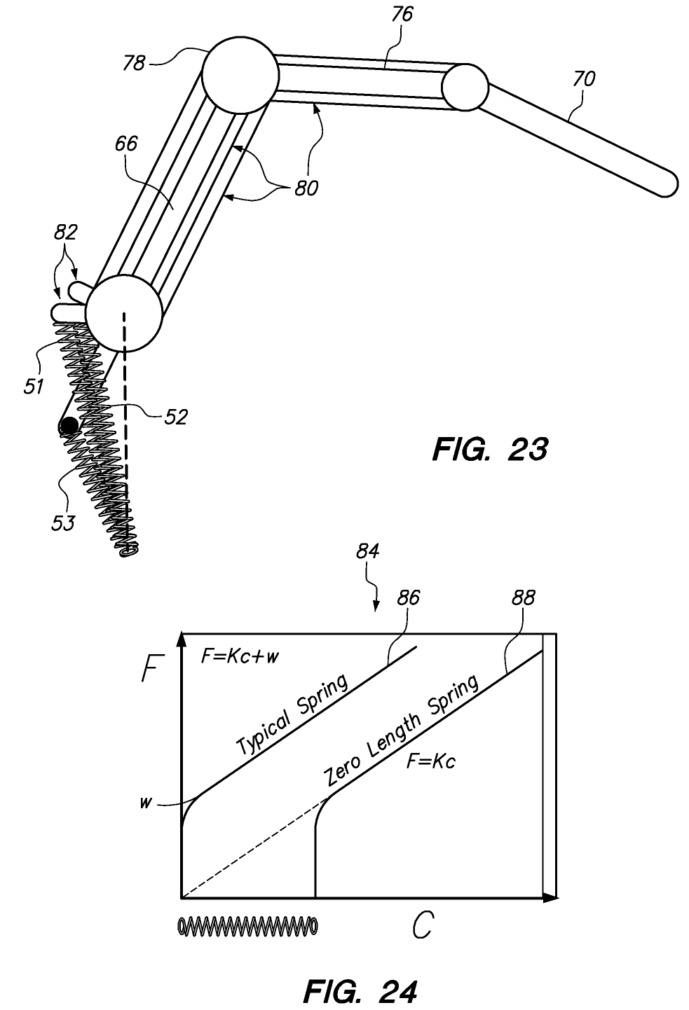

Referring to FIG. 23, a three serial link configuration is depicted, comprising a distal link (70), a middle link (76), and a proximal link (66). In this illustration the links are maintained parallel to their balance link extensions (82) using belts (80). The link extensions (82) are coupled with two of the springs (51, 52). This system may be used to float a three-link structure against a constant force such as gravity if a compensation system is needed.

A special case of force vectoring is gravity compensation. When the virtual force is oriented to exactly oppose gravity, and can counter either the static masses of the links, or also adjustable masses such as payloads. Just as in the general case A, B or k can be adjusted to compensate for changing the mass being help up (or the distance from the center of mass to O), or to exert an additional force in the direction of gravity.

In the math demonstrating the fundamental concept behind spring based force vectoring, the spring (52) pictured between points a and b is assumed to have a force-displacement curve of F=kc, where “c” is the distance between points a and b. Many commercially available tension springs have a preload offset “w” that results in the following actual spring equation: F=kc+w. This difference is illustrated in the plot diagram (84) of FIG. 24, wherein a typical spring relationship (86) may be compared with a zero length spring relationship (88).

In designs that implement the spring-based force vectoring principle, a physical spring is not generally placed between points a and b. This is usually motivated by implementation limitations such as self-intersections that limit the range of motion of parts. Generally the spring between points a and b is implemented by putting a tension member (a linkage, cable, string or other extension) between points a and b and running that tension member through a pulley arrangement (an appropriate pulley, cam or linkage arrangement—various embodiments are described below) to a physical spring elsewhere, creating a virtual spring between points a and b.

The spring itself can be obtained using any kind of elastic system, such as a tension spring, compression spring, torsion spring, gas cylinder, and a constant force spring made from many different elastic materials including metals, rubbers and polymers. The force displacement profile of a particular spring can be adjusted by the use of cams, shaped pulleys, or any other suitable mechanism to linearize a non-linear spring or shift its zero crossing.

In order for the force vector associated with the system to be completely joint angle independent, the force-displacement profile needs to be F=kc. When the force-displacement profile is close to this relationship, the spring is said to be a “zero-length spring”.

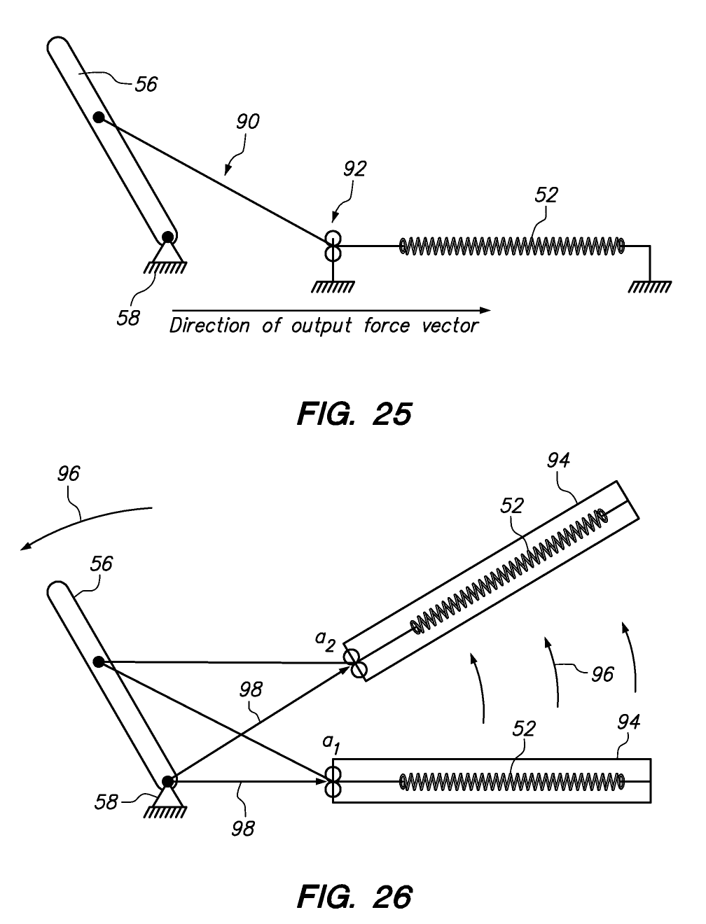

FIG. 25 illustrates a schematic of one implementation of a virtual zero-length spring (90) for an angle-independent force vector. If the lengths of the tension members on either side of the spring are set properly, the virtual spring can be adjusted to be zero length. The virtual zero-length spring (90) is directed through a pulley arrangement (92).

FIG. 26 illustrates one embodiment of an angle-independent implementation for a 1 degree-of-freedom system in which the magnitude or orientation of the output force is adjusted by moving point a (points “a1” and “a2” are depicted to denote two positions of “a”) linearly or by rotating (96) the box (94) containing the spring (52) around the fulcrum (58). The force vector will be in the direction of the arrow (98) and proportional to its length.

When implementing real systems, it can be practical to simplify the design by creating a virtual spring that has a non-zero or even angle-dependant w term. In these cases, the spring-based force vectoring system produces a force vector that will not be completely angle-independent. The force output error caused by the angle-dependant terms can be ignored or compensated in numerous ways, for example, if the error is less than the friction in the system; if a, b or K or other adjustments can be servoed by actuators; if joint motors can be actuated appropriately; if the direction of the output vector can be reoriented to compensate; if the angle dependency is actually desirable in minimizing or maximizing potential energy at some chosen angle.

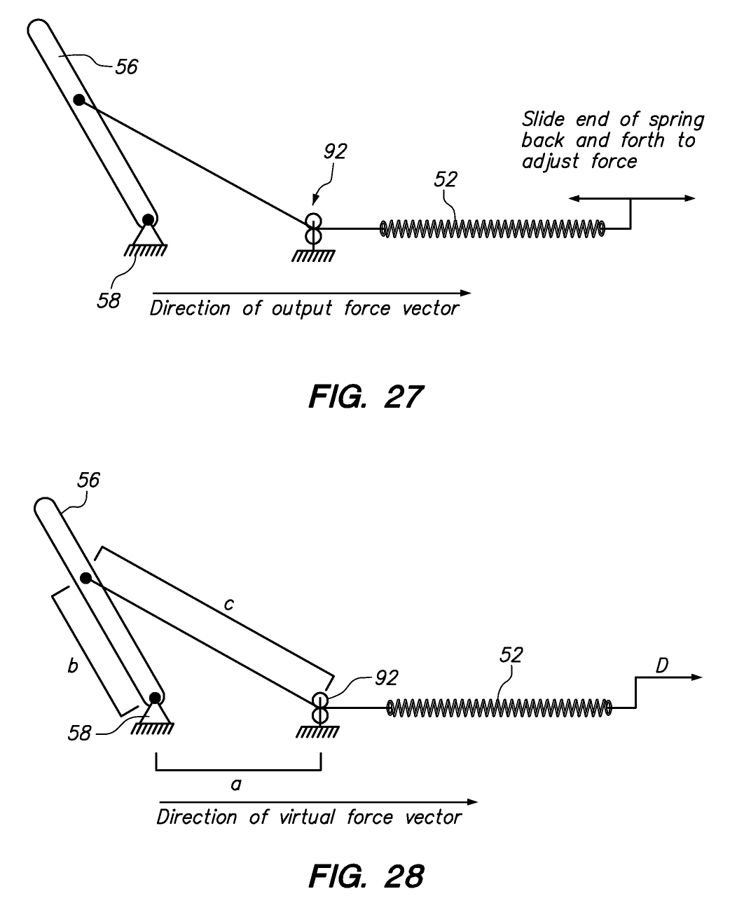

One alternative implementation involves adjusting the position of only the normally fixed, back end of the spring to vary the magnitude of the force vector. In the embodiment illustrated in FIG. 27, the distance between the pulley arrangement (92) and the pivot (58) is fixed. This has a similar effect to adjusting a but the force vector will now be a function of the joint angle for most positions of the back side of the spring. There could be, depending on the location of the pulley arrangement, a position of the back side of the spring that does result in an angle-independent force vector, but for all other positions of the back side of the spring, angle-dependant terms will be present.

FIG. 28 is helpful in illustrating a potential stability issue. Referring to FIG. 28, The distance “D” is the amount that the back of the spring (52) is taken up relative to the point where the virtual spring portion c of the tension member is a zero-length spring. The value D is defined as being positive when additional cable is taken up (in the diagram below when the right side of the spring is moved to the right). If D is kept negative or zero the result is a stable system; if D is positive, the system will no longer be stable.

The magnitude of the force of a zero-length spring is:

Fₒ=ck

As cable is taken up the output force becomes:

F_{D}=(c+D)k or

$${F}_{D} = {F}_{o} ( 1 + \frac{D}{c} )$$

Since the virtual force G applied to the link is proportional to the spring force:

$$G = {G}_{o} ( 1 + \frac{D}{c} )$$

dG/dc is rate of the virtual force increase as the spring stretches. This value must be positive for stable behavior. In the above illustration, this would mean that when the arm is deflected to the left the magnitude of the virtual force will increase, and when the arm is deflected to the right the magnitude of the virtual force will decrease.

$$\frac{d G}{d c} = \frac{- {G}_{o} D}{{c}^{2}} = D \frac{- {G}_{o}}{{c}^{2}}$$

Since Gₒ≧D and c≧0, we have stable behavior (i.e., dG/dc is positive) when D≦0 and unstable behavior when D>0.

For an angle independent force vectoring implementation, the magnitude of the force vector can be adjusted by varying the distance between a and the fulcrum (58). To practically implement a non angle-dependant force vector requires moving the pulley arrangement and the back end of the spring together. In the simplification presented here the pulley arrangement is held fixed and only the back end of the spring is moved. The error of the force vector simplification is non-zero when D is non-zero, since the angle-dependant terms no longer completely cancel each other from the equations presented in FIG. 15B. The magnitude of the error is proportional to 1/a, i.e., maximizing a minimizes the error.

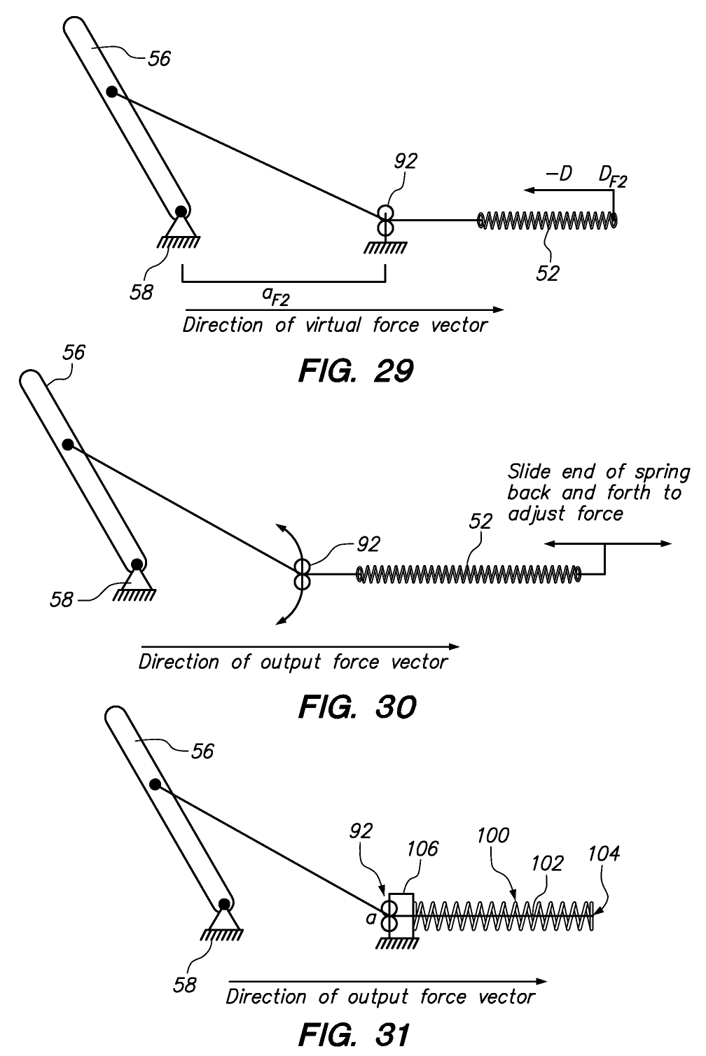

An illustrative example depicted in FIG. 29 is now considered in which the force is to be adjusted between F1 and F2, with F2>F1>. To achieve stability, the system could be implemented such that the pulley arrangement (92) is placed in a zero-length spring configuration at F2. Then, the back end of the spring (52) is relaxed (D needs to be negative for stability) to reduce the force to F1. This is also ideal from the point of view of error minimization, since a is maximized when the pulley arrangement is placed for the larger force, F2.

Placing the pulley arrangement (92) at aF2 will make the system behave as an angle independent force vector when outputting F2 from the system. If the pulley arrangement (92) is set at a point further than aF2 from the fulcrum (58), then the angle dependant error when outputting F1 will be further reduced, but an angle-dependant error will be introduced when outputting F2. Based on an analysis of the task to be performed with the link (56), the overall system may be more efficient if the pulley arrangement (92) is simply moved out as far as practical.

The above implementation may be modified to reorient the direction of the force vector as illustrated in FIG. 30. The position of the pulley arrangement (92) may be rotated around the fulcrum (58) to adjust the direction of the force output. The back end of the spring (52) may be adjusted in and out to compensate for the change in distance between the pulley arrangement (92) and the back end of the spring (52).

In space-constrained implementations such as mobile robots, one concern is the swept area or volume of the spring assembly. In some cases, compression springs may be appropriate if the tension element acts to compress the spring instead of elongate it as with an extension spring. A compression spring (100) embodiment is depicted in FIG. 31, wherein the spring (100) is contained at a mounting block (106) interfaced with a pulley arrangement (92), and is compressed with a tension element mounted at the end (104) of the spring and interfaced through the pulley arrangement (92) to the link (56).

In certain spring-based systems, safety and failure management must be addressed. The spring is essentially being used as a potential energy storage medium. It is a fairly ideal medium since it is highly efficient in converting kinetic to potential energy and back, unlike a battery, which incurs much higher energy losses in the conversion process. In case of a failure, however, a spring's potentially rapid discharge of energy must be carefully managed.

With extension springs, if the spring itself fails mechanically, it preferably should be housed in such a way that the kinetic energy is absorbed and the separated parts are physically contained. If an associated tension member fails, an extension spring will collapse rapidly, but this event is self-limiting and relatively easy to contain.

With compression springs, if the spring itself fails, it collapses on itself, which is a self-limiting scenario. When the tension member fails in a compression spring scenario, the spring will expand rapidly to its relaxed length after likely overshooting, a scenario that may require containment provisions.

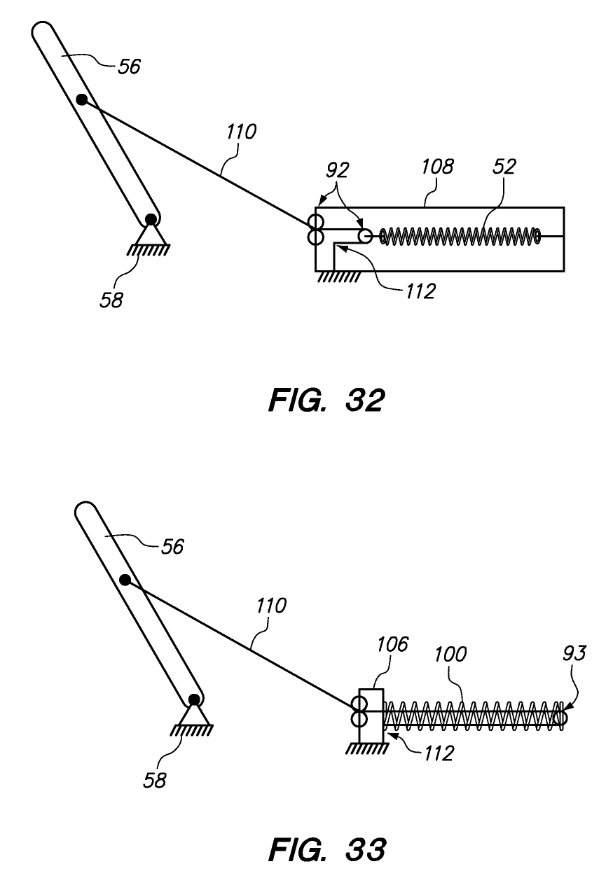

To minimize the swept volume of the spring, a pulley-based block and tackle reduction stage can be implemented, so that the change in length of the tension member as it travels through the pulley arrangement is a multiple of the spring travel. FIGS. 32 and 33 illustrate a single stage block and tackle implementation for both a compression (FIG. 33) and an extension (FIG. 32) spring. In the extension embodiment depicted in FIG. 32, a mounting structure or enclosure (108) contains the extension spring (52) and mounts it in place. A tension member (110) is coupled through the pulley arrangement (92) and terminated (112) on a portion of the mounting structure (108). In a block and tackle reduction the spring constant of the actual spring must be the desired spring constant times the square of the reduction ratio. Larger reductions may be appropriate as needed. Compression springs (100) in combination with pulley reductions (93) can be easily packaged such that the pulley reduction can fit inside the compression spring.

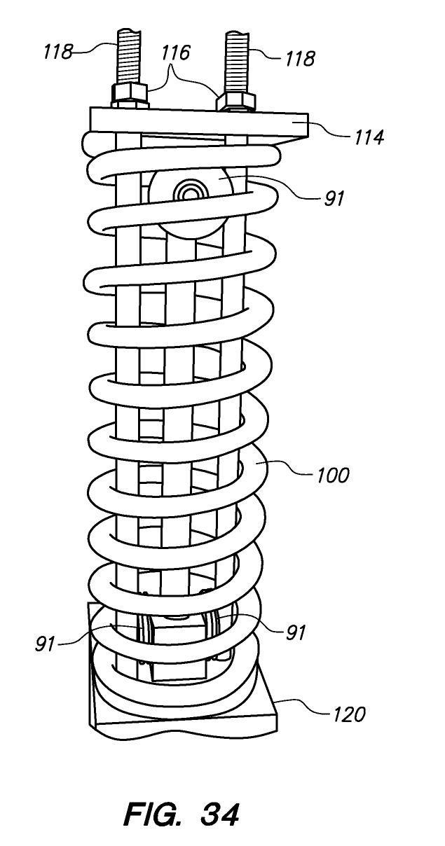

FIG. 34 depicts an implementation of one embodiment of a compression spring (100) arrangement featuring a moving end block (114) and a fixed end block (120) to compress the compression spring (100) in accordance with tensile member (not shown) activity through an arrangement of pulleys (91) configured to provide a 4× cable reduction. Maximal extension of the spring (100) is limited with a pair of threaded rods (118) and locking nuts (116). From a safety perspective, the two end blocks (114, 120), the threaded rods (118) and the lock nuts (116) are designed to absorb the maximum amount of energy stored in the spring (100) should the tension member break at full compression. The threaded rods (118) are sheathed where the moving end block (114) travels over them for smooth operation. The pulley and cable arrangement occupies the space inside the compression spring (100) and provides a four-times reduction. When the spring (100) reaches full compression, the pulley system is designed to be near its minimum range of travel.

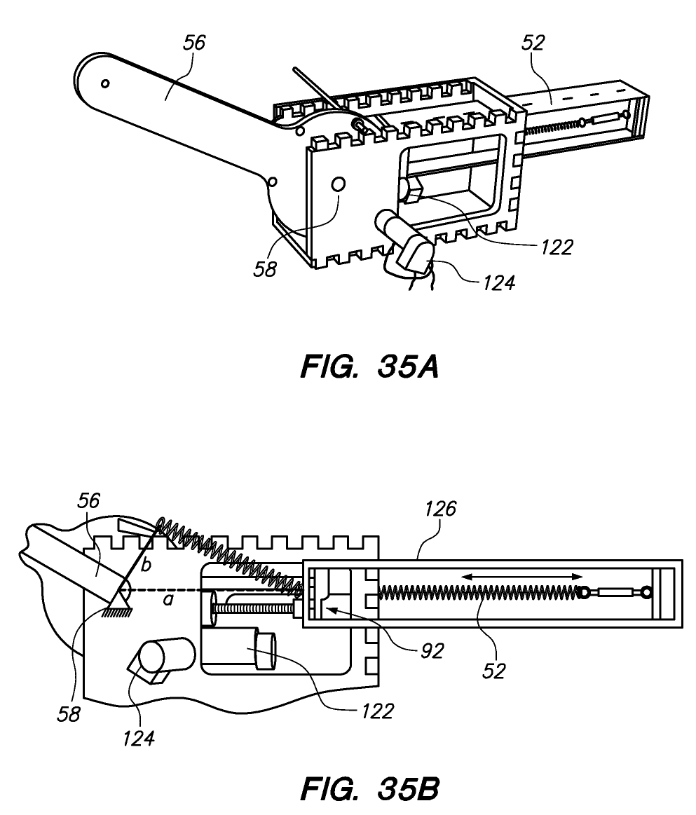

FIGS. 35A and 35B illustrate a one degree-of-freedom implementation with the following features: a non angle-dependant force vector; a small actuator (124) driving the joint directly; a vertical force vector to act as a gravity counterbalance; points at lengths a and b from the fulcrum (58) rotated 90° around the joint axis, resulting in no net effect on the counterbalance force; an adjustable length a, adjusted by an actuator (122) which moves a box structure (126) to adjust length a, so that the amount of mass counterbalanced M and the position of the mass on link L can be adjusted; and a zero-length spring that is approximated by using a spring (52) extension and a pulley (92) arrangement.

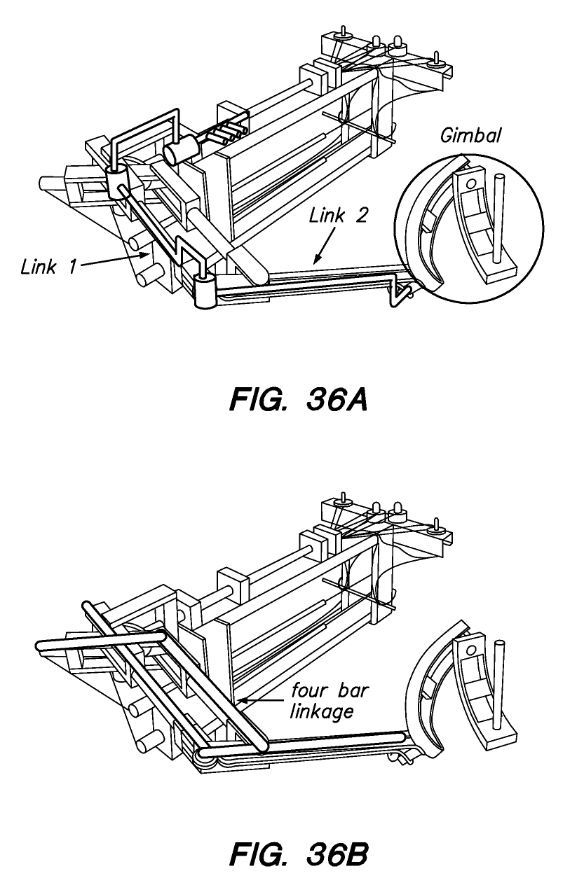

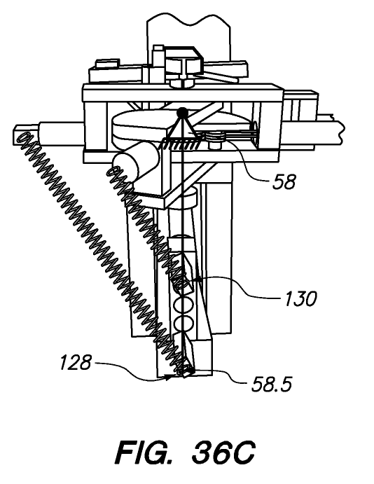

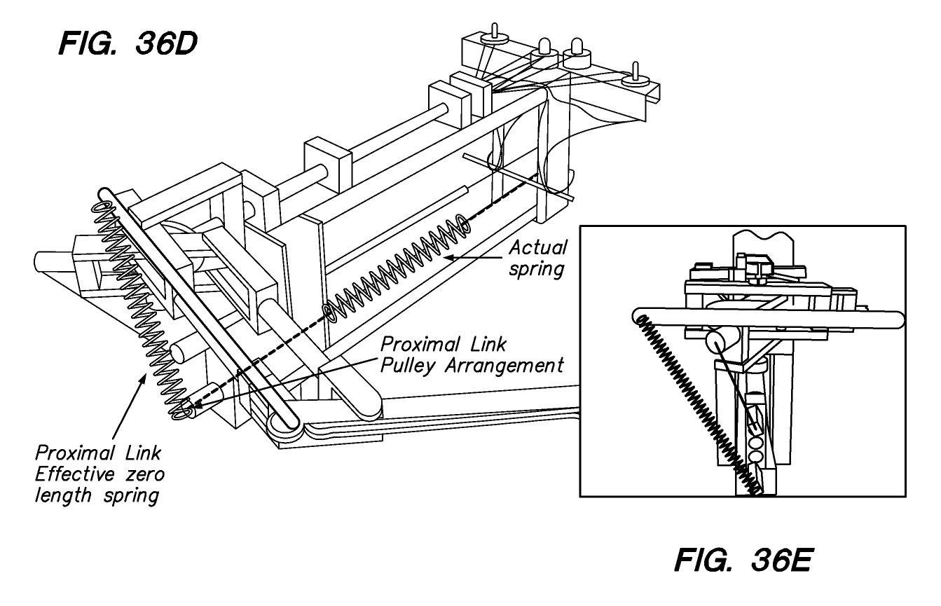

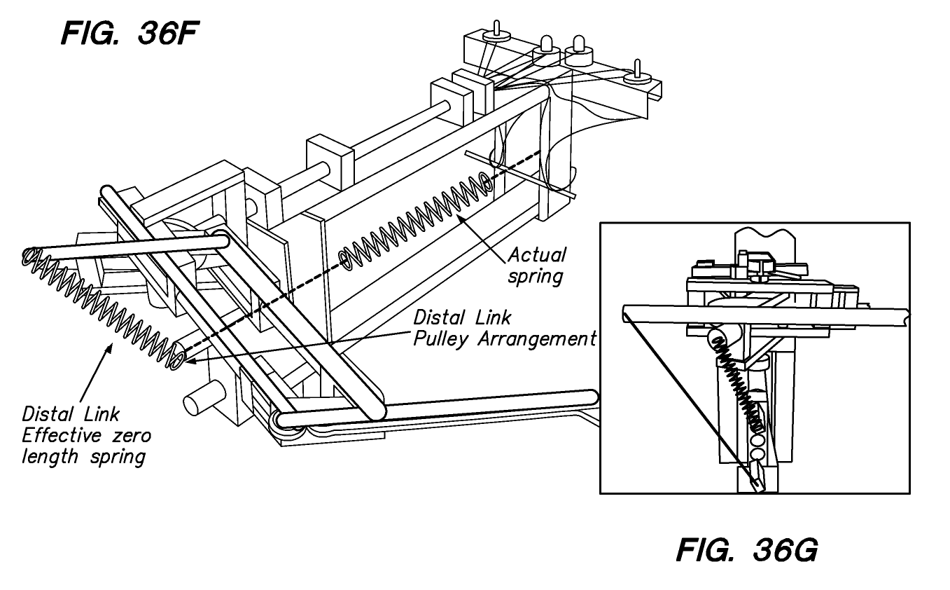

FIGS. 36A-36G depict aspects of an implementation embodiment comprising a haptic master input device interface, with the following specific features: a non angle-dependant force vector; two serial links with a total of three degrees of freedom; a four-bar linkage used as the mechanism that keeps the distal link parallel to the distal link parallel bar; a vertical spring-based force vector to act as a gravity counterbalance; a non-adjustable counterbalance force magnitude, since to the system exactly compensates for the constant weight of the manipulator arm and the gimbal with the handgrip; a gimbal incorporating additional degrees of freedom that do not need to be counterbalanced.

The pulley arrangements for each link are located inline (58.5) with the pivot (58). This can be done when the virtual springs (in this case the cables) do not have self-intersection configurations. This reduces the mechanical complexity as compared to alternate implementations that require one or more of the degrees of freedom to be abstracted away from the joint. Element 128 of FIG. 36C is a pulley arrangement for “link 1” as depicted in FIG. 36A; Element 130 of FIG. 36C is a pulley arrangement for “link 2” as depicted in FIG. 36A. FIGS. 36D and 36E illustrate the spring arrangement implemented to counterbalance the proximal link. FIGS. 36F and 36G illustrate the spring arrangement implemented to counterbalance the distal link.

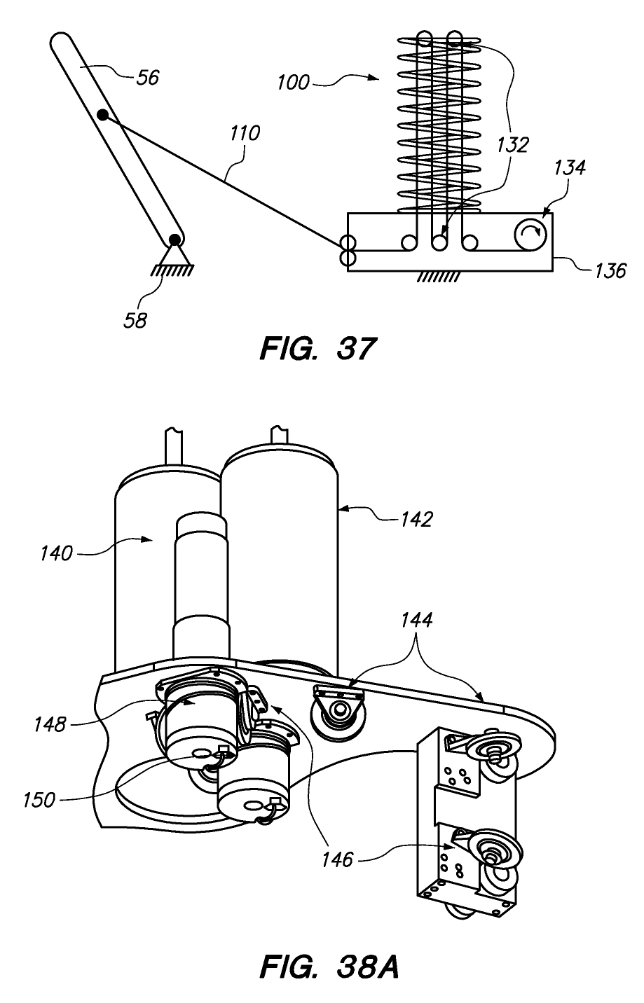

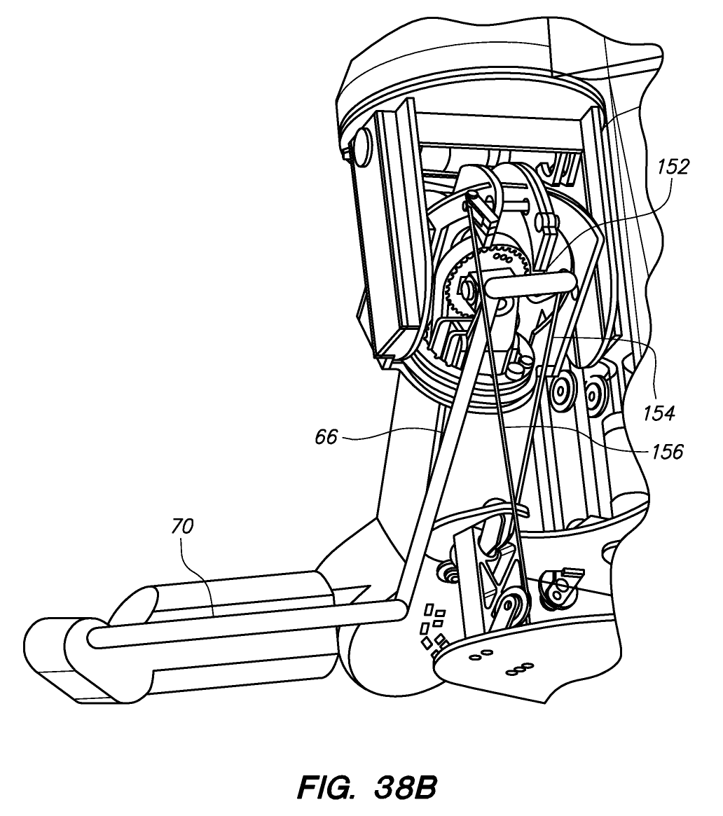

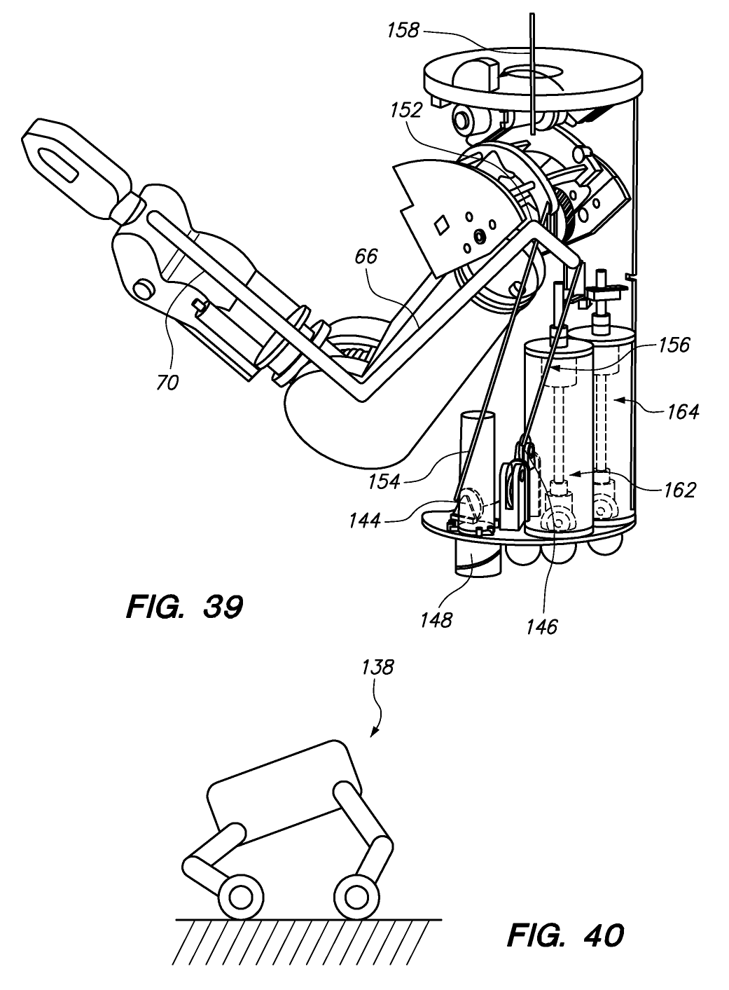

Further angle-dependent force vector system embodiments are illustrated in FIGS. 38A-39, and a representative simplified schematic is depicted in FIG. 37, wherein a pulley reduction (132), mounting base (136), and a tension member (110) coupled between the link (56), through the pulley reduction (132), and to a motorized takeup drum (134) are utilized together. The configuration uses an angle-dependent force vector configuration. The pulley arrangement (132) is set at a suitable distance from the pivot (58) to ensure stability and minimize error over the achievable output forces. The four-times cable reduction is implemented with pulleys and a cable extension in the compression spring (100). The take-up drum (134) is implemented on the back end of the spring to adjust the output force magnitude. Take up drum (134) design and actuation are described in further detail below.

Referring to FIGS. 38A and 38B, aspects of an implementation for a four degree of freedom (“dof”) robot arm with two serial links are depicted. This scheme can be extended to multiple dimensions and serial linkages. The first joint is a pan-tilt-roll shoulder assembly from the robot torso to the proximal link of the arm. The panning motion does not require gravity compensation since the axis of the joint is designed to be aligned with gravity at all times, while the tilt and roll joints have force vectoring gravity compensation mechanisms with the vector directions aligned with gravity.

At the end of the proximal link is a single-axis joint, similar to an elbow, that connects to the distal link. This distal link has a distal link extension mechanism to be able to place its force vectoring spring mechanism proximal to the proximal link. In this implementation, the ‘point a’ pulley arrangements for both links, as well as the springs for the force vectoring, are fixed in the body of the robot. The spring extensions are cables routed through a compression spring, not an extension spring. The back end of the compression spring is taken up by an actuator to adjust the output force from each link, allowing the spring-based force vector out of the system to be adjusted for payload and angle-dependant terms if necessary. In this case both spring extensions sweep out a portion of a cone relative to the body due to the panning rotation of the proximal link around its vertical axis. Referring to FIG. 38A, element 140 is a distal link compression spring; element 142 is a proximal link compression spring; element 144 is a distal link pulley arrangement; element 146 is a proximal link pulley arrangement; element 148 is a distal link take up drum; element 150 is a proximal link cable or tension element. Referring to FIG. 38B, element 66 is a proximal link; element 70 is a distal link; element 152 is a link kept parallel with the distal link; element 154 is a distal link spring extension element, such as a cable; element 156 is a proximal link spring extension element, such as a cable.

Referring to FIG. 39, an implementation embodiment similar to that depicted in FIGS. 38A and 38B is depicted, with several geometric modifications to the force vectoring principle to simplify the design. In the implementation of FIGS. 38A and 38B, the counterbalance system was attached to the body of the robot. In this implementation, the springs and “point a” locations rotate with the pan motion of the arm. Since the proximal link force vector actuator is only counterbalancing one degree of freedom, two geometric modifications are possible: (1) the plane containing the proximal link spring extension, which is normal to the tilt axis of the shoulder, is translated along the tilt axis to put it in a more convenient location for this particular design; (2) similar to the implementation embodiment illustrated in FIGS. 35A-B, the points a and b are rotated around the tilt axis by the same angle for more convenient placement. As a result, in this implementation, the distal link spring extension sweeps out part of a cone while the proximal link spring extension sweeps out part of a plane. In the cutaway assembly depicted in FIG. 39, element 158 denotes the shoulder pan axis, which is not affected by the spring actuator system; element 152 refers to the link kept parallel to the distal link (70); element 66 refers to the proximal link; element 156 refers to the proximal link spring extension, such as a cable; element 164 refers to a proximal link compression spring and cable reduction assembly; element 162 refers to a distal link compression spring and cable reduction assembly; element 146 refers to a proximal link pulley arrangement; element 148 refers to a distal link cable take up drum assembly; element 144 refers to a distal link pulley arrangement; and element 154 refers to a distal link spring extension, such as a cable.

From a safety perspective, intrinsically, a low-mass mechanism that generates a force vector to do work, as commonly found in robots, achieves the dual goals of maximizing the usability of the mechanism while minimizing safety issues. A mechanism with a large mass that can be accelerated by actuators is intrinsically unsafe near humans. Actuators capable of generating large torques or forces, even at low mass, also constitute unsafe mechanisms. Force vectoring is an inherently passive, and potentially adjustable, system that generates a force in a precise direction and magnitude chosen by the designers beforehand to be most useful and safe in a given application. In general this type of mechanism results in stable control of the direction and magnitude of the output force vector. In gravity compensation systems, for example, this vector always opposes the effect of gravity on the mass of the robot. It can never accidentally exert large forces perpendicular to gravity.

Other software-centric actuation methods have been developed that attempt to achieve the same principle of developing a true force vector from serial mechanical linkages. These include micro-macro actuators and series elastic actuators, among others. These systems rely on a software control loop with an actuator and a sensor. In all of these systems, control software maintains the force vector. In most of the implementations, the control systems require fast operation to achieve a constant force vector. The inherently tight control loop design can result in large actuator forces developed as a result of small sensor readings. From a safety point of view, failure of any single component (sensor, wiring, power supply, actuator, etc.) may result in an unstable system exerting large, potentially harmful forces. In contrast, the system described in this document is passive and adjustable, resulting in a force vector intrinsic to the mechanics. A sensor miss-calibration or loose wire, for example, would not result in an unstable system.

For a mechanical device such as a robot designed to work in the vicinity of humans, a vertically-oriented force vectoring system can be desirable, if not fundamental, for safety. Generally, the only unsafe place for a human to be is above the device in case of malfunction; however, in normal situations, the human would safely be next to the device. If joint actuators are used in this system, they preferably would be small so as to limit the total amount of force that could be applied perpendicular to the gravity vector.

If an environmental force (a force caused by an object outside the linkage) were to change, the force output of the system would also need to be servoed to counteract it. If the rate at which the force output of the system can be changed is not fast enough to react to changing environmental forces, then additional actuators at the joints may be appropriate. In addition, if the spring based force vectoring system were to fail, it may be necessary too actuate the joints directly to prevent damage to the linkage or the environment. These additional actuators may include adjustable torque actuators such as motors and locking actuators such as joint brakes.

Automatic joint brakes that engage based on one or more independent parameters may be useful. Implementations may include a mechanical centrifugal break that locks down a particular joint if the angular velocity of that joint gets to high. This may also include a sensor based brake system that monitors acceleration, temperature, forces or other parameters and locks the system down based on a particular unacceptable environmental condition.

Regarding electric motors, in general there is a large ratio between the continuous force output of a motor and a peak force output of a motor. In general, thermal properties limit the time duration that a motor can be driven above its continuous rating. In a force vectoring system that includes adjustability of the force magnitude or direction with an actuator, there will be a time constant associated with that adjustment. Environmental forces may change quickly, especially in unstructured environments. It may be desirable for the design of the system that adjusts the spring based actuation system and the joint actuators to be matched so that during the time it takes the spring based actuation system to adjust to react to a changing condition the joint motors can be over-driven to temporarily prevent the linkage from behaving inappropriately.

An example of this behavior would be in a spring based actuator setup designed for gravity compensation. In this example if a payload was being manipulated and was dropped, the force vectoring adjustment actuator would need to be used to compensate for the new payload. However, if the time constant of this operation is too long to prevent unwanted arm motion, the joint motor itself, designed to have a faster time constant, may be driven over its continuous force rating temporarily to provide the needed force until the gravity compensation vector magnitude adjustment was completed. In this case the safety for people around the robot may be maintained.

Spring based force vectoring actuation systems may be used in linkages intended for mobility such as bipedal or quadruped locomotion. The system offers intrinsic compliance, the lack of which is often an impediment to true bipedal locomotion.

A spring-based force vectoring actuation system also may be appropriate for shuffling walkers or for wheeled systems as a suspension tool. An example of a legged-wheeled system (138) is depicted in FIG. 40.

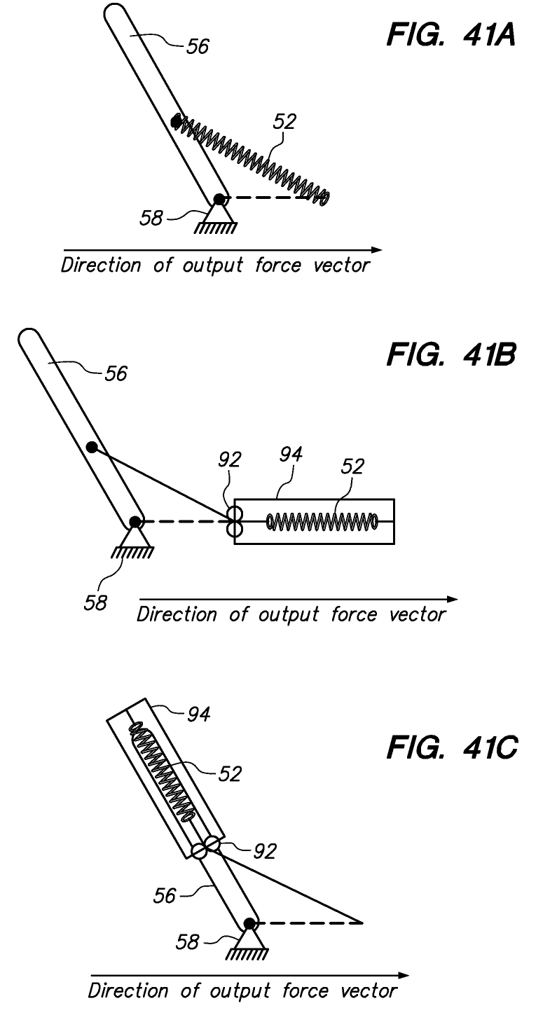

In certain embodiments, it may be advantageous to package the springs of such a force vectoring system in the links themselves. FIG. 41A shows the original single link system, as described above. The next two implementations depicted in FIGS. 41B and 41C both exert the same torque on the link (56) as in the original implementation, although different a, b and K values would need to be selected because of the effect of the mass of the spring (52) in the link. Element 92 refers to a pulley arrangement and element 94 refers to a spring container structure. These examples illustrate the concept of virtual spring placement and show two equivalent locations to place the actual spring.

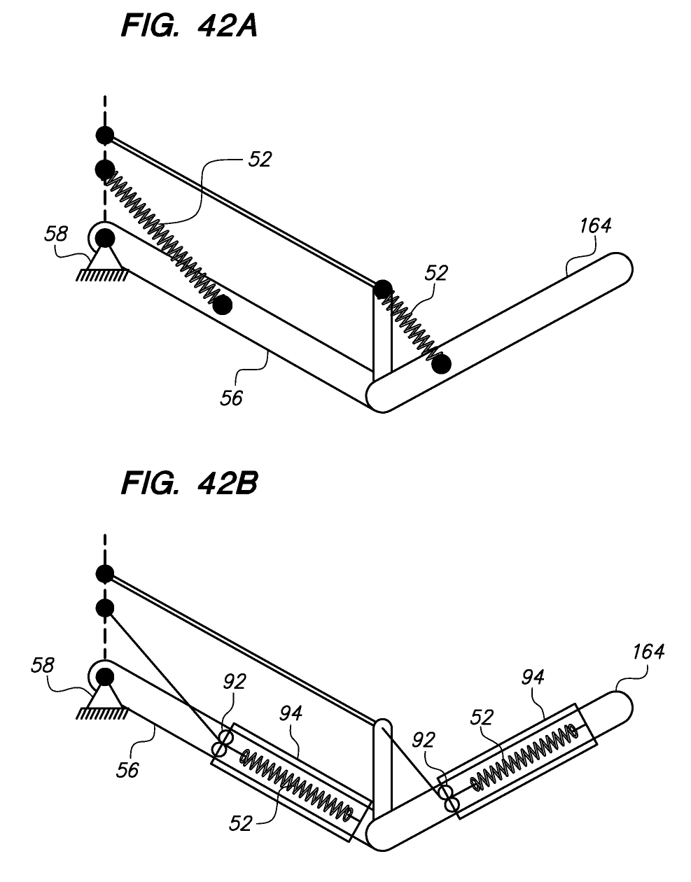

The concepts described herein may also be extended to serial mechanisms with springs in the links. FIGS. 42A and 42B depict two simple two-link examples comprising a first link (56) and a second link (164), illustrating an implementation with virtual springs and placement of the actual springs.

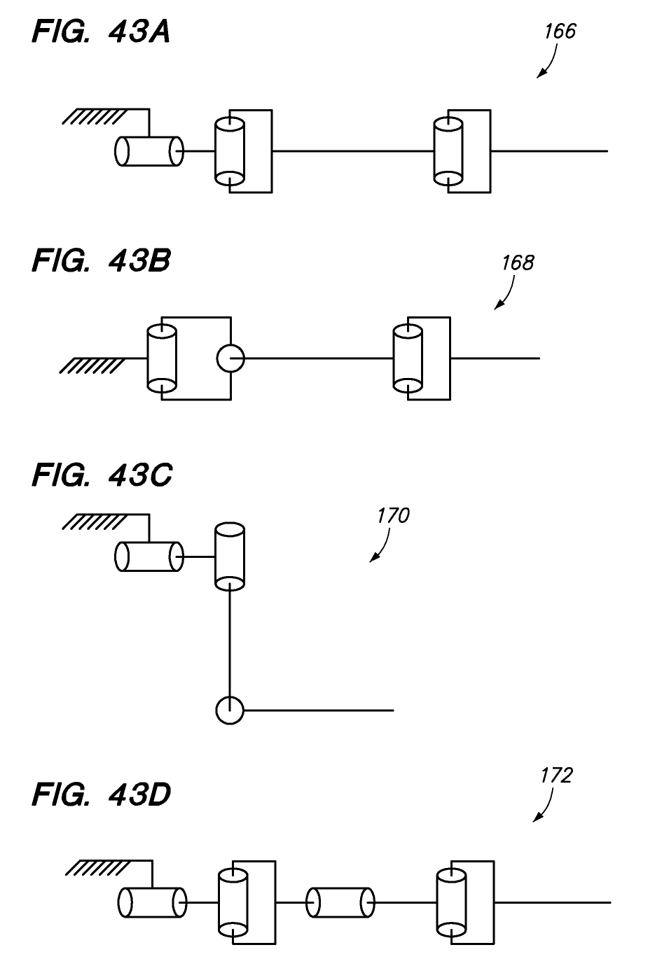

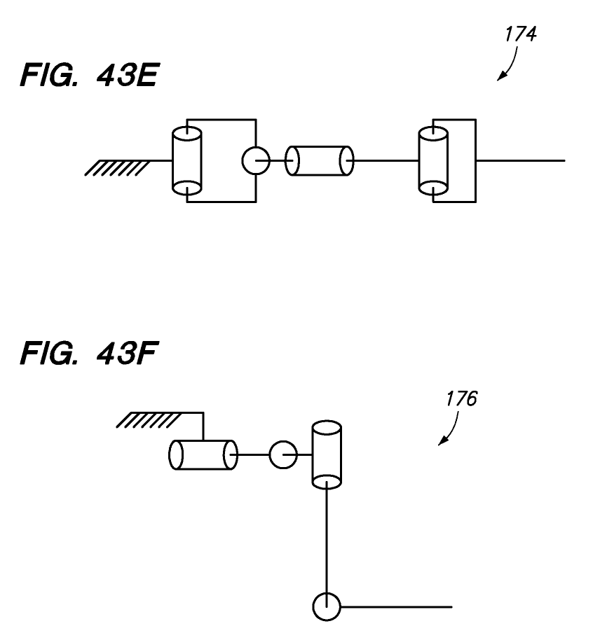

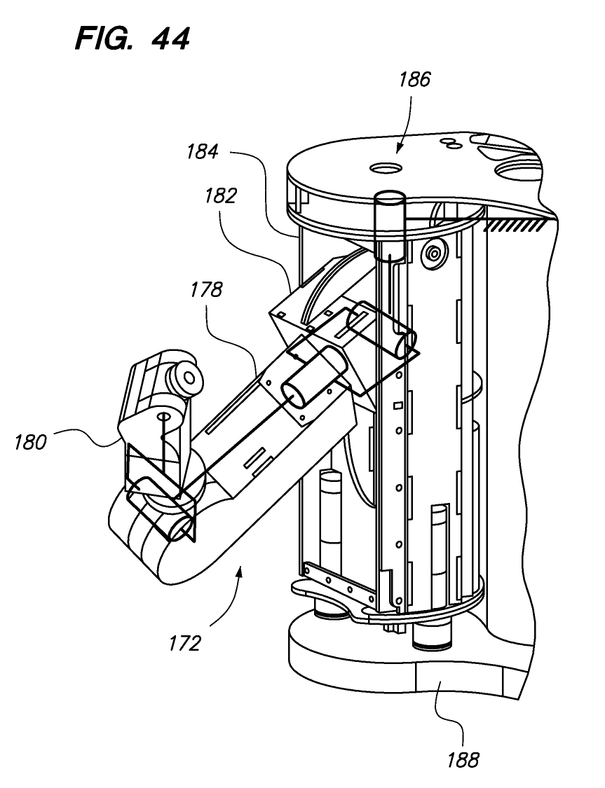

For a two link arm, many kinematic arrangement are possible. General kinematic goals include workspaces of two or more arms sufficient overlap for coordinated manipulation; adequate degrees of freedom available to move in free space; optional additional degrees of freedom for pose control; joint ranges of motion to optimize shared workspaces; and continuous degrees of freedom when possible and/or practical. Referring to FIGS. 43A-43F, various two-link arm kinematic arrangements are diagrammatically illustrated. FIGS. 43A, 43B, and 43C depict 3 degree of freedom embodiments (166, 168, 170); FIGS. 43D, 43E, and 43F depict 4 degree of freedom embodiments (172, 174, 176). FIG. 44 depicts a robot arm implementation embodiment having a kinematic arrangement similar to that depicted in FIG. 43D (172), the implementation comprising a forearm assembly (180) configured to pitch and roll relative to the upper arm assembly (178) to which it is coupled; the upper arm assembly (178) is configured to roll relative to a shoulder flexion assembly (182) to which it is coupled; the shoulder flexion assembly (182) is configured to rotate, or “flex”, relative to a shoulder turret assembly (184) to which it is coupled; the shoulder turret assembly (184) is configured to rotate about a pan axis (186) relative to the main robot body (188), to which it is rotatably coupled.

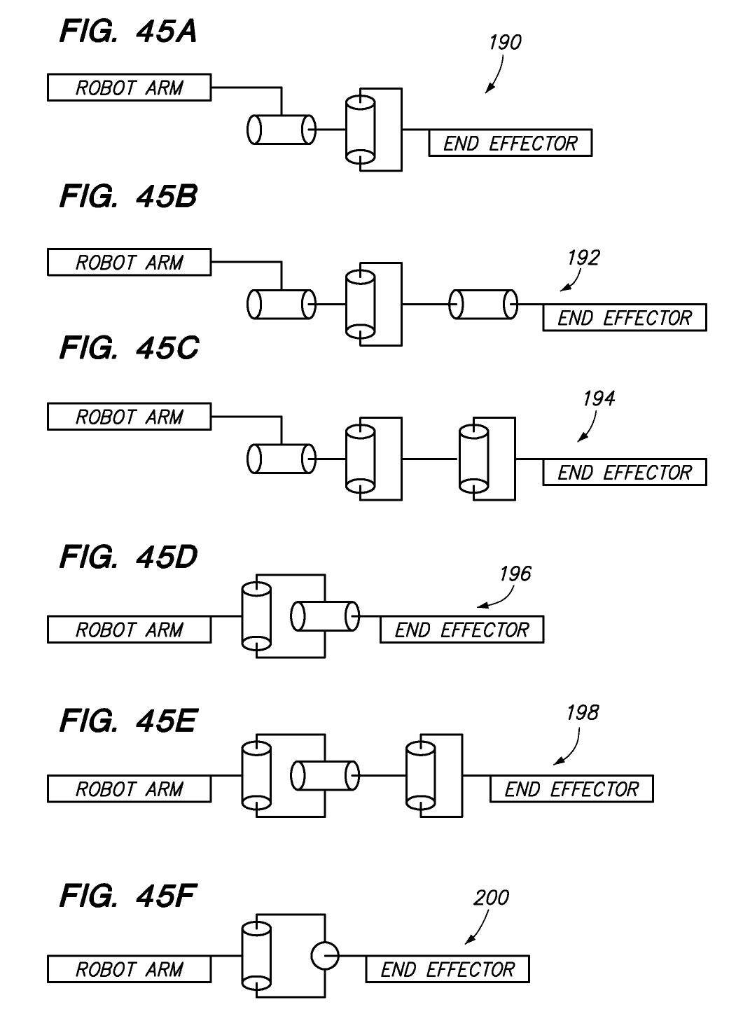

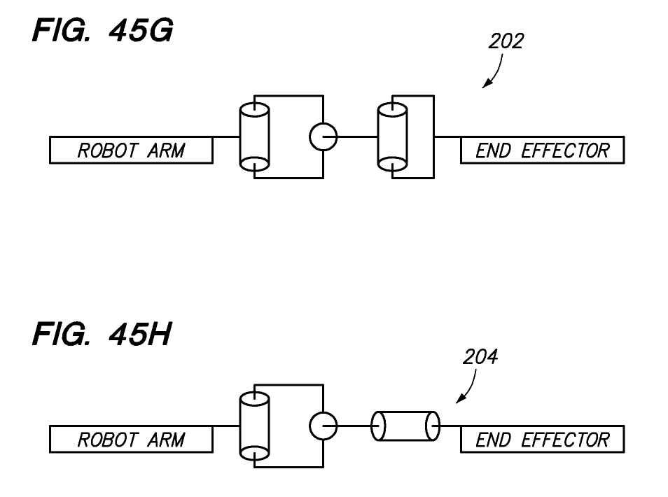

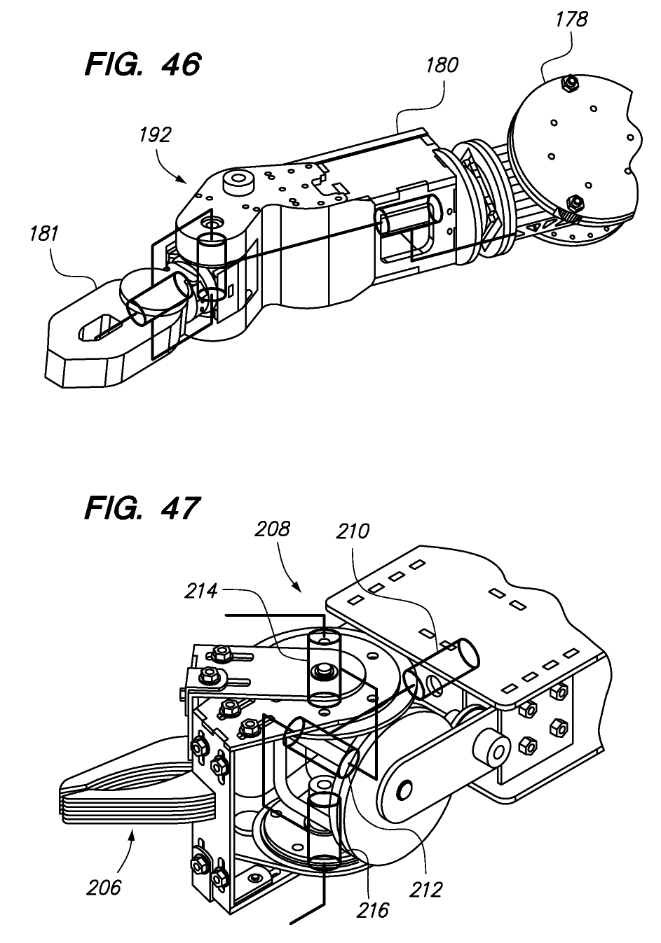

Moving more distally to wrist embodiments, there are many possible configurations of the wrist kinematics for a manipulator. FIGS. 45A, 45D, and 45F depict two degree of freedom embodiments (190, 196, 200); FIGS. 45B, 45C, 45E, 45G, and 45H depict three degree of freedom embodiments (192, 194, 198, 202, 204). The wrist configuration is intended to provide increased manipulation capability to the arm. Most applications require more than three degrees of freedom for manipulation. In those applications, the wrist kinematics described herein may be combined with arm kinematic arrangements to satisfy the needs of the application. In many of these implementations, it is advantageous to make one or more of these degrees of freedom continuous. In all of these configurations one or more sets of joint axes can be designed to intersect or be offset. Single degree of freedom wrists may also be used as well as modifications on these themes, as in the implementation illustrated in FIG. 47. FIG. 46 depicts an implementation having a 3 degree of freedom kinematic model similar to that depicted in FIG. 45B (192)−roll-pitch-roll. The output degree is implemented to be continuously rotatable. All joint axes are configured to intersect. FIG. 47 depicts a 4 degree of freedom wrist assembly (208). This roll (210)−pitch (212)−pitch (214)−pitch (216) wrist configuration has the last two degrees of freedom (214, 216) in parallel, and their difference may be used as a gripper (206). All joint axes are configured to intersect.

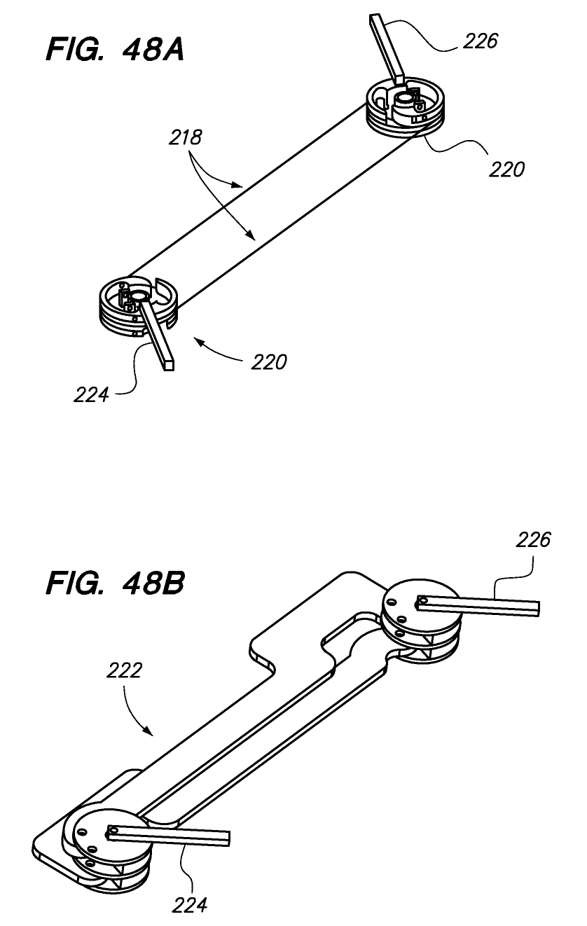

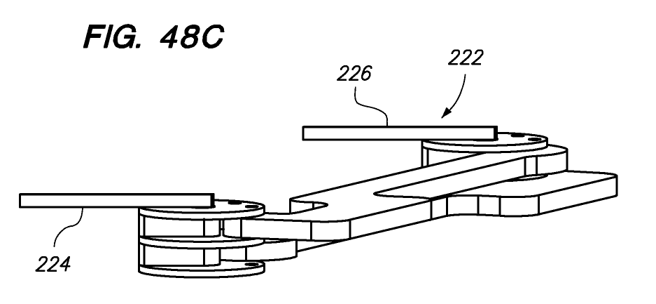

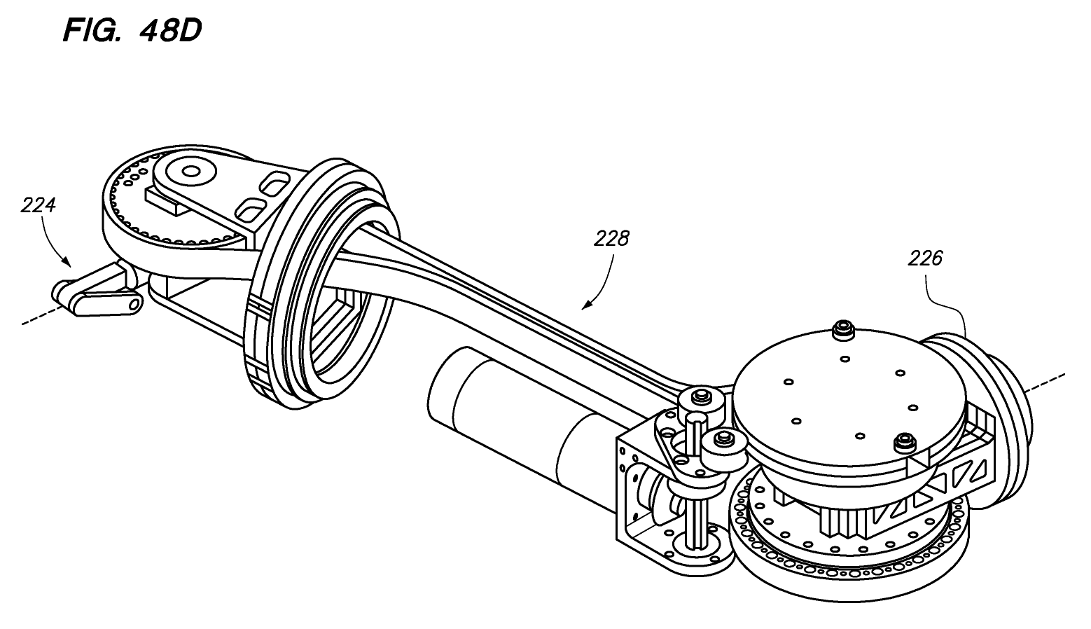

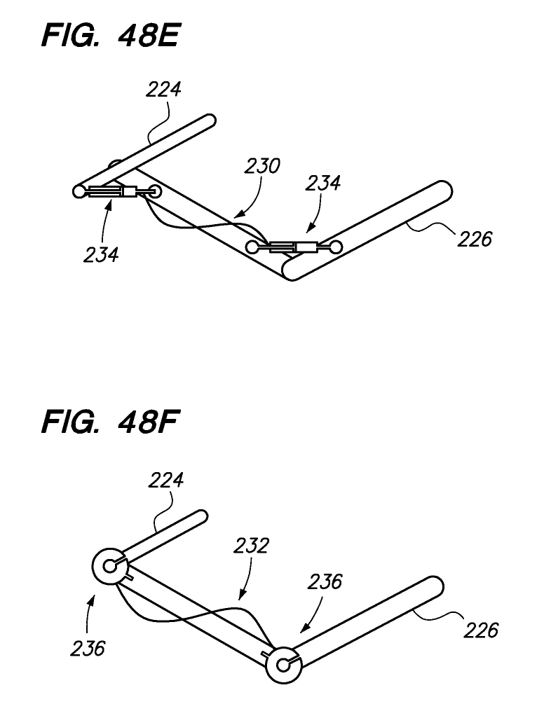

As discussed above in reference to spring actuation embodiments, there are alternate ways to keep the balance link parallel to the link being counterbalanced. Several examples of mechanisms for keeping a distal link parallel to a proximal link through one degree of freedom are depicted in FIGS. 48A-48F. Referring to FIG. 48A, one or more tension members (218), such as cabling, intercoupled between two tension member interfaces (220), such as pulleys, may be utilized to keep two members (224, 226) in parallel geometric configurations. FIGS. 48B and 48C depict two views of a linkage assembly (222) configured to maintain parallelism between the two members (224, 226). This class of solutions includes many variations. The depicted embodiment (222) uses two linkages in parallel but out of phase for increased range of motion and reduced stress in the links. One or more links may be used depending on range of motion, acceptable stress, and packing constraints. A belted embodiment is depicted in FIG. 48D to keep two components (224, 226) in parallel. This class of solutions also includes many variations. The depicted embodiment uses a toothed belt (228). Options include various belt materials with various toothed and non-toothed configurations. In this example, the belt is routed around idlers (not pictured) to deal with packaging constraints. The use of fluid or gas cylinders (linear or rotary) or fluid or gas motors may also be appropriate ways to enforce the constraint that the two links remain parallel. FIG. 48E depicts an embodiment wherein two links (224, 226) are kept in parallel utilizing a set of fluid cylinders (234) connected by a connecting line (230). FIG. 48F depicts an embodiment wherein two links (224, 226) are kept in parallel utilizing a set of motors or rotary cylinders (236) connected by an electronic connecting line (232).

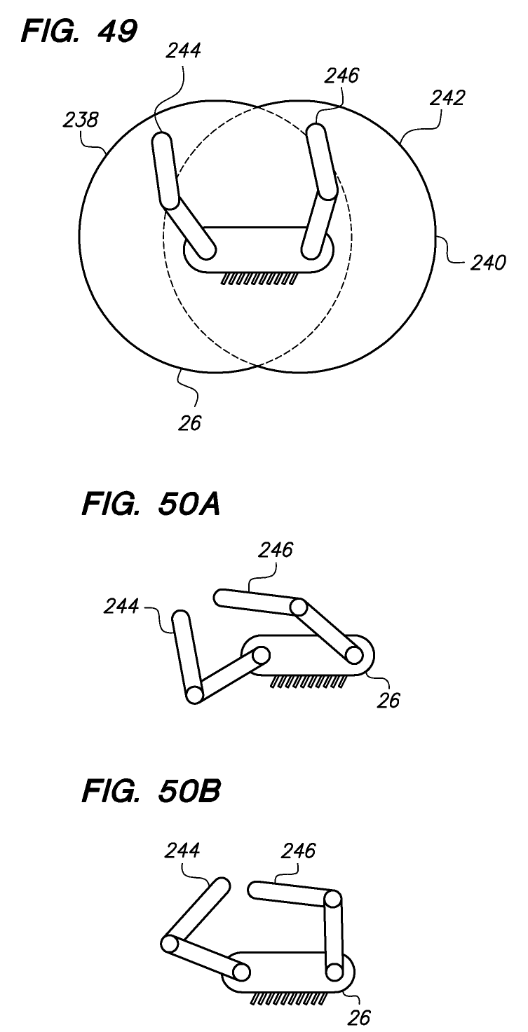

In a robot implementation wherein two linkages or manipulators are to be used for collaborative manipulation, the workspaces of the manipulators desirably are optimized for working with each other and their environment. FIG. 49 depicts a robot body (26), or shoulders, from a functional perspective, coupled to two manipulator arms (244, 246), each of which has it's own workspace (238, 240), and the community of which have a shared workspace (242) wherein they can work together to manipulate the same object in the same space. In the discussion that follows, workspace optimization is described in human anatomy style terms for illustrative purposes. In order to maximize the shared workspace, the upper arms must be able to cross the chest. Many two-armed, human-like upper torso robots have a limited shared workspace because the upper body limits the range of motion of the upper arms across the chest. By designing an upper body structure that does not limit the arm when crossing the chest midline, the range of motion can be optimized for two-armed manipulation. FIG. 50A depicts a two armed (244, 246) configuration having a fairly ideal range of motion. FIG. 50B depicts a two armed (244, 246) configuration having a fairly typical range of motion.

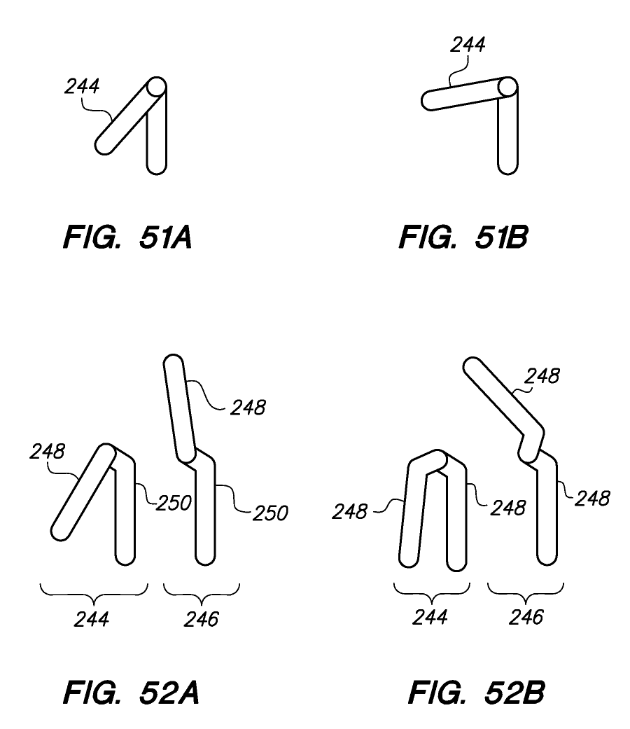

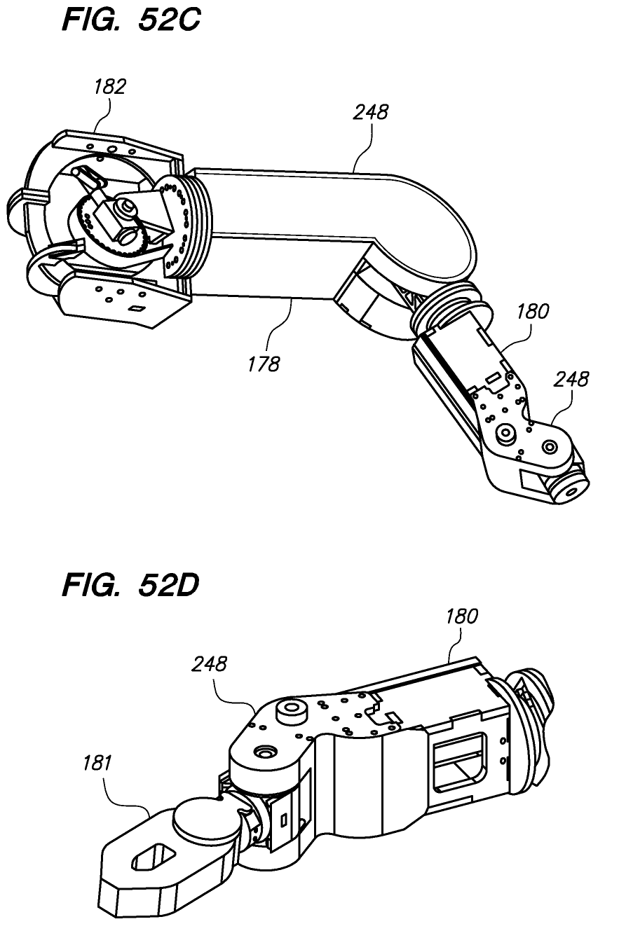

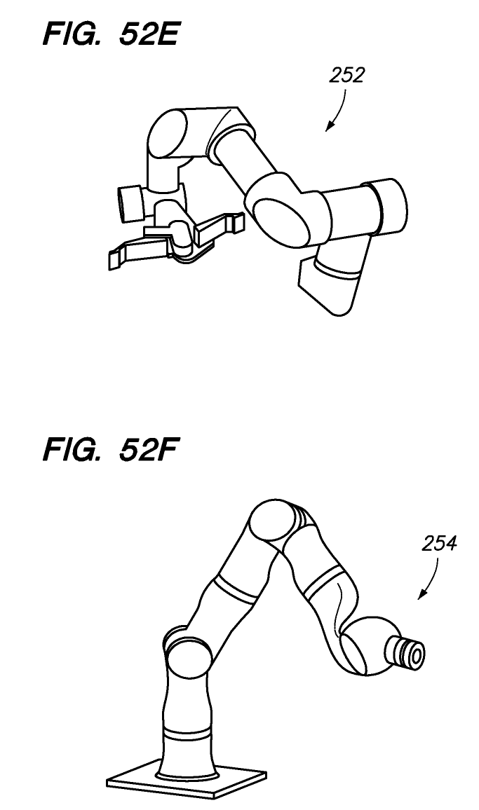

Flexing of arm joints is fundamental to a shared workspace. If arm joint flexion is limited, then areas close to the joints will not be accessible to the arms. Specifically, this applies to the flexion of a robot shoulder and elbow joints. FIG. 51A depicts a fairly ideal range of motion configuration for an arm (244); FIG. 51B depicts a more typical range of motion scenario. FIGS. 52A-52F depict implementations to accomplish extended ranges of motion in a flexion joint or plurality thereof. FIG. 52A depicts a set of arms (244, 246), each of which has a “canted” link (250) as well as an uncanted link (248). By canting one or both links, the range of motion is enhanced close to the joints themselves. FIG. 52B depicts an embodiment having two arms (244, 246), each of which has two canted links (248). FIGS. 52C and 52D illustrate implementation embodiments for aspects of the abovedescribed robotic arm configuration. The upper arm assembly (178) is a canted link (248), as is the forearm assembly (180) a canted link (248). Another technique for achieving increased range of motion is designing links to mechanically clear each other as they revolve around their joint axes. FIG. 52E depicts a non-planar link configuration (252); FIG. 52F depicts a hybrid configuration (254) featuring nonplanar and canted links.

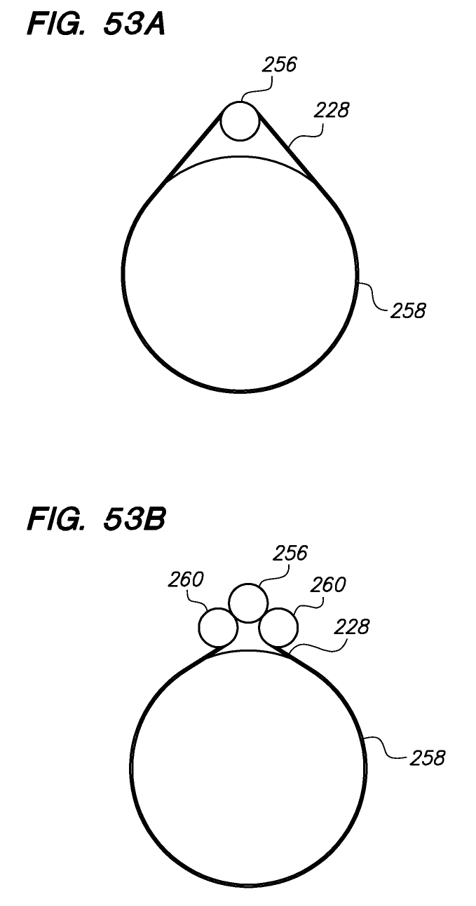

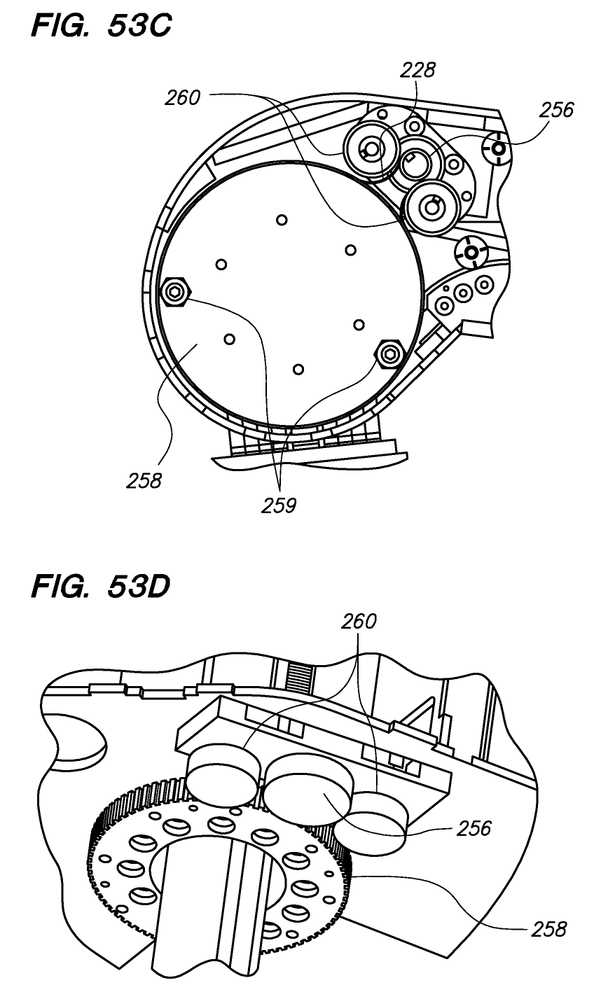

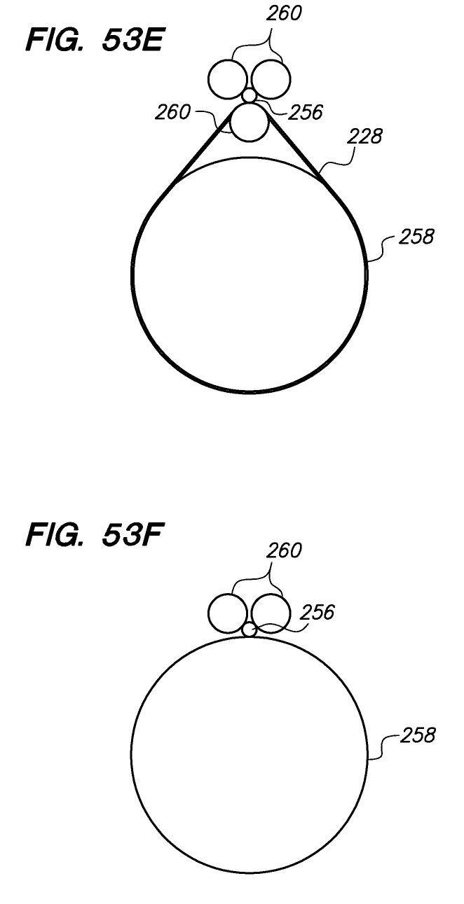

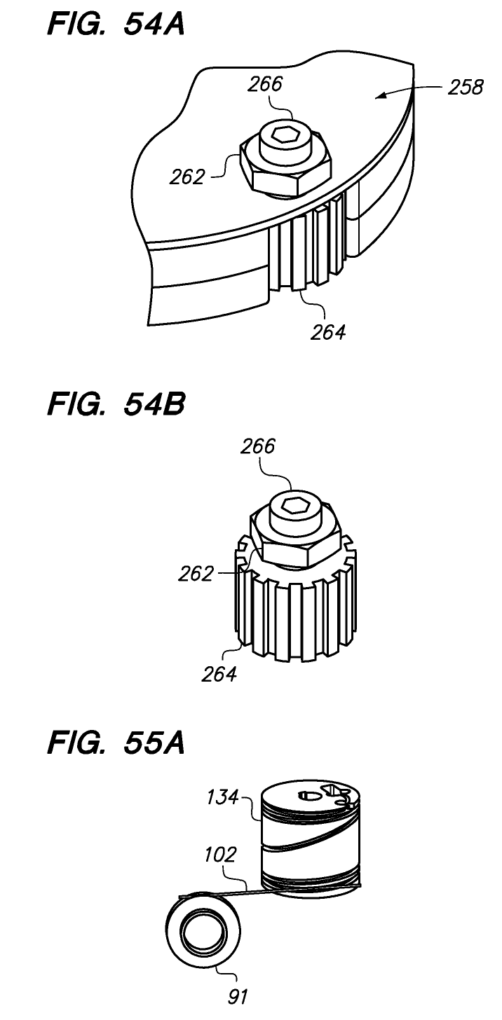

Rotary drivetrain considerations also are important in many of the preferred embodiments. In the type of drivetrain shown in FIG. 53A, a flexible tension member, such as a belt (228), is used to drivably couple the drive pulley (256) with the driven pulley (258). Example tension members include belts, bands and cables. The objective of the reverse bending implementation illustrated in FIG. 53B is to increase engagement of the tension member over more of the circumference of the drive pulley. As shown, this may be accomplished using a set of idlers (260) or idler pulleys. In this example, the engagement is increased from approximately 90° of the circumference of the drive pulley (256) to 270°. Increasing the engagement is important in drivetrains with tension members since the amount of torque transmitted from drive pulley (256) to output pulley (258) is most often limited by the tensile strength of the tension member and (if present) the strength of the teeth of the belt. Increasing the friction surface in contact with the drive pulley, or increasing the number of teeth engaged, results in higher transmitted loads for the same tension member. A robotic joint actuation implementation is depicted in FIG. 53C. In this implementation the input degree of freedom (drive pulley—256) is continuous and the output degree of freedom (258) is not continuous. The tension member in this implementation is a timing belt that is not pictured. The drive pulley (256) in this implementation is cogged for the timing belt. The output pulley (258) is smooth and has a tensioning mechanism (259) for the timing pulley built into it, as described in further detail below in reference to FIGS. 54A and 54B. Referring to FIG. 53D, another implementation is illustrated. This implementation is for continuous rotation of the input (256) and the output (258) degrees of freedom. This implementation is for a timing belt. For illustrative purposes, certain features are hidden (the cogs on the drive pulley, and timing belt, are not pictured FIG. 53D).

In a friction band drive, the drive pulley is reduced in diameter to maximize the drive ratio. In a conventional reduction mechanism, the diameter of the drive pulley cannot be reduced past the minimum bending radius of the tension member. In this implementation, either the idler's diameter (FIG. 53E) or the output pulley diameter (FIG. 53F) is the limiting factor, and these can be significantly larger than the motor drive pulley itself. Engagement is optimized by loading the tension member (228) or output pulley (258) to the drive pulley (256) with the help of idlers (260). This permits a higher friction load between drive pulley and tension member than possible by only tensioning the flexible member around the pulleys. Referring to FIGS. 53E and 53F, two embodiments are illustrated wherein the drive pulley diameter is minimized and the normal load is maximized. The two additional top idlers pictured in FIG. 53E are optional but permit the three idlers (260) to be mounted on the same mounting plate as the drive pulley (258), reducing the force on the output pulley (256) shaft.

A cable drive is a traditional implementation in which a cable makes one or more wraps around the drive pulley and then is terminated on the output pulley. Certain drivetrain designs from suppliers such as Sensable Technologies Inc. incorporate such configurations. They may be useful and desirable in certain robotic embodiments.

In tension member driven drivetrains, the tension member (228) is tensioned to minimize the compliance and backlash between the drive pulley (256) and the output pulley (258). Tension may be achieved by adjusting the location of the drive pulley (256), and associated idlers (260) if necessary, closer to or further from the output pulley (258). Alternate options include passive tensioning systems that use spring(s) inline with the tension member or spring(s) to move the drive pulley (256) away from the output pulley (258).

FIGS. 54A and 54B depict a passive tensioning system for non-continuous output systems. In this configuration the tension member can be both terminated and tensioned. In this implementation, the tensioner (264) is designed to engage a timing belt. Other terminations are also possible, such as a band mount, a cable termination or other engaging termination for a tension member. The tensioner (264) has a threaded extension (266) that protrudes through a surface in the output pulley (258). The nut (262) locks the tensioner in place. The direction of the thread in the nut (262) and threaded extension (266)is such that the tension force in the tension member tightens the tensioner (264) against the nut. Since the tension member is always under a tensile load, the tensioning mechanism generally cannot rotate and loosen itself. In this example implementation for a timing belt, the design is such that an adequate number of teeth are engaged with the belt to maximize the tension rating for the belt.

A backdrivable transmission is defined as one in which the input of the transmission can be driven by a torque (or force) applied to the output. Generally, friction and inertial forces combine to resist input torques in drivetrains. To improve backdrivability of a drivetrain, friction and inertia both generally must be reduced. Different types of drivetrains can be combined to achieve the desired amount of backdrivability. In general, the drivetrains presented herein are more backdrivable for a given reduction ratio as compared to traditional gear-based reduction systems.

Backlash is the small angular indeterminacy between the input and output of a drivetrain due to, for example, incomplete meshing of the teeth of engaged gears, or slack in a toothed belt or chain. For many applications, minimizing backlash is desired, especially in drivetrains that alternate between rotating clockwise and clockwise against a variable load, such as in the joints of a robot manipulator. In general, traditional gearboxes have backlash. The mechanisms illustrated above with tension members and tensioners are backlash-free. In a multi-stage drivetrain, if a gearbox with backlash is placed near the input stages, and a backlash-free drivetrain stage is placed near the output, then the effect of the backlash will be minimized in comparison to one in which the backlash-free stage is placed near the input.

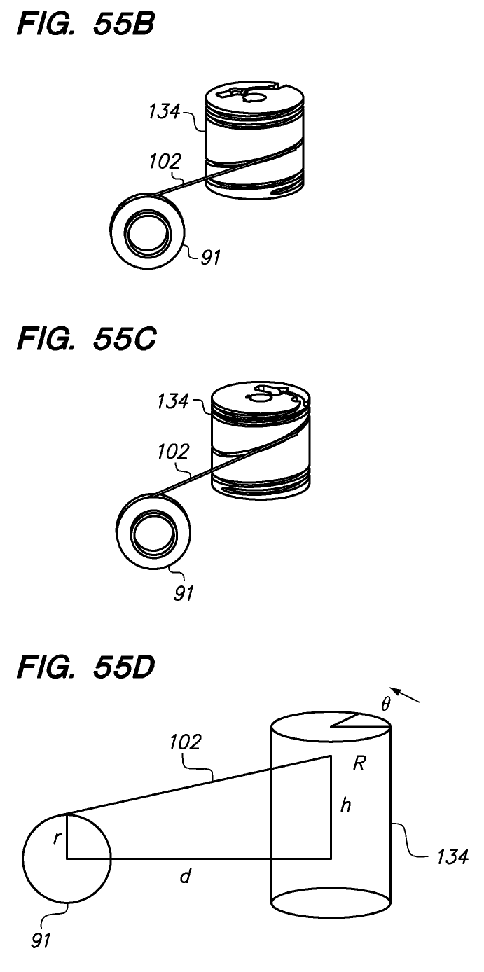

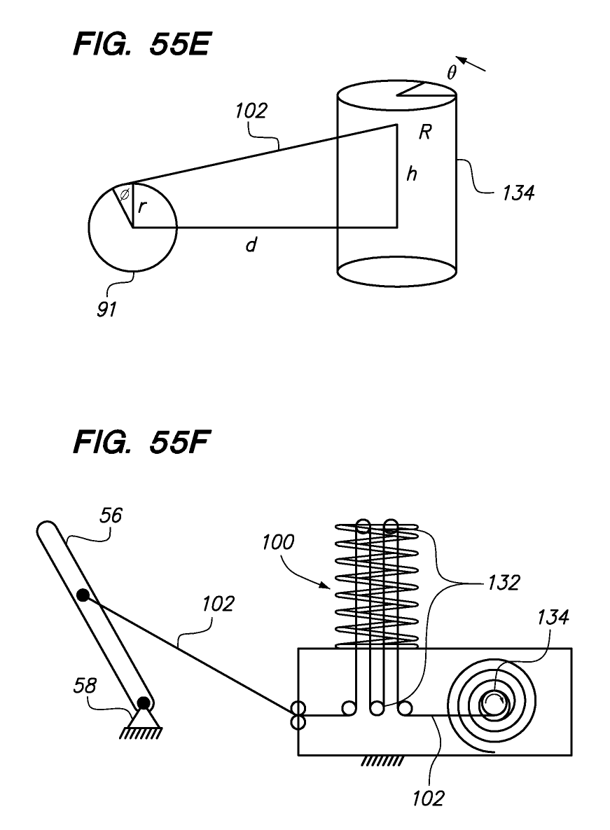

Non-continuous drivetrains using cables or other tension elements may require a mechanism to take up cable at one or both ends. Solutions generally include actuators or springs (linear or rotary) to provide torque, and may include drums, capstans or pulleys to play out and take in the cable as appropriate. FIGS. 55A-55C depict an implementation embodiment for using a rotary actuator and drum (134) to take up cable in a cable tension element (102) configuration. This implementation has the advantages over simple drums in that: a) it takes up multiple turns of cable; b) the cable does not wrap on itself; c) the amount of cable taken up is determined precisely by the drum angle; and d) and the cable life is maximized by reducing friction due to the geometry of the take-up path on the drum. The cable take-up drum (134) is designed so that the cable path on the outer surface is always tangent to the pulley (91) as it takes up cable. FIGS. 55A-55C show the cable drum in three positions with increasing amounts of cable let out from left to right. In the implementation pictured, the path design is determined by an exponential function (see mathematical development below). Two additional wraps are included at the top of the drum (134) before the termination to relieve some of the mechanical stress at the termination. The drum (134) preferably will never be rotated to allow the cable to unwrap these two stress-relieving wraps. Referring to FIG. 55D, mathematical development for fixed point of tangency at the top of the pulley (91) is as follows:

$$\frac{d h}{d θ} = \frac{2 π R ( h - r )}{d}$$

$$h = \frac{d}{2 π R ( h - r )} {e}^{\frac{2 π R ( h - r )}{d} θ}$$

Referring to FIG. 55E, mathematical development for moving the point of tangency, given by , along the pulley is as follows (this more accurate implementation is especially useful when the pulley 91 is close to the takeup drum 134):

$$\frac{d h}{d θ} = 2 π R \frac{h - r cos φ}{h + r sin φ}$$

$$tan ( φ - \frac{π}{2} ) = 2 π R \frac{d h}{d θ}$$

Actuation of the take-up drum (134) in a configuration such as that depicted in FIG. 55F is generally accomplished with a motor. To generate adequate torque for the take-up drum, a motor or gear motor may be used. If the take-up motor is backdrivable, it will be consuming power to hold its position when the system outputting a constant, non-zero force. In many applications, a brake may be added to hold the static load with no power consumption when the take-up drum is not being adjusted. In many applications, reducing the torque requirement of the take-up drum motor is desirable. An additional spring can offset some of the torque that this motor would otherwise need to provide (see, for example, U.S. Patent Application publication number 20040035243, incorporated herein by reference in its entirety). One solution is to use a coil spring inline with the take-up drum (134) to remove some of the torque requirements of the motor.

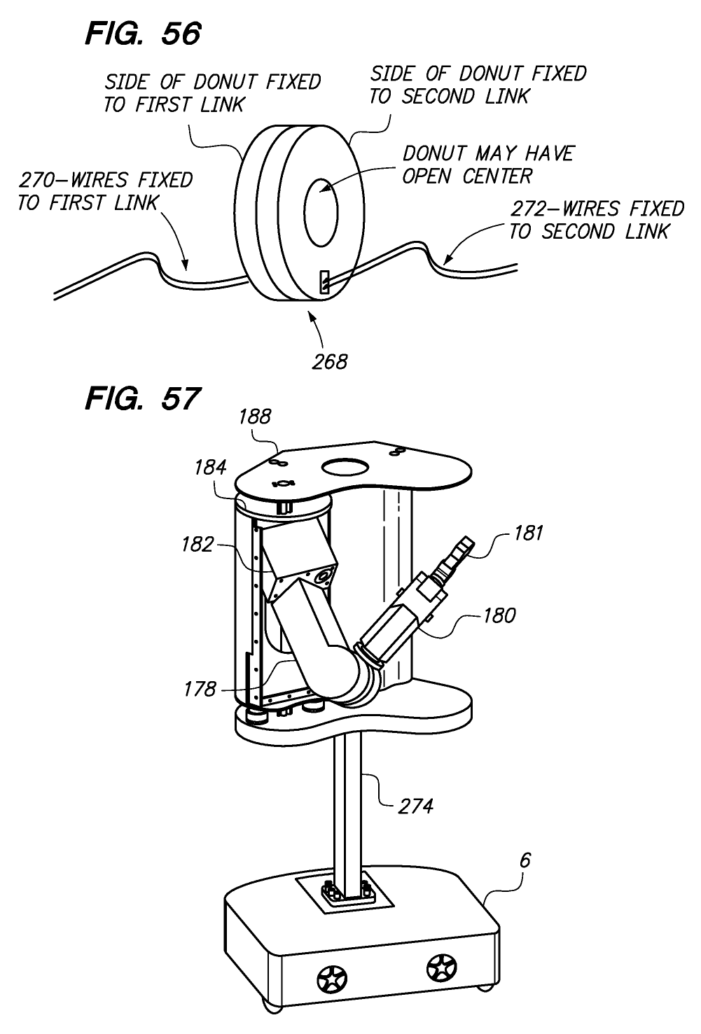

Passing signals and power across robotic joints can be an important consideration. In certain embodiments, “joint donut” devices (268), may be utilized to facilitate this, as depicted in FIG. 56. In a preferred joint donut configuration, all of the needed mechanical and electrical functionality is contained in a single unit. With this integrated approach, many of the critical details can be more readily addressed together as a subassembly, without having to consider the design of the robot per se. FIG. 56 depicts an implementation that can be mounted between two serial links of a manipulator. Depending on the requirements of the joint, different combinations of the following features may be integrated: relative rotation between the two sides of the donut; joint limits (for non-continuous rotation); flexible wire loops with strain relief (for non-continuous rotation); slip rings for power and/or signal; optical slip ring for data transmission; inductive coupling system for electrical power transmission; absolute joint angle sensors including optical potentiometer for absolute joint angle sensing, incremental or absolute encoders, standard potentiometer for absolute joint angle sensing, and/or Hall effect sensor for absolute joint angle sensing; single or multi axis accelerometers on one or both sides of the joint donut; single or multi axis gyroscopes on one or both sides of the joint donut; plugs so that power and signal interconnects can be plugged into either side of the donut.

4. Exemplary Embodiment—“PR1” Personal Robot Embodiment:

Referring to FIGS. 57-62, various aspects of preferred humanoid robotic embodiments are depicted, incorporating many of the abovedescribed elements and subassembly configurations. Referring to FIG. 57, an embodiment of a humanoid robotic system is depicted comprising a mobile base (6), a body elevator assembly (274), a body assembly (188), and an arm assembly comprising a shoulder pan turret assembly (184), a shoulder flexion assembly (182), an upper arm assembly (178), a forearm assembly (180), and a gripper assembly (181). In the preferred embodiment, the system comprises two complete, mirror-image identical, arm assemblies, but for illustrative purposes, only one is shown in FIG. 57.

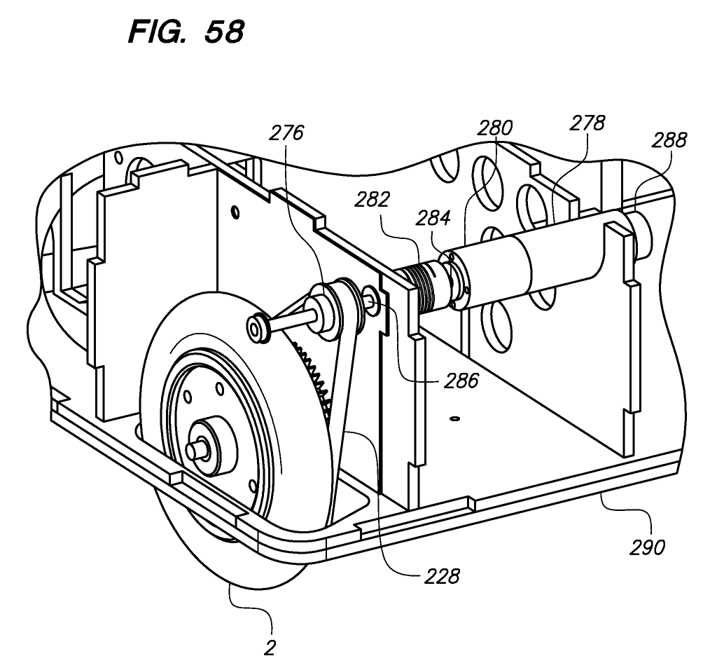

Referring to FIG. 58, aspects of the mobile base (6) assembly are illustrated. In one embodiment, similar to that illustrated in FIG. 1C, each of two driven wheels (2) are operably coupled to a motor (278) as shown. An encoder (288) is coupled to the motor (278), which is coupled to a gearbox or gearhead (280), which is coupled to a shaft (284), which is coupled to a shaft coupler (282), which is coupled to another shaft (286), which is coupled to a drive pulley (276), which is coupled, by a drive belt (228), to a driven pulley (not shown—directly coupled to the wheel 2).

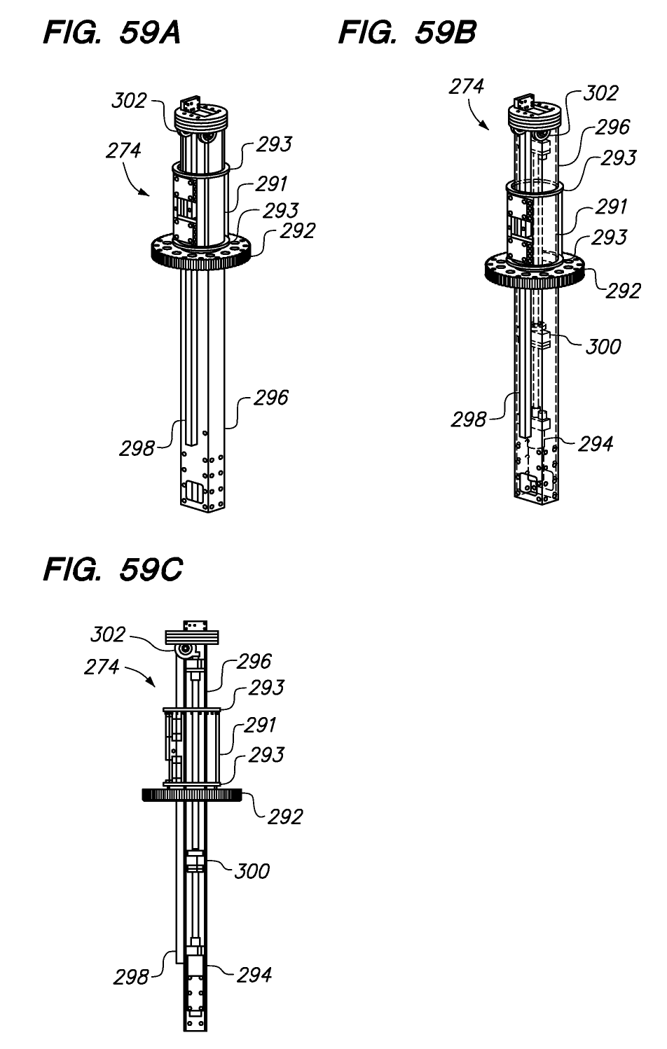

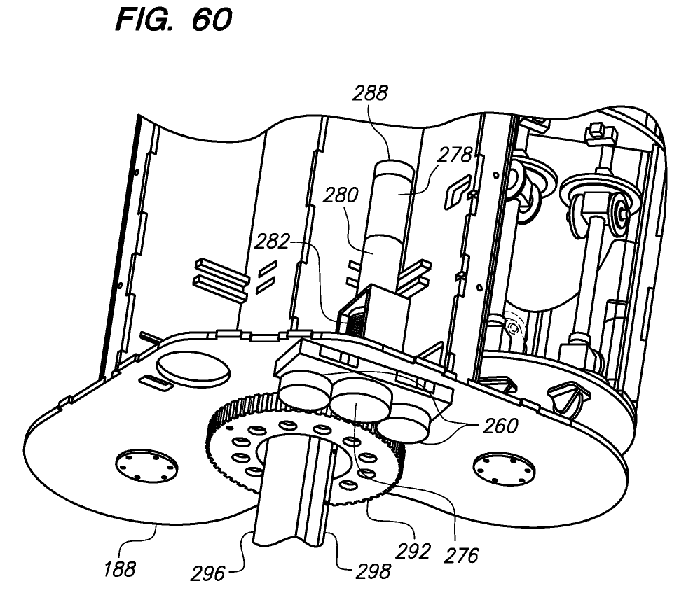

Referring to FIGS. 59A-59C, aspects of a preferred body elevation mechanism (274) are depicted in different orientations and shadowing to illustrate various components. The body assembly (not shown) is coupled to the base (not shown) in this implementation with a combination prismatic and rotary joint comprising the body elevation assembly (274). The prismatic joint adjusts the workspace of the arms vertically and the rotary joint pans the body relative to the base. In this implementation, the prismatic joint is driven by a lead screw assembly (300) coupled to a motor (294). The lead screw is configured to controllably elevate, up or down, a threaded fitting coupled to a body coupler carriage (291) through a cable and pulley (302) subassembly. The body coupler carriage (291) is slidably coupled to the outer aspect of the elevator structural member (296) and is constrained and guided by a rail (298) coupled to the elevator structural member (296). The lower portion of the body coupler carriage (291) comprises a body rotation pinion (292), discussed below in reference to FIG. 60. A set of ring bearings (293) coupled to the body coupler carriage (291) allow for relative rotation of the body assembly (not shown) relative to the body coupler carriage (291), as such body roll actuation is driven by the belted interfacing between the body rotation pinion (292) and a drive pulley (276), as described below in reference to FIG. 60. The base of the elevator structural member (296) is fixedly coupled to the movable base assembly (not shown in FIGS. 59A-59C; shown as element 6 in FIG. 58).

Referring to FIG. 60, a body assembly (188) is depicted rotatably interfaced with a body coupler carriage (the body rotation pinion 292 of which is shown), the carriage being linearly movably coupled to the elevator structural member (296) as described above in reference to FIGS. 59A-59C. A drive pulley (276) coupled to a motor (278) and encoder (288) by a series of shafts (not shown) and a shaft coupler (282) is drivably coupled to the body rotation pinion (292) by a belt (not shown). A set of idlers (260) maintain a preferred contact and tensioning configuration of the belt, as described above. Thus, to roll the body assembly relative to the base and elevator assemblies, the motor is actuated, which rotates the drive pulley, which causes the body to rotate or “walk” about the axis of the body rotation pinion until the motor is stopped, reversed, etc. The large ring bearings depicted in FIGS. 59A-59C (293) facilitate such rotation. Such rotation may be conducted independently of body elevation, as described in reference to FIGS. 59A-59C.

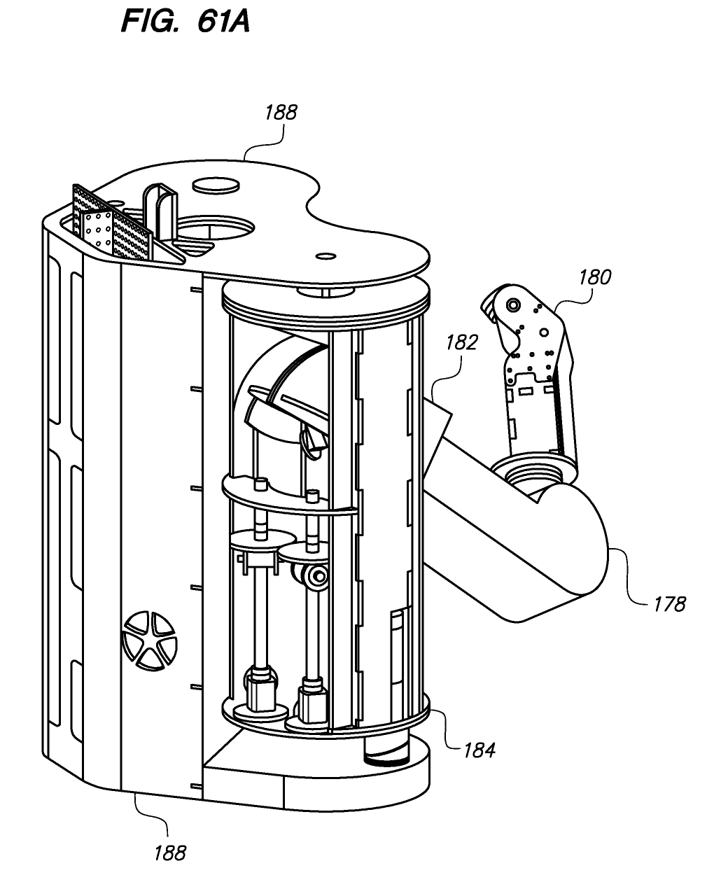

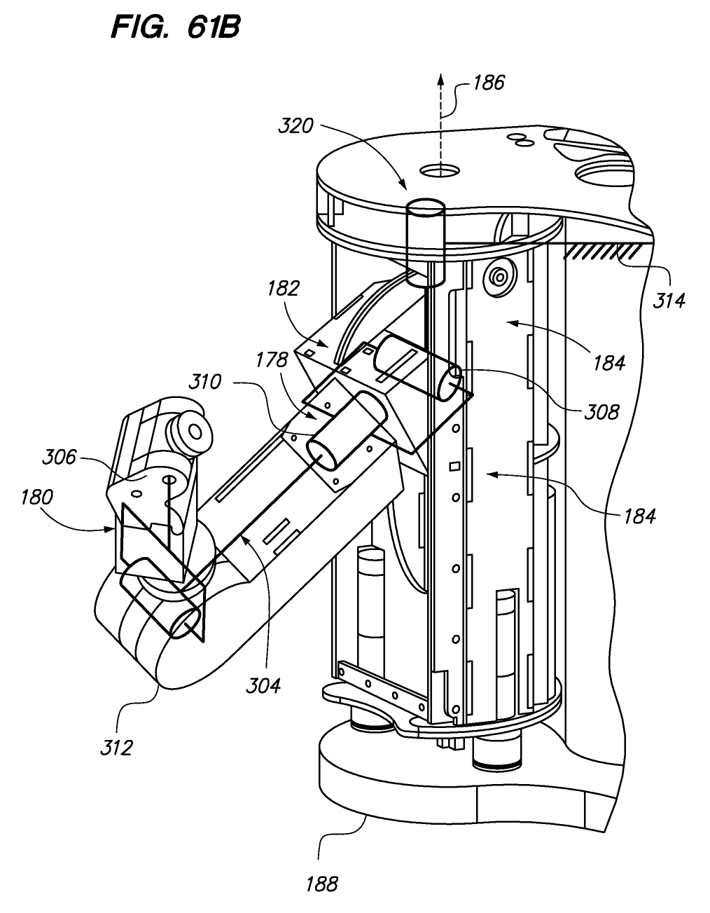

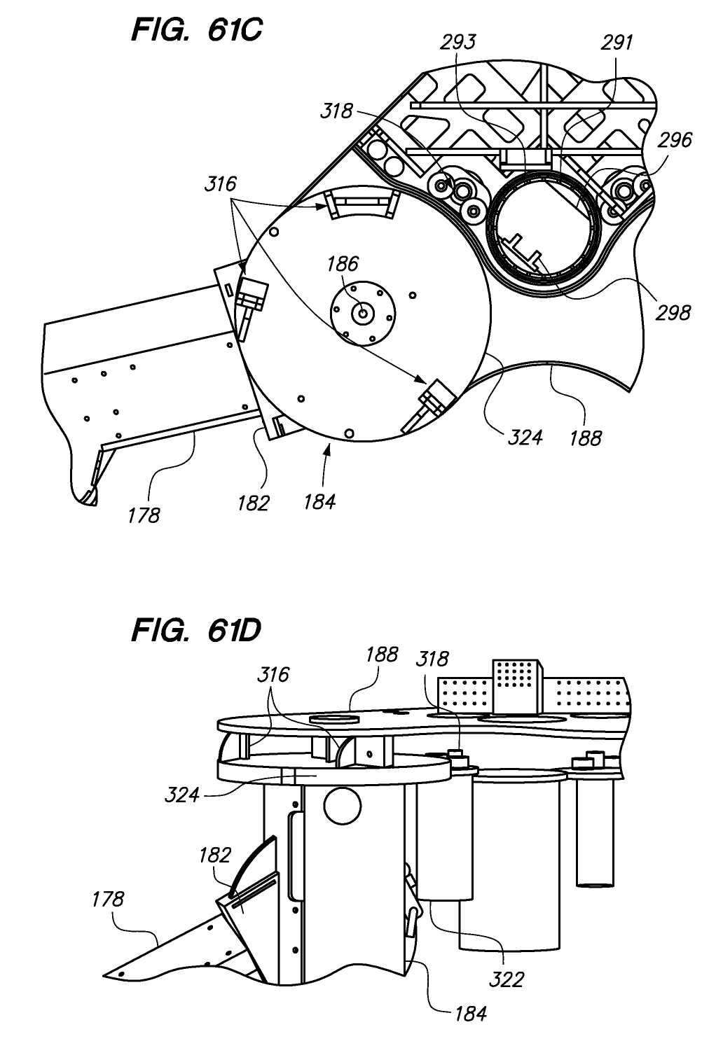

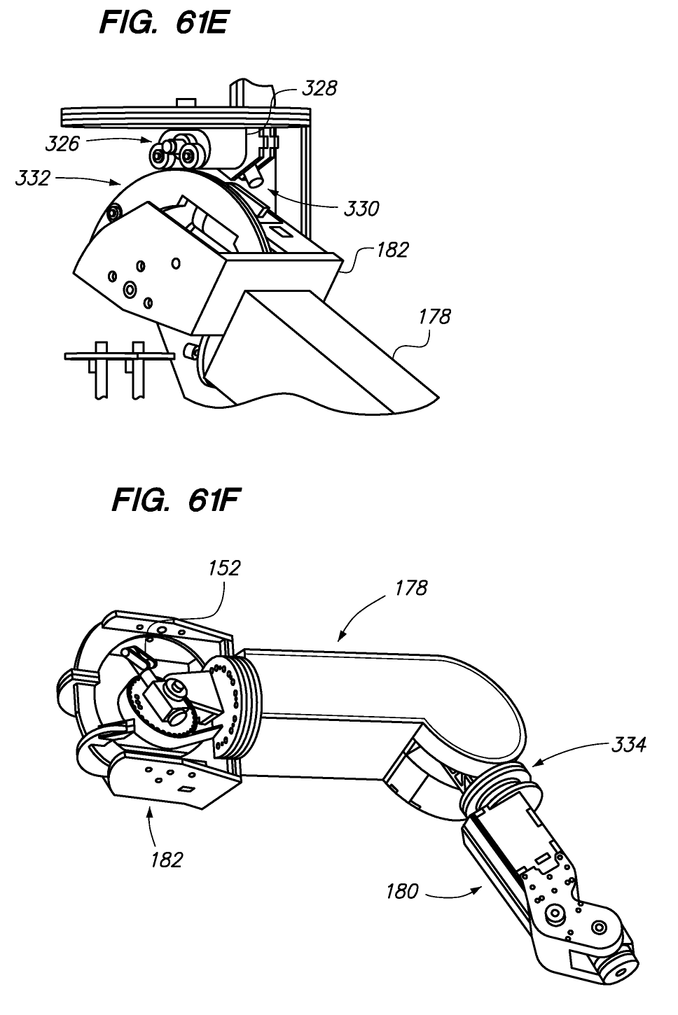

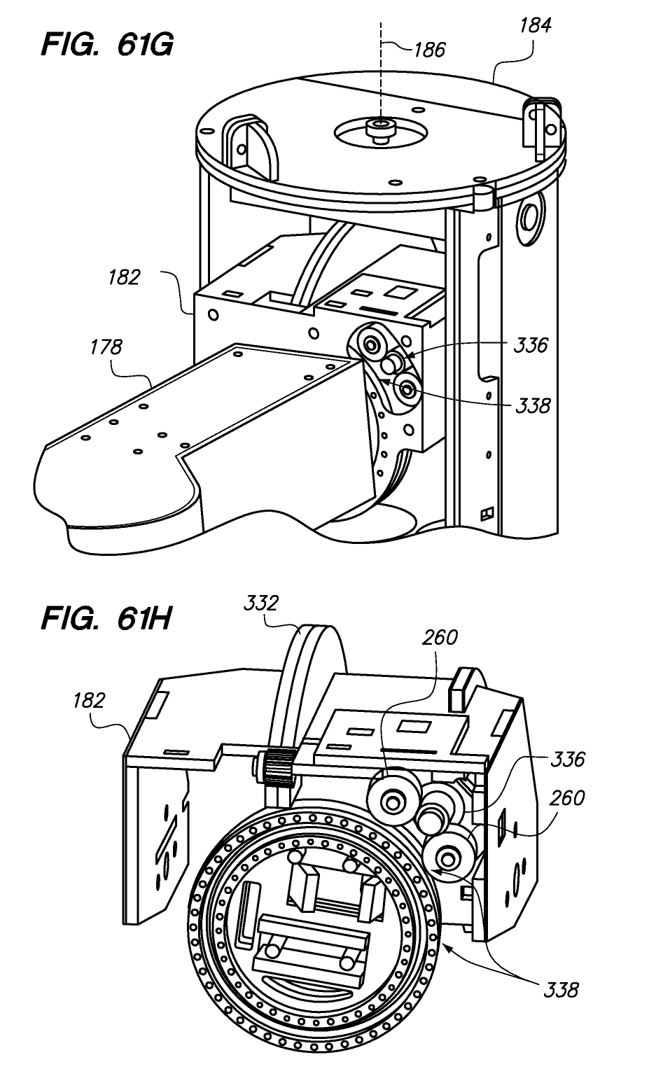

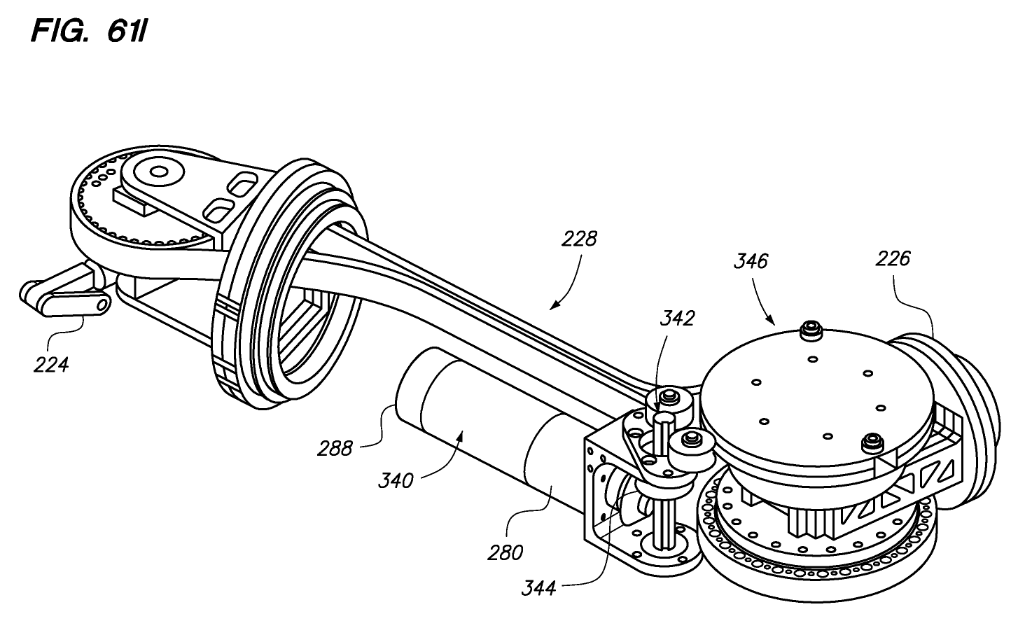

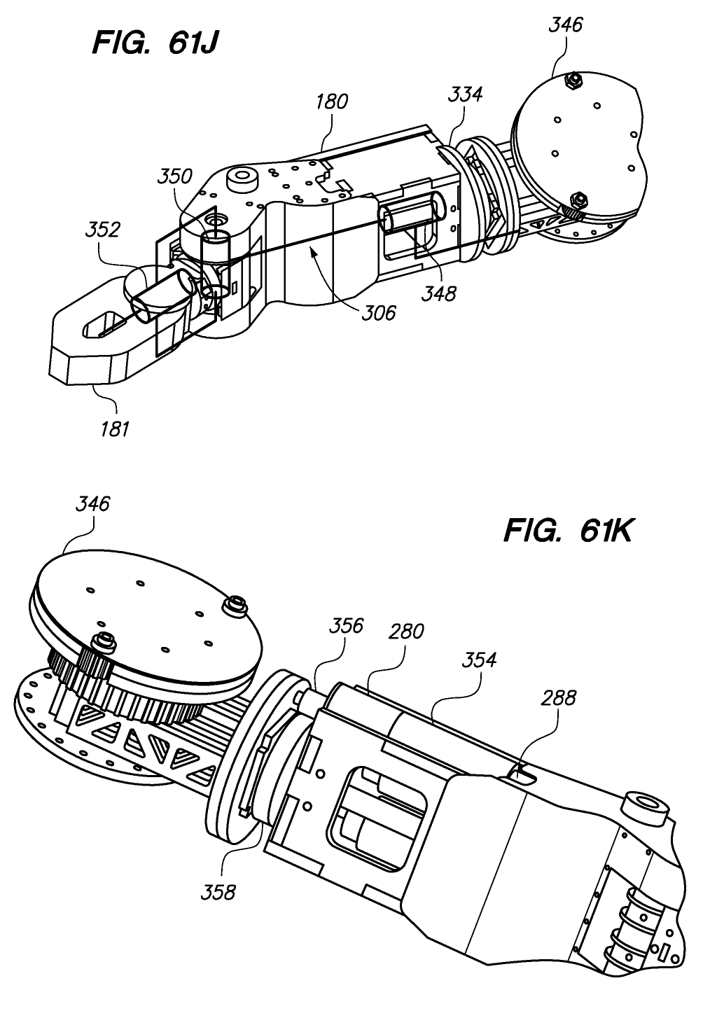

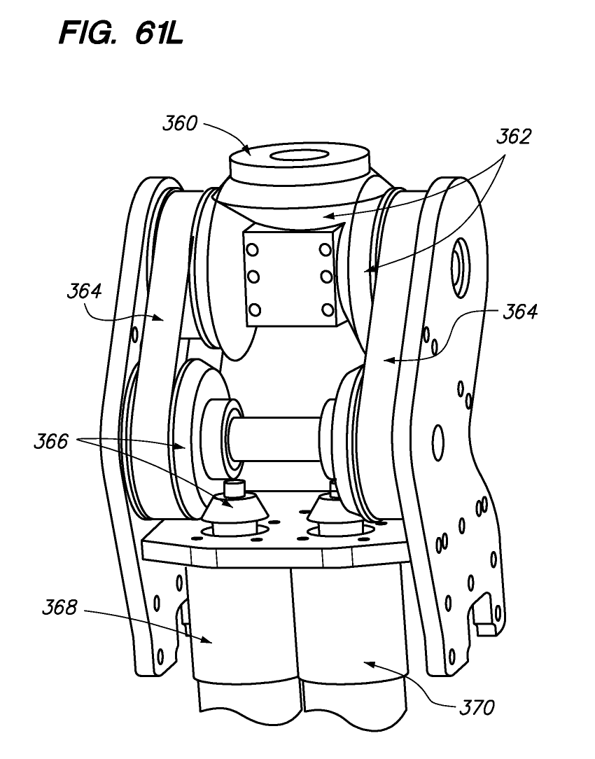

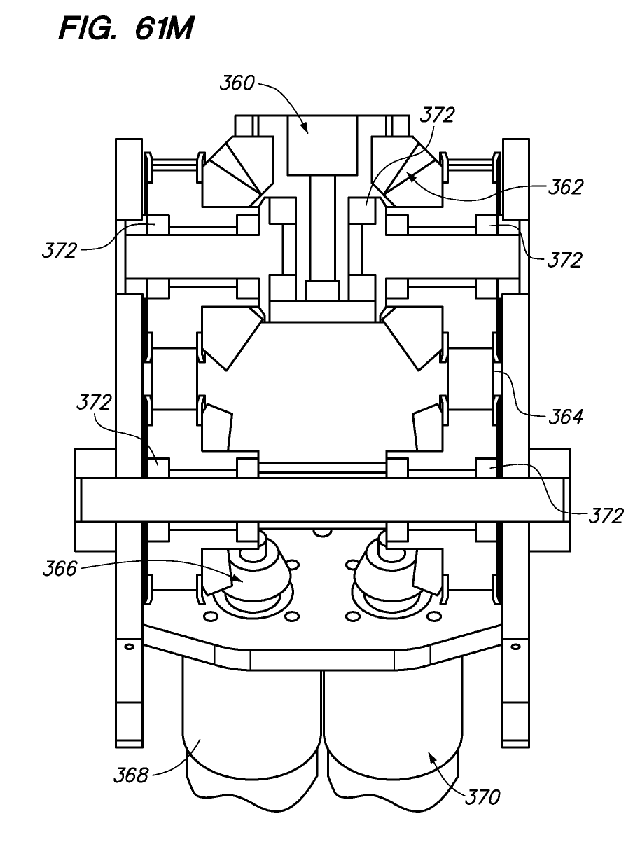

FIGS. 61A-61M illustrate aspects of a preferred arm embodiment, as movably interfaced with a body assembly (188). Referring to FIG. 61A, a cutaway view of the shoulder pan turret assembly (184) depicts elements of the arm counterbalancing hardware contained within the turret assembly (184). FIG. 61B illustrates the interaction of the body assembly (188), shoulder pan turret assembly (184), shoulder flexion assembly (182), upper arm assembly (178), and forearm assembly (180). The forearm assembly (180) is configured to controllably pitch (with an elbow flexion dof 312) and roll (about a roll axis 306) relative to the upper arm assembly (178). The upper arm assembly (178) is configured to roll (about a roll axis 304) relative to the shoulder flexion assembly (182). The shoulder flexion assembly (182) is configured to rotate (with shoulder flexion dof 308) relative to the shoulder pan turret assembly (184) to which it is coupled. Finally, the shoulder pan turret assembly (184) is configured to pan/rotate about a shoulder pan axis (186) relative to the body assembly (188) to which it is rotatably coupled. All of these relative motions may be conducted independently and/or simultaneously.

Referring to FIG. 61C, shoulder pan rotation may be limited utilizing physical stops or joint limit features (316) configured to interface with each other and prevent certain ranges of relative motion or rotation, here rotation as the shoulder pan turret assembly (184) rotates relative to the body assembly (188) as driven by the shoulder pan drive pinion (318), which is drivably interfaced to a driven pinion portion (324) of the shoulder pan turret assembly (184) by a belt (not shown). FIG. 61D depicts a different view of similar structures.

FIG. 61E depicts aspects of the drivable interfacing whereby a shoulder flexion, or tilt, actuation motor (328), is configured to controllably pitch the upper arm. The motor (328) is coupled to a drive pinion (326), which is drivably coupled to a driven pinion portion (332) of the shoulder assembly (182) by a belt (not shown). A joint limit fitting (330) prevents certain ranges of motion within the shoulder flexion assembly (182). FIG. 61F depicts a shoulder flexion assembly (182) coupled to an upper arm assembly (178), coupled (at an elbow interface 334) to a forearm assembly (180). The long axis of the forearm assembly is maintained in parallel with the parallel link (152) housed within the shoulder flexion assembly (182) utilizing a belt (not shown), as described in reference to FIG. 48D.

FIGS. 61G and 61H depict aspects of a preferred upper arm (178) roll actuation interface. Referring to FIG. 61G, an upper arm roll motor housed within the shoulder flexion assembly (182) is drivably interfaced through a drive pinion (336) and belt (not shown) with a driven pinion (338) to actuate roll of the upper arm (178) relative to the shoulder flexion assembly (182). FIG. 61H depicts a cutaway view better showing the driven pinion (338) and drive pinion (336) interfacing configurations.

Referring to FIG. 61I, aspects of a preferred elbow flexion (pitch rotation between the distal end of the upper arm assembly 178 and the proximal end of the forearm assembly 180) are illustrated. An elbow flexion drive pinion (342) is drivably coupled to a elbow flexion drive motor (340) using a set of bevel gears (344), and is drivably coupled to an elbow flexion driven pinion (346) by a drive belt (not shown). As described above, the mechanism used to maintain links (224 and 226) in parallel is a toothed belt (228). This belt assembly is fully contained within the upper arm link and therefore rotates with upper arm rotation. Large rotational interfaces are fitted with ring bearings to facilitate motion, including for elbow flexion, forearm roll, upper arm roll, shoulder flexion, and body roll (about the body elevator roll carriage, as described above).

FIGS. 61J-61M illustrate aspects of preferred forearm actuation embodiments. Referring to FIG. 61J, a forearm assembly (180) intercouples a gripper assembly (181) and a partially assembled upper arm assembly. Schematics overlaid upon the figure illustrate pitch (350—gripper pitch) and roll (348—forearm roll; 352—gripper roll) degrees of freedom. FIG. 61K illustrates aspects of forearm roll actuation, wherein a forearm roll drive pinion (356) driven by a motor (354) is drivably engaged using a belt (not shown) with a driven forearm roll pinion (358) that comprises one of the distal elements of the upper arm assembly. Actuation of the motor (354) causes the entire forearm assembly to rotate, or “walk”, itself about the central axis of the driven forearm roll pinion (358).

In this implementation, the actuator for the end-effector (i.e., the gripper) preferably is located in the end-effector itself. Alternatively, the actuator or actuators for the end-effector may be mounted in the forearm and mechanically transmit that actuation through or around the wrist to the end-effector. As described above, in this implementation, the first roll of the wrist is implemented by rolling the whole forearm itself. In other embodiments it may be desirable to configure accommodations to roll the wrist without rolling the forearm. As described above, in the depicted implementation, the actuator for the forearm rotation is in the forearm. In another embodiment, that actuator may be placed in the elbow joint and configured to act against the forearm instead. In one embodiment, continuous (i.e., infinite) rotation of the gripper assembly roll degree of freedom is preferred. In general any of the arm joints may be implemented to have continuous rotation, including the forearm. Cameras (not shown) as sensors may be mounted at or near the gripper assembly (181). Mounting cameras on all of the linkages of the robot in general may be desirable and practical in certain applications.

Referring to FIGS. 61L and 61M, aspects of a wrist embodiment are depicted. Referring to FIGS. 61L and 61M, element 360 represents a gripper assembly mounting member; element 364 represents a drive belt; element 366 represents a bevel gear set; element 362 represents another bevel gear set; elements 368 and 378 represent motors; and element 372 represents a bearing portion cross section. In the depicted implementation, the wrist tilt and roll axes are driven by two actuators (368, 378). Differential motion of the actuators results in wrist roll motion. The sum of the actuator motions results in wrist tilt or pitch motion. This implementation gives continuous rotation at the output wrist roll degree of freedom of the wrist. Referring to FIGS. 61L and 61M, the depicted actuation system consists of the following: a bevel gear (366) on the motor shaft and belt idler, a belt (364) that runs from this first gear set (366) to the output gear set (362), and an output gear set (362) that couples the relative rotations of the two motors (368, 370) into pitch and roll of an end-effector, such as a gripper, which may be mounted to the end effector mounting structure (360). The three-stage, gear-and-belt drivetrain design of the wrist realizes two primary objectives. The first is to accommodate the doglegging of the joint, which is desired to maximize the joint flex range of motion and eliminate a pinch point. The second objective is to keep the structure of the wrist and forearm as slim as possible. Minimizing the cross-sectional area of the wrist area is important not only for aesthetic reasons, but from a practical perspective, it minimizes the chance of collisions with objects as the whole forearm rotates. As a result, all the drivetrain and actuator components are contained inside a constrained space. The depicted embodiment is one possible implementation to achieve the stated objectives.

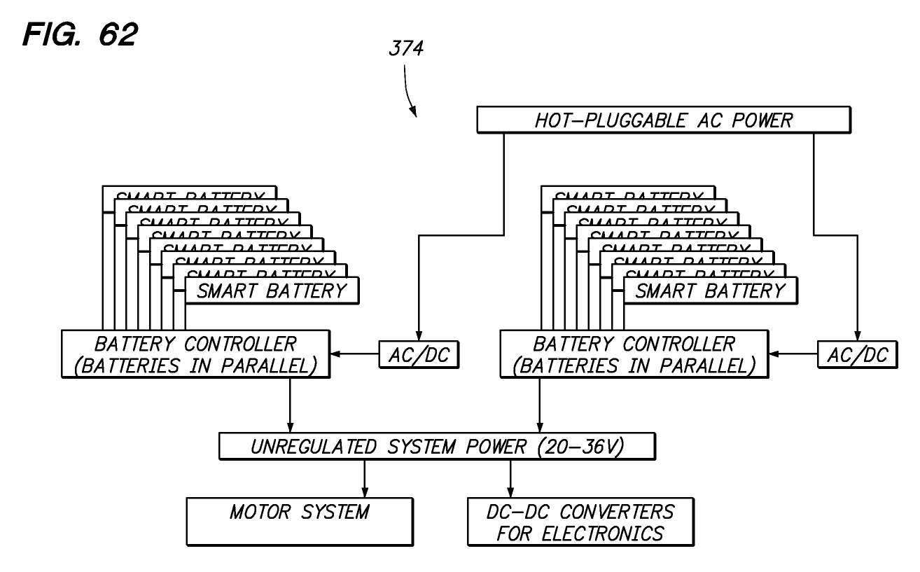

Referring to FIG. 62, a battery and power system (374) embodiment is depicted. There are many possible power systems that may be used in personal robot applications. These range from the traditional battery technology including lead acid, NiCd, NiMh to advanced technologies including the lithium-ion system described below. In general desirable characteristics include being hot-pluggable to the AC power source, safety protections, and long battery life. The system shown in FIG. 62 preferably uses multiple lithium-ion smart batteries to provide unregulated power to the system at 36V. The use of smart batteries allows for a modular battery system, potential upgrades when new chemistries become available, and monitoring of power system status at th individual battery level. Using multiple batteries with an intelligent controller results in a system that is tolerant of the failure of any single battery element, since such a loss only reduces the maximum available power and energy storage. The AC/DC chargers are mounted on the robot to allow the system to be recharged from any AC wall outlet, and to be able to run the robot uninterrupted during charging.

From a communications perspective, almost all loops are closed through a central processor (or processors) at −1 khz. Distributed controllers on sensor boards and motor driver boards handle computations that need to be dealt with faster than that, such as current loop closure. The communications preferably are implemented as a standard Ethernet network, but also may be implemented with any other communications protocol that can provide low-latency communication.

There are a number of basic configurations for the motor control network. These include distributed stacks, distributed drivers, a heterogeneous network, and hybrid configurations. Distributed stacks, each comprising 5 motor control units, each of which supports six motors, six encoders, analog and digital I/O, and RS-232 communications preferably are built into a robot. They are connected via a standard Ethernet network with a star topology to the control computer. Each unit consists of a controller card stacked with six motor drivers. The functionality is implemented in firmware on a CPLD and microcontroller that generate the PWM signals, have access to all sensor readings on the board (including sensed motor current), and communicate with the host system. This enables a variety of control schemes to be implemented, ranging from fully autonomous control to a completely dependent slave system.

Preferably the sytem has a distributed controller configuration with one controller per motor, and communications and raw motor power supplied to all the boards. Each board preferably contains electronics and code to communicate with other boards and with the host computer, close a control loop around the motor, and read sensors. One implementation embodiment includes driving one motor, reading one optical encoder and an absolute feedback device (e.g. a potentiometer or resolver). Network communications may be a ring architecture, a tree-based system, wireless, or star topology, or any other setup.

Heterogeneous network configuration is preferred, wherein different nodes implement different functionality (single high performance motor drivers, lower-current or lower accuracy units, sensor processing units, etc), all together in one network.

Several networks of the type described above may co-exist in hybrid configurations, either being combined at the base to interface with the computer, DSP, or other central processor, or being fed into multiple different processors.

From a controls perspective, preferably the control computer sends out current commands, which are executed by the motor control unit. Since current is proportional to torque in a DC motor, this allows direct control over the torque exerted by the motor. In addition, the computer preferably is configured to be able to send out position commands (instantaneous or trajectory), which then may be followed by the unit using PID or other similar control configurations.

Preferably velocity control may be accomplished without encoder data, since back EMF developed by an electric motor is proportional to the motor's velocity. The controller preferably is capable of closing a control loop around the motor back EMF to provide damping without external velocity feedback. This can be useful for recovering from failures, or for controlling joints that only have lower-resolution sensors (e.g. potentiometers at joints) at higher bandwidths.

The boards can be configured to take wave variables as inputs and return wave variable responses. The velocity estimates used can come directly from back EMF estimation, from differentiation of encoders signals, from external tachometers accelerometers or gyroscopes, or from a combination of these velocity sensors. The forces used can come directly from the motor current or from separate force sensors in the mechanism.

Configuration commands may also be sent “on the fly” to change the configuration of the board depending on the situation. Examples of this include switching to sign-magnitude PWM control when joints are not being used for precise force control and do not require clean zero crossings, changing the parameters of the current loops itself to provide damping or smoothing required by the control system, or enabling and disabling driver features and motor power to certain axes for power use minimization.

From a feedback control loop perspective, the boards can read positions from encoders or other position sensors which may be present (potentiometers, etc) and transfer that information back to the computer.

Velocity estimates from back-EMF estimation, differentiation of encoders signals, external tachometers, accelerometers, gyroscopes, or from a combination of these velocity sensors may be processed locally to achieve safety and functionality outlined in the subsequent software section. Alternatively, or additionally, separate data streams from each of the sensors can be fed back to be processed on-board the computer.

Because the current-loop is closed in firmware on the motor drive board, there is more information about electrical state available than on many amplifiers, which may be helpful in estimating system parameters, identifying faults or system errors, recovering from errors, providing good behaviors in case of errors, replacing traditional sensors, or increasing accuracy of estimates obtained from standard sensors. Any value available in the computation of the control loop can be communicated back to the computer, in particular: supply voltage, PWM value provided to motor, voltage provided to motor, commanded current, measured current, estimated resistance, and estimated back-EMF value.

Wave variables may be returned directly to the computer, allowing for guaranteed limits on energy exerted by the system on the world. Other computed parameters include values such as velocity estimates, which are better estimated with the high servo-rate of the motor-board loop (˜10 khz) than the 1 khz main loop.

Regarding message passing, one possible model for the entire communications network is to use Bayesian message passing (belief propagation or another similar algorithms) everywhere in the system so that redundant sensor readings may be automatically combined in correct ways, faults may be detected both locally and globally, and errors in measurement, uncertainties about initialization, and sensor or network problems may all be handled in a graceful and mathematically correct way.

From a software architecture perspective, on-board the computer, and on the distributed micro-controllers (on the driver boards and elsewhere), a layered system preferably enforces safety constraints ranging from the low-level limits on commanded current that enforce thermal limits, through code that prevents hard collisions with joint limits, and enforces the unprotected joint limits that are needed to protect cable runs or other parts of the mechanism. It also preferably includes code that monitors the overall system behavior for readings that may indicate failure of electrical, mechanical, or software components. Values monitored by the configuration preferably include motor currents, velocity estimates, commanded torques, joint limits, position estimates, workspace limits, kinetic energy limits, robot dynamics indications, etc, as discussed below.

Motor currents may be monitored using a thermal model of motor heating to keep the motors within their thermal limits while allowing them to be driven over their continuous current for short periods of time. Velocity estimates may be determined by comparing the velocity estimate given by differentiating the encoders with the estimate given by knowledge of the motor back-EMF. This information may be used to improve the velocity estimate, as well as to detect faults in either the encoder or the current amplifier. Limits may be enforced on commanded torques that are imposed by limited maximum torque ratings of motors, transmissions, or linkages. Joint positions and velocities may be individually monitored and commanded torques adjusted to prevent joints from being driven into their limits too hard, or moving to ranges of motion or positions where they should not be going. Knowledge of mechanical limits of travel with recorded position estimates from the encoders may be utilized to detect breaking of mechanical limits, errors in encoder initialization and reading, or errors in kinematic computations. The system may also be configured to monitor overall robot configuration and apply torques to prevent entering regions of the workspace that should not be entered. These may include self-intersection conditions, configurations where the mechanism would interfere with sensor operation, or configurations where the mechanism could damage itself, e.g. by intersections in the counterbalance cables. Further, the system may be configured to account for kinetic energy limits or robot dynamics. In one embodiment, the system may be configured to use estimates of mechanism dynamics to keep track of kinetic energy of the system, and keep that under specified limits when required. This may also be expanded to track maximum deliverable impacts from various points on the robot, or other more complex safety measures. In another embodiment, the system may be configured to use the model of robot dynamics to identify deviations of robot behavior from its predicted dynamics. This both lets the operator detect hardware failures such as worn-out bearings, slipping transmissions or electrical system problems in the early stages of failure, but also lets the operator monitor and put limits on the amount of work done on the world. Especially with a backdriveable system, this knowledge lets the operator ensure that the robot never exerts a lot of force or does a lot of work on the outside world without an explicit command to do so, and lets the operator put checks in place to limit the forces and energies that can be commanded by user code.

Since in the preferred embodiment the robot is designed to potentially run many programs at once and be used with potentially un-trusted high-level code (buggy code or code in development), a concept analogous to the “permissions” model of unix-type operating systems preferably is employed. Instead of controlling access to various computer resource (cpu, memory, files, etc), access to different robot capabilities (joint torques to computation resources) is controlled. Using the above limits, individual processes may be limited in terms of any of those parameters (maximum exertable forces, maximum kinetic energies, maximum work done on the world, joints which can be controlled) to allow un-trusted code to run without the possibility of causing undesired problems. Several preferred use cases for this follow.

Axis limiting: Code written for directing a pan-tilt camera may be limited to controlling only the links responsible for the positioning of the camera, so that it may be guaranteed that the code will not interfere with control of the arms or of robot navigation. Another application comprises preventing code from controlling the wheel motors when the robot cannot or should not move as determined by another process.

Power limiting: Although the motors can be run beyond their continuous power ratings for short periods of time, the output current will have to be limited if they are run beyond their limits for more than a few seconds. To prevent this from causing problems with user code (e.g. using that to lift up an object too heavy to hold long term), in a conservative implementation, all code except safety code is limited to only applying forces within the continuous ratings of the motors.

Limiting for testing: When new code is being developed, there is a possibility that something will be completely wrong with the code and that it will cause instability, or undesirable behavior. Even with safety systems in place, this can be dangerous to the mechanism, the surrounding environments, and people working with the robot. To compensate for this, basic protections preferably may be turned up (made more conservative) to limit variables such as motor power, max energy output, max frequency output, etc., to allow developers to test algorithms in real-world environments.

Limiting for priority: When multiple applications are running, some generally are more important than others. Being able to resolve conflicting commands between different programs in an intelligent way is an important factor in enabling this. For example, code that monitors the balance of the robot and prevents actions that would cause it to tip over should be able to override commands from specific manipulation tasks, for example. Even within tasks, if, for example, a robot embodiment is carrying a glass of water in its gripper, the code that keeps the water from spilling preferably needs to be able to prevent commands to the wheels that will cause jerking and spillage.

Safety code: As an embodiment of the robot moves into new environments, takes on new tasks, or even as aspects of the robot itself are improved, more constraints on what constitutes safe or unsafe behavior are imposed. The priority deals with the increased high level functionality and how the system controls the way in which these safety systems interact with each other, and with the task level code.

From a task level environment perspective, to perform useful tasks with a robot, the software that implements the logic in the tasks generally must accesses system information and be able to control the robot and other task modules in appropriate ways. A publish-subscribe architecture preferably is used to allow general development and interconnection of modules. Interaction with the robot sensors may be performed by subscribing to raw or processed streams of sensor input, or by polling directly when only a few values are desired. Control of the robot may be implemented by instantiating servo loops, such as desired positions or trajectories, open-loop force application at a point, or more complex loops needed for difficult tasks, for example closing the loop around computed quantities like distances between points, orientations of tools, or complex force-control behaviors.

By implementing the servo loops themselves in the base code, it is possible to include information about task intent, to allow the enforcing of safety limits discussed above in an adaptive, informed way. As an example, if a command to follow a trajectory would require motor torques greater than can be exerted by the requesting task (as determined by the safety system), the correct behavior to adopt would depend on the context of the task. If the command is trying to move a pen to draw a picture, then following the trajectory accurately but slowly would be the right behavior. If the command was trying to move a camera to track an object, however, then just driving the motors to get as close to the target position as possible is the proper response.

Preferably the system is configured such that individual tasks can run on any of the on-board computers, or other computational devices (FPGAs, distributed micro controllers, etc.), as well as on off-board computational resources.

Given all of the aforementioned capabilities and features of the embodiments described herein, significant overall functionality may be brought to bear in the human environment. From a functional perspective, embodiments within the scope of this invention include robotic systems that maintain a taught, learned, or externally provided model of the desired state of a system and take actions to maintain that state, where the state can consist of one or more of the following: locations and orientation of objects; amounts of consumable items; relationships between number, type, location, or other parameters of a set of objects; parameters of the environment, such as temperature, sound and light level; complex states, such as the health of a houseplant; state of information systems contained within the primary system, within the robotic system, or external to both. The actions may include, for example: alerting a person, another robotic system, or another entity of deviations from the desired state (or informing them of the continued desirable state of the system); taking indirect action to fix the problems, such as adjusting a thermostat or placing an online order; taking direct action to fix the problem, such as moving objects to their desired locations, moving trash to a wastepaper bin, clearing a table and washing dishes; and operating on information systems related to the system, such as recording data about the system, checking any combination of current and recorded data for consistency or for other relevant predicates, and updating models of system activity, such as modeling the moisture required by a plant over time.

Additionally, robotic embodiments may be configured to support interacting with people, or other external systems, to allow them to make changes to the robotic system's behavior, including: requesting specific information about the current or past state of the system; and identifying aspects of the desired state of the system to change, either on a temporary or permanent basis (such as requesting an object to be brought to a location, identifying a location where all objects of a certain type should be stored, or asking the system to record and store certain data in a specific manner.

Such robotic embodiment may consist of any of: a single self-contained physical entity; multiple self-contained physical entities operating completely independently, or in a loosely coupled manner, or under the control of a centralized controller; and/or a plurality of sensors and actuators spread around an environment without a discrete physical entity to be identified as a robot.

For example, in one implementation, an embodiment of the inventive robot may be configured to go through a human scale door while carrying an object, and may comprise at least one manipulator of sufficient strength and dexterity to open a door; a second manipulator of sufficient strength and dexterity to compete a task such as carrying a removable payload; a mobility platform to move the robot around within the human scale environment; a sensor system; and a computing system. The robot may be configured to open a door, pass through the doorway using the mobility platform and one manipulator, while using the second manipulator to complete a task.

In another implementation, an inventory tracking embodiment of the inventive robot may be configured to go through the inventory of a store room and distinguish different types of items, keep track of quantities, report these quantities, accept information about item names, retrieve items from a remembered location, and add items to the inventory. Applications of such embodiment include inventory tracking in a company, reporting shopping lists, and maintaining a kitchen pantry in a home.

In another implementation, a redundant actuation system embodiment of the inventive robot may comprise a linkage that uses joint level actuators to actuate each degree of freedom in the linkage: wherein there are one or more redundant actuators that do not have a one-to-one correspondence to the joint actuator (i.e., the redundant actuators are not coupled in a one to one fashion to the individual output joint degrees of freedom); wherein the redundant actuators have a one-to-one correspondence to the link (i.e., there is one redundant actuator for each link, but not each degree of freedom)—for example, in a two-link serial arm there may be one redundant actuator for the “upper arm” and one redundant actuator for the “lower arm”; wherein the redundant actuators have a one-to-one correspondence to the link (i.e., there is one redundant actuator for each link, but not each degree of freedom)—for example, in a two-link serial arm there may be one redundant actuator for the “upper arm” and one redundant actuator for the “lower arm”; and wherein there is a one-to-one correspondence to each linkage (this is to say that there is one redundant actuator for an entire linkage).

In other implementations wherein specific tools are utilized to enable specific tasks, embodiments of the inventive robot may comprise a mobile robot with one or more manipulators, along with specific tools designed for the robot to be able to manipulate to accomplish specific tasks. Certain tools may increase dexterity or range of motion so as to enable the manipulator to more efficiently complete the task. For example, tools may be configured for bathroom cleaning, such as toilet, shower, bathtub, and sink cleaning. Other variations could be outfitted with tools for window cleaning tasks, dish washing tasks, and fabric/textile manipulation tasks such as folding clothes or even making a bed.

While multiple embodiments and variations of the many aspects of the invention have been disclosed and described herein, such disclosure is provided for purposes of illustration only. For example, wherein methods and steps described above indicate certain events occurring in certain order, those of ordinary skill in the art having the benefit of this disclosure would recognize that the ordering of certain steps may be modified and that such modifications are in accordance with the variations of this invention. Additionally, certain of the steps may be performed concurrently in a parallel process when possible, as well as performed sequentially. Accordingly, embodiments are intended to exemplify alternatives, modifications, and equivalents that may fall within the scope of the claims.

1. A humanoid robotic system comprising:
a. a mobile base comprising a base frame and a plurality of wheels rotatably coupled to the base frame and configured to controllably navigate floors through contact with a generally planar floor surface;
b. an elongate spine structure fixedly coupled to the mobile base and projecting from said mobile base along a longitudinal axis of the elongate spine structure that is substantially perpendicular from the plane of the generally planar floor surface;
c. a body structure slidably and rotatably coupled to the elongate spine structure, the body structure having spine interface configured to facilitate rolling of the body structure about a roll axis substantially coincident with the longitudinal axis of the elongate spine structure, as well as simultaneous and independent axial defection of the body relative to the mobile base in a direction substantially parallel to the longitudinal axis of the elongate spine structure; and
d. at least one robotic arm rotatably coupled to the body structure.

2. The robotic system of claim 1, wherein the mobile base comprises a battery-based power supply system configured to operate all aspects of the robotic system in an extended self-contained mode, without additional external power connectivity, when charged.

3. The robotic system of claim 1, wherein the mobile base comprises at least three wheel-based floor interfaces, two of which are independently actuated by a wheel drive motor, the remainder of which are passively rotatable.

4. The robotic system of claim 1, wherein the elongate spine structure comprises a body structure elevator cart which is controllably repositionable relative to a length of the elongate spine, and which is rotatably coupled to the body structure.

5. The robotic system of claim 4, wherein the body structure may be electromechanically rolled about the body structure elevator cart to which it is coupled via a body roll actuator coupled to the body structure, the roll actuator being coupled to a body roll actuator drive pulley which is coupled to a pulley comprising the body structure elevator cart by a flexible recirculatory drive member.

6. The robotic system of claim 4, wherein the body structure elevator cart may be electromechanically repositioned relative to the length of the elongate spine via a body elevator actuator coupled to the mobile base, the body elevator actuator being coupled to a body elevator drive pulley which is coupled to the body structure elevator cart by a tension member.

7. The robotic system of claim 1, comprising two robotic arms rotatably coupled to the body structure.

8. The robotic system of claim 1, wherein the at least one robotic arm comprises a force-controlled, backdriveable arm.

9. The robotic system of claim 8, wherein the at least one robotic arm has a payload of approximately 2 kilograms.

10. The robotic system of claim 1, wherein the at least one robotic arm comprises a spring-based counterbalancing mechanism configured to utilize one or more springs to compensate for gravitational forces associated with one or more portions of the at least one robotic arm.

11. The robotic system of claim 10, wherein the at least one robotic arm comprises a forearm portion, an upper arm portion, a first spring, and a second spring, and wherein the first spring is configured to compensate for gravitational forces associated with the mass of the forearm portion, and the second spring is configured to compensate for gravitational forces associated with the mass of the upper arm portion.

12. The robotic system of claim 10, wherein at least one of the one or more springs is configured to be controllably and electromechanically adjusted utilizing an actuator.

13. The robotic system of claim 10, wherein at least one of the one or more springs is a compression spring.

14. The robotic system of claim 10, wherein the at least one robotic arm comprises a proximal support structure rotatably coupled to the body structure, the proximal support structure rotatably coupled to a robotic arm upper arm portion, which is rotatably coupled to a robotic forearm portion, and wherein the proximal support structure substantially contains and is coupled to the spring-based counterbalancing mechanism.

15. A robotic arm system, comprising:
a. a proximal support structure;
b. an arm comprising an upper arm portion and a forearm portion;
the upper arm portion having a proximal and a distal end, the proximal end being rotatably coupled to the proximal support structure;
the forearm portion having a proximal and a distal end, the proximal end being rotatably coupled to the distal end of the upper arm portion; and
c. an electromechanically adjustable spring-based counterbalancing mechanism comprising a spring intercoupled between the proximal support structure and the arm and configured to counterbalance loads imparted to the arm.

16. The robotic arm system of claim 15, wherein the proximal end of the upper arm portion comprises a shoulder interface portion configured to be rotatably coupled to the proximal structure to allow shoulder flexion rotation about an axis substantially perpendicular to a longitudinal axis of the proximal support structure.

17. The robotic arm system of claim 16, wherein the proximal support structure is rotatably coupled to a parent structure such that the proximal support structure may be rotated about its longitudinal axis to provide a panning rotation of the shoulder interface relative to the parent structure, independently of the shoulder flexion rotation.

18. The robotic arm system of claim 16, wherein the spring is intercoupled between the proximal support structure and the shoulder interface portion by a tension member, and wherein the spring is configured to apply a counterbalancing torque about the shoulder interface to prevent shoulder flexion based at least in part upon gravitational loads imparted upon the upper arm portion.

19. The robotic arm system of claim 15, further comprising a forearm counterbalancing linkage comprising a proximal member extending from and being rotatably coupled to the proximal end of the upper arm portion, the proximal member also being coupled to the forearm portion and being configured such that a longitudinal axis of the proximal member remains parallel to a longitudinal axis of the forearm portion.

20. The robotic arm system of claim 19, wherein the forearm counterbalancing linkage comprises a proximal member pulley rotatably coupled to the proximal end of the upper arm portion and fixedly coupled to the proximal member, and wherein the proximal end of the forearm portion comprises a timing pulley configured to rotate about an elbow flexion axis defined by the rotatable coupling between the proximal end of the forearm portion and the distal end of the upper arm portion when the upper arm portion and forearm portion are rotated relative to each other, and wherein a timing belt is routed around each of the proximal member pulley and timing pulley and across the upper arm portion to retain the parallel orientation of the proximal member and the longitudinal axis of the forearm portion.

21. The robotic arm system of claim 20, wherein the spring is intercoupled between the proximal support structure and the proximal member, and wherein the spring is configured to apply a counterbalancing torque about the elbow flexion axis to prevent rotation of the forearm portion at the elbow flexion axis based at least in part upon gravitational loads imparted upon the forearm portion.

22. The robotic arm system of claim 15, further comprising a gripper rotatably coupled to the distal end of the forearm portion.

23. The robotic arm system of claim 22, wherein the gripper is configured to roll and flex about a wrist axis relative to the distal end of the forearm portion.

24. The robotic arm system of claim 16, wherein the shoulder interface portion of the upper arm portion is rotatably coupled to the remainder of the upper arm portion, and configured to allow for a shoulder roll rotation about a longitudinal axis of the upper arm portion.

25. The robotic arm system of claim 15, wherein the spring is constrained in controlled compression.

26. The robotic arm system of claim 15, wherein the spring is constrained in controlled tension.

27. The robotic arm system of claim 15, wherein the spring-based counterbalancing mechanism comprises a first spring intercoupled between the proximal support structure and the forearm portion, and a second spring intercoupled between the proximal support structure and the upper arm portion, wherein both springs are electromechanically adjustable.

28. The robotic arm system of claim 15, wherein the spring is electromechanically adjusted with a cable operably coupled to a motor configured to controllably add or decrease loads applied to the spring.

29. A method of operating a robotic arm, comprising:
a. providing a robotic arm system comprising a proximal support structure and an arm having an upper arm portion and a forearm portion;
the upper arm portion having a proximal and a distal end, the proximal end being rotatably coupled to the proximal support structure;
the forearm portion having a proximal and a distal end, the proximal end being rotatably coupled to the distal end of the upper arm portion; and
b. electromechanically adjusting a spring-based counterbalancing mechanism comprising a spring intercoupled between the proximal support structure and the arm to counterbalance loads imparted to the arm.

30. The method of claim 29, wherein the spring-based counterbalancing mechanism is intercoupled between the proximal support structure and the proximal end of the upper arm portion, and wherein electromechanically adjusting comprises actuating a motor coupled to the spring by a tensioning element.

31. The method of claim 29, wherein the spring-based counterbalancing mechanism is intercoupled between the proximal support structure and a proximal member extending from and being rotatably coupled to the proximal end of the upper arm portion, the proximal member being coupled to the forearm portion by a linkage configured such that a longitudinal axis of the proximal member remains parallel to a longitudinal axis of the forearm portion, and wherein electromechanically adjusting comprises actuating a motor coupled to the spring by a tensioning element.

32. The method of claim 29, wherein electromechanically adjusting comprises changing the tension on a compression spring by actuating a motor coupled to the spring by a tensioning element.

33. The method of claim 29, wherein electromechanically adjusting comprises changing the tension on a tension spring by actuating a motor coupled to the spring by a tensioning element.
